(19) United States
(12) Patent Application Publication
(10) Pub. No.: US 2007/0002232 A1
(43) Pub. Date: Jan. 4, 2007

(54) Optical compensation film, polarizing plate and liquid crystal display device

(75) Inventors: Kentaro Toyooka, Minami-ashigara-shi (JP); Shoji Yasuda, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/431,745

(22) Filed: May 11, 2006

(30) Foreign Application Priority Data
May 11, 2005 (JP) 138197/2005

(51) Int. Cl. G03C 5/00; G02F 1/1335

(52) U.S. Cl. 349/117; 430/321

(57) ABSTRACT

A novel optical compensation film is disclosed. The optical compensation film comprises a substrate, and, on the substrate, at least one optically anisotropic layer of a composition comprising a liquid crystalline compound, wherein a difference (H₂−H₁) between a haze (H₂) of the whole of the optical compensation film and a haze (H₁) of the substrate along is not more than 0.2%. A novel polarizing plate and liquid crystal display device comprising the optical compensation film are also disclosed.

This application claims benefit of priority under 35 USC 119 to Japanese Patent Application No. 2005-138197 filed May 11, 2005.

### BACKGROUND OF THE INVENTION

1. Field of the Invention

The present invention relates to an optical compensation film comprising an optically anisotropic layer in which liquid crystal molecules are fixed in an alignment state, to a polarizing plate and a liquid crystal display device employing the optical compensation film.

2. Related Art

For the purpose of reducing image colorations or widening viewing angles, optical compensation sheets have been used in various liquid crystal display devices. So far, a stretched birefringent film has been used as the optical compensation sheet. Also, it has been proposed to use an optical compensation sheet comprising an optically anisotropic layer formed of a liquid crystalline composition and a transparent substrate supporting the layer in place of the stretched birefringent film. This optically anisotropic layer is usually produced by applying a liquid crystal composition containing a liquid crystalline compound such as a discotic liquid crystalline compound to a surface of an alignment layer, heating at a temperature higher than the orientation temperature to align the liquid crystalline molecules and fixing them in an orientation state. In general, liquid crystalline compounds have a large birefringent index and take various oriented states. By using a discotic liquid crystalline compound, it has become possible to achieve optical properties which cannot be obtained by conventional stretched birefringent films.

There have been made various proposals to utilize an optical compensation sheet which exhibits optical anisotropy generated by an orientation of discotic liquid crystalline molecules for optically compensating a liquid crystal display device employing a TN mode. For example, as an optical element capable of contributing to improving a viewing angle characteristic of a color liquid crystal display device employing a TN mode liquid crystal cell, there is proposed an optical element comprising a transparent film and, thereon, a layer containing discotic molecules, and having an optical anisotropy and a haze of not more than 5.0% in Japanese Laid-Open Patent Publication “Tokkai” No. hei 8-50204.

### SUMMARY OF THE INVENTION

An object of the invention is to provide an optical compensation film and a polarizing plate capable of contributing to a reduction of light leakage in a black state and an improvement of a contrast ratio when being employed in a liquid crystal display device.

Another object of the invention is to provide a liquid crystal display device in which not only the light leakage in a black state is reduced, but also a contrast ratio is improved.

The inventors conducted various studies with respect to the performance of an optical compensation film comprising an optically anisotropic layer formed of a liquid crystalline composition, and as a result, they found that a haze of the optical compensation film is related to an optical compensation ability, especially performance capable of reducing the light leakage in a black state. They further conducted various studies on the basis of this finding, and as a result, they found that such performance can be remarkably improved by reducing a variation in the haze before and after the formation of an optically anisotropic layer.

In one aspect, the invention provides an optical compensation film comprising a substrate and, on the substrate, at least one optically anisotropic layer formed of a composition comprising a liquid crystalline compound, wherein a difference (H₂−H₁) between a haze (H₂) of the whole of the optical compensation film and a haze (H₁) of the substrate alone is not more than 0.2%.

As embodiments of the invention, there are provided the optical compensation film wherein the optically anisotropic layer is a layer formed by applying the composition to a surface; the optical compensation film wherein the liquid crystalline compound is a discotic liquid crystalline compound; the optical compensation film, wherein the haze (H₂) of the whole is not more than 0.5%; and the optical compensation film wherein the composition comprises cellulose acetate butyrate in an amount falling within 0.1 to 2.0% with respect to a weight of the composition; and the optical compensation film wherein the optically anisotropic layer has a thickness of from 0 1 to 2.0 μm.

In another aspect the invention provides a polarizing plate comprising at least a polarizing film and a transparent protective film provided on one surface of the polarizing film wherein the transparent protective film is the optical compensation film of the invention, a liquid crystal display device comprising the optical compensation film of the invention, and a liquid crystal display device comprising the polarizing plate.

### DETAILED DESCRIPTION OF THE INVENTION

Embodiments of the present invention are described in detail below. It is to be noted that, in the description, ranges indicated with “to” mean ranges including the numerical values before and after “to” as the minimum and maximum values.

In the specification, the term of “A is parallel to B” or the term of “A is orthogonal to B” means that the angle between A and B falls within a range of an exact angle ±10°. The angle desirably falls within a range of an exact angle ±5°, and more desirably within a range of an exact angle ±2°. The term of “A is perpendicular to B” means that the angle between A and B falls within a range of an exact angle ±10°. The angle desirably falls within a range of an exact angle ±5°, and more desirably within a range of an exact angle ±2°. The term of “visible light wavelength” means a wavelength from 380 nm to 780 nm. The term of “slow axis” means a direction giving a maximum refractive index. As long as written specifically, refractive indexes are measured at 550 nm.

In the specification the terms of “polarizing plate” means not only polarizing plates having a proper size to be employed in a liquid-crystal but also long polarizing plates before being cut. And in the specification, the terms of “polarizing film” is distinct from the term “polarizing plate”, and the term of “polarizing plate” is used for any laminated body comprising a “polarizing film” and at least one protective film thereon.

[Optical Compensation Film]

The optical compensation film of the invention comprises at least one optically anisotropic layer formed of a composition containing a liquid crystalline compound, and a substrate supporting the layer. One feature of the optical compensation film of the invention resides in that the difference (H₂−H₁) between a haze (H₂) of the whole of the optical compensation film and a haze (H₁) of the substrate alone is not more than 0.2%. In the specification, the term “haze” refers to a value as measured according to ASTM-D 1003-52. The difference (H₂−H₁) between a haze (H₂) of the whole of the optical compensation film of the invention and a haze (H₁) of the substrate alone is not more than 0.2%, preferably not more than 0.1%, and more preferably not more than 0.05%. When the difference of the haze falls within the foregoing range, an excellent optical compensation film capable of contributing to a reduction of the light leakage in a black state and an improvement of a contrast ratio is obtained. Furthermore, the haze of the optical compensation film of the invention is preferably not more than 0.5%, more preferably not more than 0.4%, and further preferably not more than 0.3%. The optical compensation film having the haze value falling within the foregoing range is preferred because the light leakage in a black state, especially remarkably generated in the oblique direction, can be more reduced when being employed in a liquid crystal display device.

Usually, the composition which is employed for forming the optically anisotropic layer comprises, in addition to the liquid crystalline compound, various additives such as an alignment controlling agent for aligning liquid crystalline molecules in a desired alignment state and a surfactant for improving coating properties. As a result of extensive and intensive investigations, the present inventors found that the addition of these additives can cause formation of domains during the process of preparing an optically anisotropic layer, thereby generating non-uniformity of a refractive index. And, therefore, according to the conventional optical compensation films having such a construction, even when a polymer film having a low haze value or the like is used as a substrate supporting an optically anisotropic layer, the haze value as the whole of the optically compensating film increases after the formation of an optically anisotropic layer for the reasons as described above. And, as a result, the optical compensation abilities of the conventional optical compensation films are sometimes lowered. According to the present invention, it is possible to provide an optical compensation film having an excellent optical compensation ability by reducing a variation in the haze before and after the formation of an optically anisotropic layer.

In order to reduce a variation in the haze before and after the formation of an optically anisotropic layer, as described above, it is required to reduce formation of domains due to the additives. In particular, examples of a material which easily causes formation of domains include cellulose acetate butyrate. Accordingly, it is preferred to reduce the content of such a material in the layer. Details will be described later. Furthermore, a liquid crystalline compound, especially a discotic liquid crystalline compound may possibly form domains depending upon aging conditions. Thus, there is some possibility that such a phenomenon becomes a cause for an increase of the haze. Accordingly, it is preferred to set up aging conditions and the like so as to align liquid crystalline molecules, especially discotic liquid crystalline molecules in a mono-domain alignment state. Furthermore, even in the case of forming plural domains, so far as the size of each domain is not larger than 0.1 μm, and preferably not larger than 0.08 μm, the resulting domains do not affect visible light and do not become a cause for an increase of the haze and therefore, such is preferable. In addition, it is also possible to prevent the haze increasing by reducing the thickness of the optically anisotropic layer. The thickness of the optically anisotropic layer is preferably from 0.1 to 2.0 μm, and more preferably from 0.1 to 1.0 μm.

Examples of the material, examples of the method and so forth which can be used in producing the optical compensation film of the invention will be hereunder described in detail.

(Optically Anisotropic Layer)

It is preferable that the optically anisotropic layer is designed so as to compensate retardation generated by the orientation of liquid crystalline molecules in the liquid crystal cell in a black state when being employed in a liquid crystal display device. The orientation state of liquid crystalline molecules in a liquid crystal cell in a black state varies depending upon a mode of the liquid crystal display device. Various examples of the orientation state of liquid crystalline molecules in a liquid crystal cell are described on pages 411 to 414 of IDW'00, FMC7-2 and so on.

The optically anisotropic layer may be formed by applying a liquid crystalline composition to a surface of a substrate or to a surface of an alignment layer formed on the substrate. The alignment layer preferably has a thickness of not more than 10 μm.

Examples of the liquid crystalline compound, which can be used in preparing the optically anisotropic layer, include rod-like liquid crystalline compounds and discotic liquid crystalline compounds. Each of the rod-like liquid crystalline compound and the discotic liquid crystalline compound may be a high molecular liquid crystal or a low molecular liquid crystal. In addition, a compound in which a low molecular liquid crystal is crosslinked so that it does not exhibit liquid crystallinity is also included. The optically anisotropic layer may be formed by applying a coating fluid comprising a liquid crystalline compound and if desired, a polymerization initiator and arbitrary additives to a surface of an alignment layer. Preferred examples of the alignment layer which can be used in the invention are described in Japanese Laid-Open Patent Publication “Tokkai” No. hei 8-338913.

(Rod-Like Liquid Crystalline Compound)

Examples of the rod-like liquid crystalline compound, which can be preferably used in the preset invention, include azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans and alkenyl cyclohexyl benzonitriles.

It is to be noted that examples of the rod-like liquid crystalline compound include metal complexes. And it is also possible to use, as a rod-like liquid crystalline compound, liquid crystalline polymers comprising a repeating unit having a residue of a rod-like liquid crystalline compound. Or, in other words, the rod-like liquid crystalline, compound which can be used in the present invention, may bind to a polymer.

Rod-like liquid crystalline compounds are described in fourth, seventh and eleventh chapters of “Published Quarterly Chemical Review vol. 22 Chemistry of Liquid Crystals (Ekishyo no Kagaku)” published in 1994 and edited by Japan Chemical Society; and in third chapter of “Handbook of liquid Crystal Devices (Ekishyo Debaisu Handobukku)” edited by the 142 th committee of Japan Society for the Promotion of Science.

The rod-like liquid-crystalline compounds desirably have a birefringence index of 0.001 to 0.7.

The rod-like liquid-crystalline compounds desirably have one or more polymerizable groups for fixing themselves in an alignment state. Preferred examples of the polymerizable group include unsaturated polymerizable groups and epoxy group, and unsaturated polymerizable groups are more preferred, and ethylenic unsaturated polymerizable groups are much more preferred. More specifically, polymerizable groups and polymerizable liquid crystalline compounds, described in columns from [0064] to [0086] of in Japanese Laid-Open Patent Publication “Tokkai” No. 2002-62427, are preferably used in the present invention.

(Discotic Liquid Crystalline Compound)

Examples of discotic liquid crystalline compounds include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al.

Examples of the discotic liquid-crystalline compounds also include compounds having a discotic core and substituents, radiating from the core, such as a linear alkyl or alkoxy group or substitute benzoyloxy groups. It is preferred that molecules have rotational symmetries respectively or as a whole of molecular assembly to be aligned in an alignment state. The discotic liquid-crystalline compounds employed in preparing optically anisotropic layers are not required to maintain liquid crystallinity after contained in the optically anisotropic layers. For example, when a low-molecular-weight discotic liquid-crystalline compound, having a reacting group initiated by light and/or heat, is employed in preparation of an optically anisotropic layer, polymerization or cross-linking reaction of the compound is initiated by light and/or heat, and carried out, to thereby form the layer. The polymerized or cross-linked compounds may no longer exhibit liquid crystallinity. Preferred examples of the discotic liquid-crystalline compound are described in Japanese Laid-Open Patent Publication “Tokkai” No. hei 8-50206. The polymerization of discotic liquid-crystalline compounds is described in Japanese Laid-Open Patent Publication “Tokkai” No. hei 8-27284.

In order to fix the discotic liquid crystalline molecule by a polymerization, a polymerizable group has to be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Preferred examples of the discotic liquid crystalline compound having a polymerizable group include the group represented by a formula (5) below.

Formula (5)
D(—LQ)ᵣ

In the formula, D is a disk-shaped core, L is a divalent liking group, Q is a polymerizable group and r is an integer from 4 to 12.

Examples of the disk-shaped core are shown below. In each of the examples, LQ or QL means the combination of the divalent linking group (L) and the polymerizable group (Q).

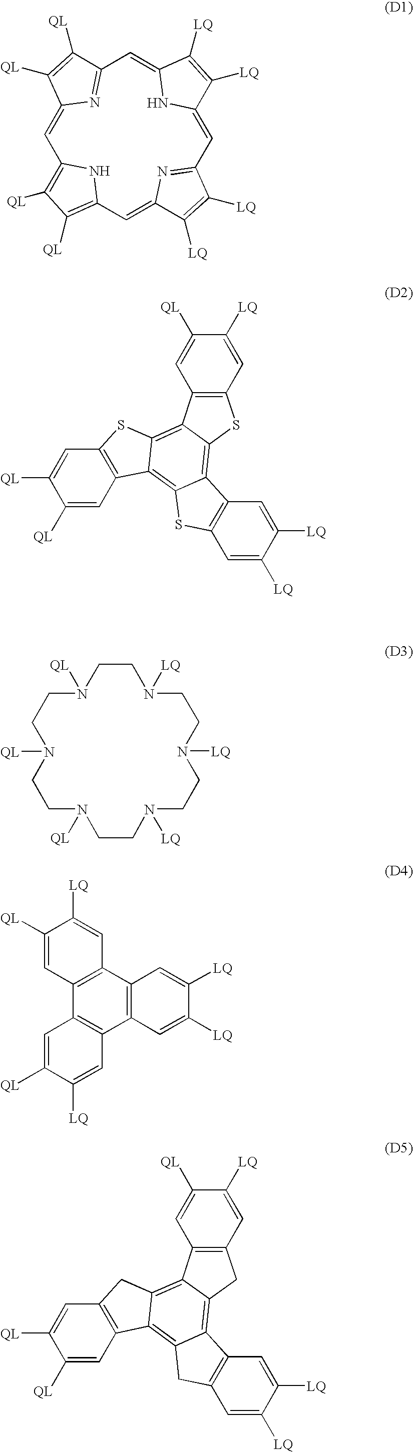

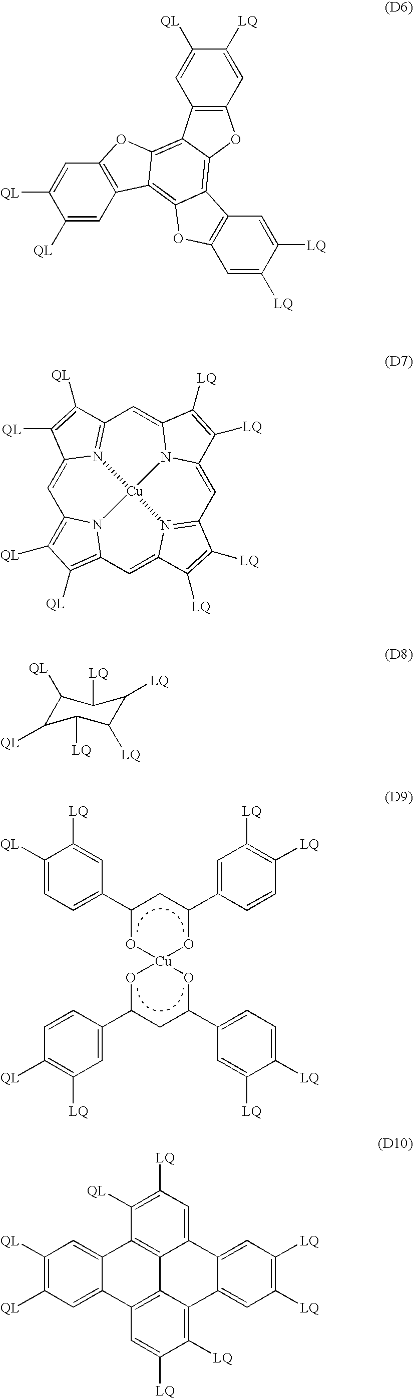

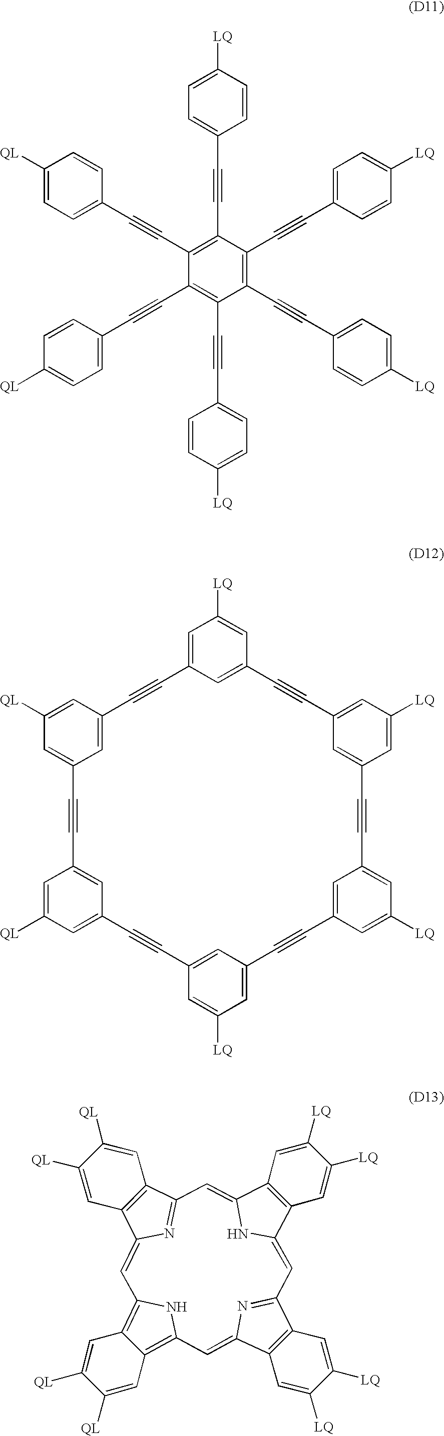

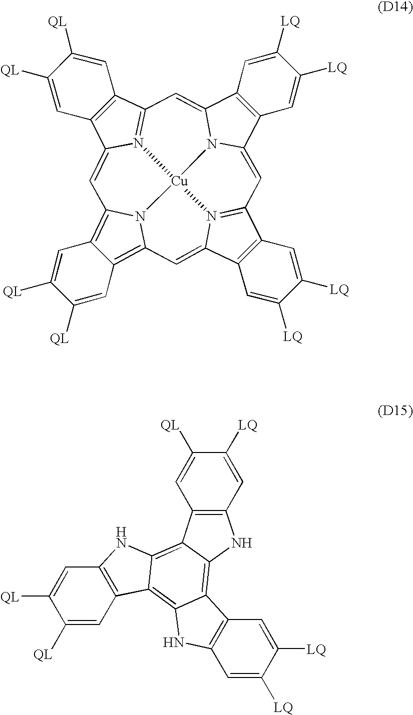

In formula (5), the divalent liking group (L) is preferably any one of those selected from the group consisting of alkylene group, alkenylene group, arylene group, —CO—, —NH—, —O—, —S— and combinations of these groups. The divalent liking group (L) is more preferably based on combination of at least two divalent groups selected from the group consisting of alkylene group, arylene group, —CO—, —NH—, —O— and S—. The divalent liking group (L) is most preferably based on combination of at least two divalent groups selected from the group consisting of alkylene group, arylene group, —CO— and O—. The number of carbon atoms of the alkylene group is preferably 1 to 12. The number of carbon atoms of the alkenylene group is preferably 2 to 12. The number of carbon atoms of the arylene group is preferably 6 to 10.

Examples of the divalent coupling group (L) are listed below. The left end binds with the discotic core (D), and the right end binds with the polymerizable group (Q). AL represents an alkylene group or an alkenylene group, and AR represents an arylene group. The alkylene group, alkenylene group and arylene group may have a substituent (e.g, alkyl group).
L1: —AL—CO—O—AL—,
L2: —AL—CO—O—AL—O—,
L3: —AL—CO—O—AL—O—AL—,
L4: —AL—CO—O—AL—O—CO—,
L5: —CO—AR—O—AL—,
l6: —CO—AR—O—AL—O—,
L7: —CO—AR—O—AL—O—CO—,
L8: —CO—NH—AL—,
L9: —NH—AL—O—,
L10: —NH—AL—O—CO—,
L11: —O—AL—,
L12: —O—AL—O—,
L13: —O—AL—O—CO—,
L14: —O—AL—O—NH—AL—,
L15: —O—AL—S—AL,
L16: —O—CO—AL—AR—O—AL—O—CO—,
L17: —O—CO—AR—O—AL—CO—,
L18: —O—CO—AR—O—AL—O—CO—,
L19: —O—CO—AR—O—AL—O—AL—O—CO—,
L21: —O—CO—AR—O—AL—O—AL—O—AL—O—CO—,
L22: —S—AL—,
L23: —S—AL—CO—,
L24: —S—AL—S—AL—, and
L25: —S—AR—AL—.

The polymerizable group (Q) in formula (5) is determined depending on types of the polymerization reaction.

Examples of the polymerizable group (Q) are shown below.

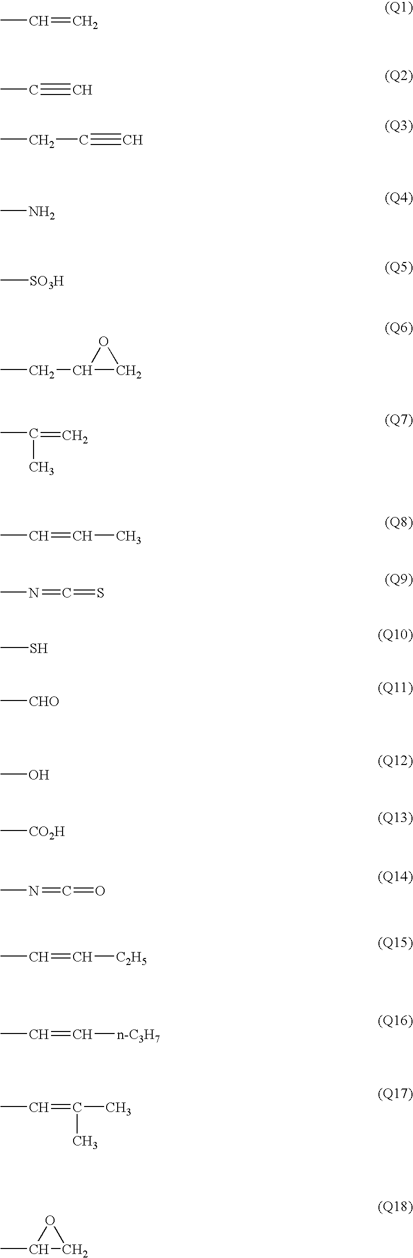

The Q is preferably selected from the unsaturated polymerizable group such as Q1, Q2, Q3, Q7, Q8, Q15, Q16 and Q17, or the epoxy group such as Q6 and Q18; more preferably selected from unsaturated polymerizable group; and much more preferably selected from the ethylenic unsaturated polymerizable group such as Q1, Q7, Q8, Q15, Q16 and Q17.

The value represented by “r” is decided depending on the type of the disk-shaped core (D). The plural sets of L and Q may be same or different from each other, and are preferably same each other.

In a hybrid alignment, an angle formed between the long axis (disk face) of a liquid crystalline molecule and a layer plane, or, in other words, tilt angle, increases or decreases in the thickness direction (or, in other words, the normal direction) of the optically anisotropic layer, along with an increase in the distance from the surface of the substrate (or the alignment layer). The tilt angle preferably increases along with the increase in the distance from the surface of the substrate (or the alignment layer). Also the change in the tilt angle may be a continuous increase, a continuous decrease, an intermittent increase, an intermittent decrease, a change including a continuous increase and a continuous decrease, or an intermittent change including an increase and a decrease. The intermittent change contains a region in which the tilt angle does not change, within the thickness direction. Also the angular change may be a general increase or a general decrease over the thickness, even including a region without angular change. Also, a continuous angular change is preferable.

The mean direction of the long axes (disk faces) of discotic molecules may be generally adjusted by selecting the type of the discotic liquid crystalline compounds to be used in producing optically anisotropic layers and the materials to be used in producing alignment layers, or by selecting the condition of the rubbing treatments to be applied to alignment layers. The directions of the long axes (disk faces) of discotic molecules existing in the surface side (air-interface side) of the layer may be adjusted by selecting the type of the discotic liquid crystalline compounds or the type of the additives to be used in producing optically anisotropic layers.

Examples of the additive to be used with the liquid crystalline compound include plasticizers, surfactants, polymers and polymerizable monomers. The variation degree in the alignment directions of long axes may be adjusted by selecting the type of the discotic liquid crystalline compounds or the type of the additives to be used in producing optically anisotropic layers.

Such additive preferably has a compatibility with the liquid crystalline molecules and has a property of changing the tilt angle thereof or of not inhibiting the alignment thereof. among the additives, polymerizable monomers such as compounds having a vinyl group, vinyloxy group, acryloyl group and methacryloyl group are preferably added to the composition. Such polymerizable compound may be added to the composition with an amount of 1 to 50%, and preferably added with an amount of 5 to 30% with respect to the weight of liquid crystalline compound. Using polymerizable monomer having four or more reactive functional group per a molecule may contribute to improving the adhesion between the alignment layer and the optically anisotropic layer.

The optically anisotropic layer may comprise one or more types of polymers with the liquid crystalline compound. The polymer preferably has a compatibility with the liquid crystalline molecules and has a property of changing the tilt angle thereof. Examples of such polymer include cellulose esters. Preferred examples of the cellulose ester include cellulose acetate, cellulose acetate propionate, hydroxy propyl cellulose and cellulose acetate butyrate. As described above, the content of cellulose ester, especially cellulose acetate butyrate, include in the optically anisotropic layer is so large that the formation of domains are promoted. And, therefore, the polymer may be added in an mount so as to avoid disorder of alignment of liquid crystalline molecules, is preferably added with an amount of 0.1 to 2.0% with respect to the weight of the liquid crystalline compound, and is more preferably added with an amount 0.1 to 8% with respect to the weight of the liquid crystalline compound.

It is preferred that the discotic liquid crystalline molecules has a transition temperature between the discotic liquid crystalline phase and the solid phase within a range of 70 to 300° C., more preferably 70 to 170° C.

(Fixing of Liquid-Crystalline Molecules in Alignment State)

After being aligned in an alignment state, the liquid crystalline molecules may be fixed in the alignment state without disordering the state. Fixing is preferably carried out by the polymerization reaction of the polymerizable groups contained in the liquid-crystalline molecules. The polymerization reaction includes thermal polymerization reaction using a thermal polymerization initiator and photo-polymerization reaction using a photo-polymerization initiator. Photo-polymerization reaction is preferred.

Examples of photo-polymerization initiators include alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in Japanese Laid-Open Patent Publication (Tokkai) shyo No. 60-105667 and U.S. Pat. No. 4,239,850) and oxadiazole compounds (described in U.S. Pat. No. 4,212,970).

The amount of the photo-polymerization initiators to be used is preferably 0.01 to 20%, more preferably 0.5 to 5% with respect to the weight of solids in the coating fluid.

Irradiation for polymerizing the liquid-crystalline molecules preferably uses UV rays. The irradiation energy is preferably 20 mJ/cm² to 50 J/cm², more preferably 20 to 5000 mJ/cm² and much more preferably 100 to 800 mJ/cm². Irradiation may be carried out under heating to accelerate the photo-polymerization reaction.

A protective layer may be formed on the optically anisotropic layer.

And, the optically anisotropic layer may comprise at least one type of copolymer, occasionally referred to as “fluoride-polymer” hereinafter, comprising a repeating unit derived from the fluorine-containing monomer represented by a formula [1] or [2] shown below. The fluoride-polymer is preferably selected from acryl-type or metharcryl-type polymers comprising a repeating unit derived from a monomer represented by the formula [1] or [2] and a repeating unit derived from a monomer represented by a formula [3] shown below. And the polymer is also preferably selected from acryl-type or methacryl-type polymers comprising the two repeating units described above and a repeating unit derived from a vinyl-type monomer.

The fluoro-aliphatic group in the fluoride-polymer may be derived from a fluoro-aliphatic compound prepared by a telomerization method, occasionally referred to as telomer method, or an oligomemerization, occasionally referred to as oligomer method. Examples of preparation of the fluoride-aliphatic compound are described on pages 117 to 118 in ““Synthesis and Function of Fluoride Compounds (Fussokagoubutsu no Gousei to Kinou)” overseen by ISHIKAWA NOBUO and published by CMC Publishing Co., Ltd. in 1987; and on pages 747 to 752 in “Chemistry of Organic Fluorine Compounds II”, Monograph 187, Ed by Milos Hudlicky and Attila E. Pavlath, American Chemical Society 1995; and the like. The telomerization method is a method for producing a telomer by carrying out radical polymerization of fluorine-containing compound such as tetrafluoroethylene in the presence of an alkylhalide such as iodide, having a large chain-transfer constant number, as a telogen. One example is shown in Scheme-I.

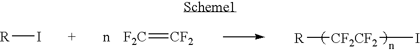

The obtained fluorine-terminated telomers are usually terminal-modified properly as shown in Scheme 2, to give fluoro-aliphatic compounds. These compounds are, if necessary, transferred to a desired monomer structure, and then used for preparing fluoro-aliphatic containing polymers. In the Scheme 2, n represents a natural number.

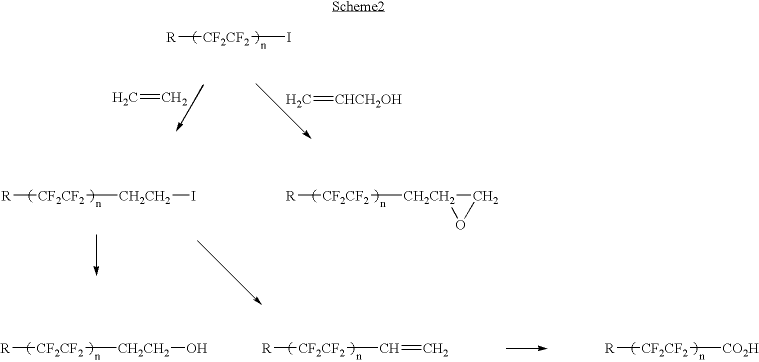

As described above, as a monomer of the fluoride-polymer, compounds represented by a formula [1] or [2] shown below are preferably used.

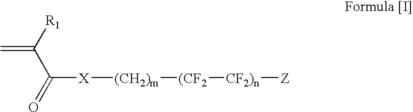

In the formula [1], R₁ represents a hydrogen atom (H) or methyl; X represents an oxygen atom, a sulfur atom or —N(R₂)—, where R₂ is a hydrogen atom or a C₁₄ alkyl group, and is preferably a hydrogen atom or methyl; Z is a hydrogen atom or a fluorine atom; “m” is an integer from 1 to 6; and “n” is an integer from 2 to 4.

It is preferred that X is an oxygen atom, Z is a hydrogen atom, m is 1 or 2 and n is 3 or 4. The mixture thereof may be also used.

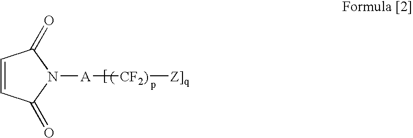

In the formula [2], “A” is a divalent (q=1) or trivalent (q=2) linking group selected from Linking Group A shown below or a divalent (q=1) or trivalent (q=2) linking group formed by combining two or more selected from Linking Group A shown below. And it is allowable that two or more same or different linking groups bind to each other through an oxygen atom (—O—).

(Linking Group A)

—CH₂—, —CH₂CH₂—, —CH₂CH₂CH₂—, —C₆H₄— and —C₆H₃<, where any positions of the benzene ring may be substituted.

In the formula [2], Z is a hydrogen atom or a fluorine atom, “p” is an integer from 3 to 8 and “q” is 1 or 2.

In the formula, “A” is preferably selected from the group shown below.

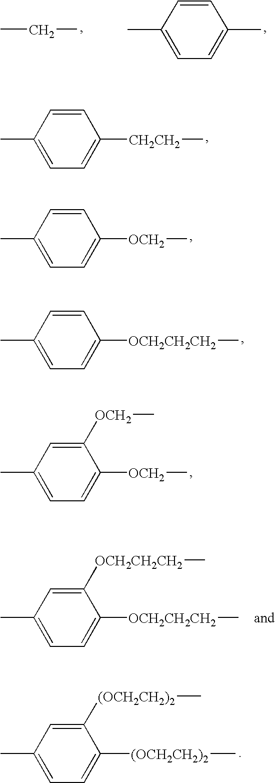

It is preferred that Z is a fluorine atom and “p” is 4 or 6. The mixture thereof may be also used.

Examples of the monomer which can be used in preparing the fluoride-polymer include, but not to be limited to, those shown below.

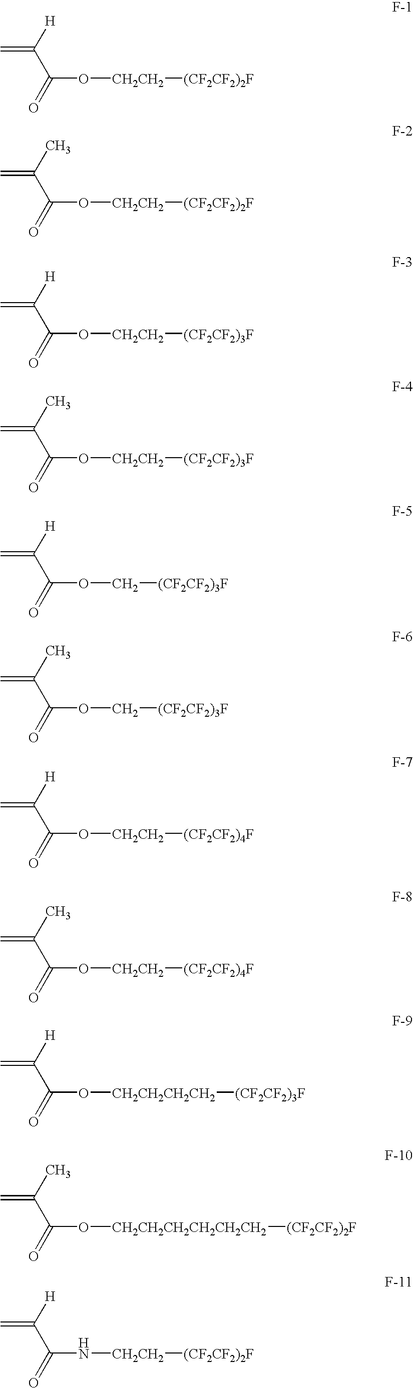

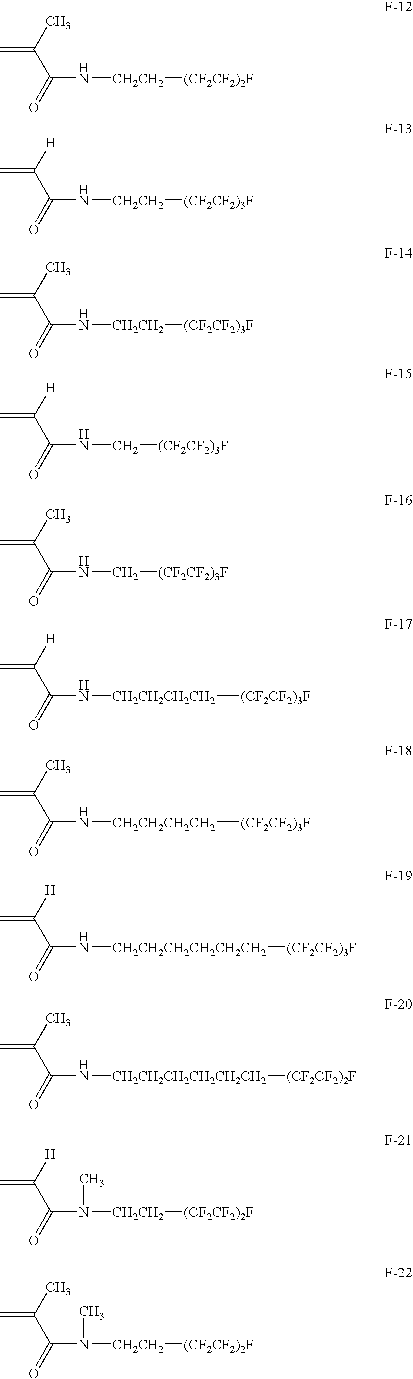

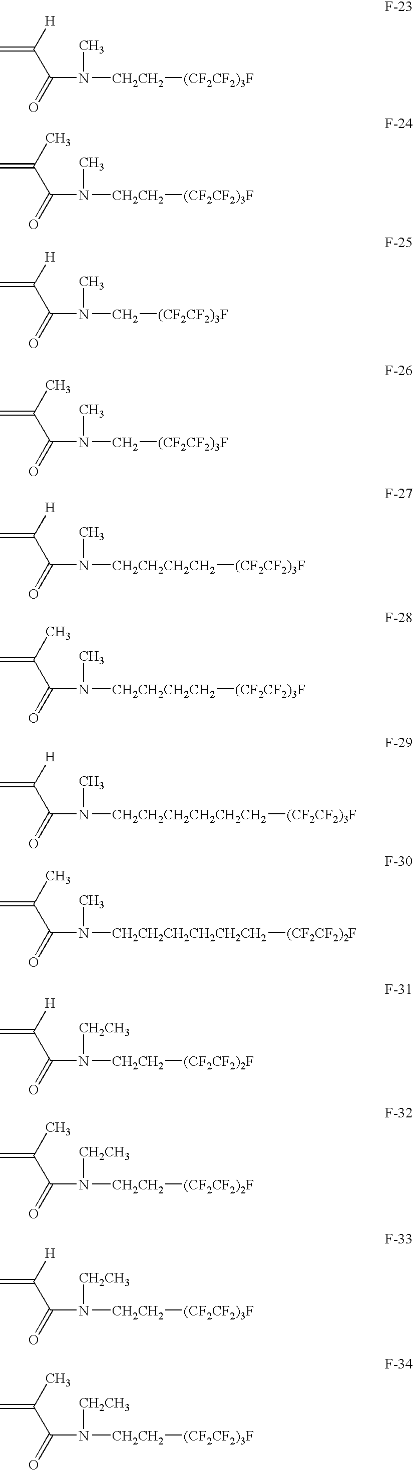

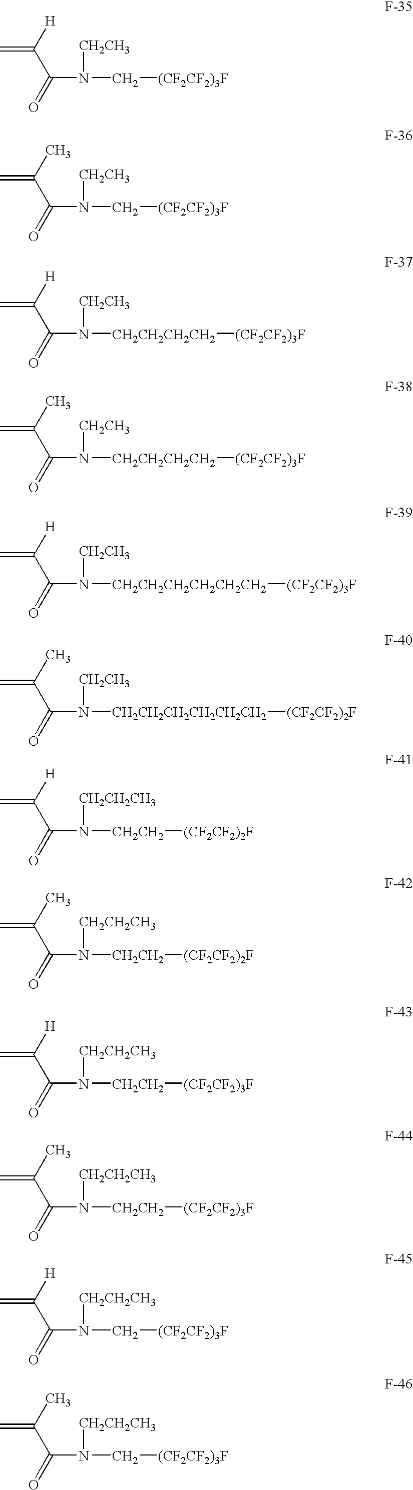

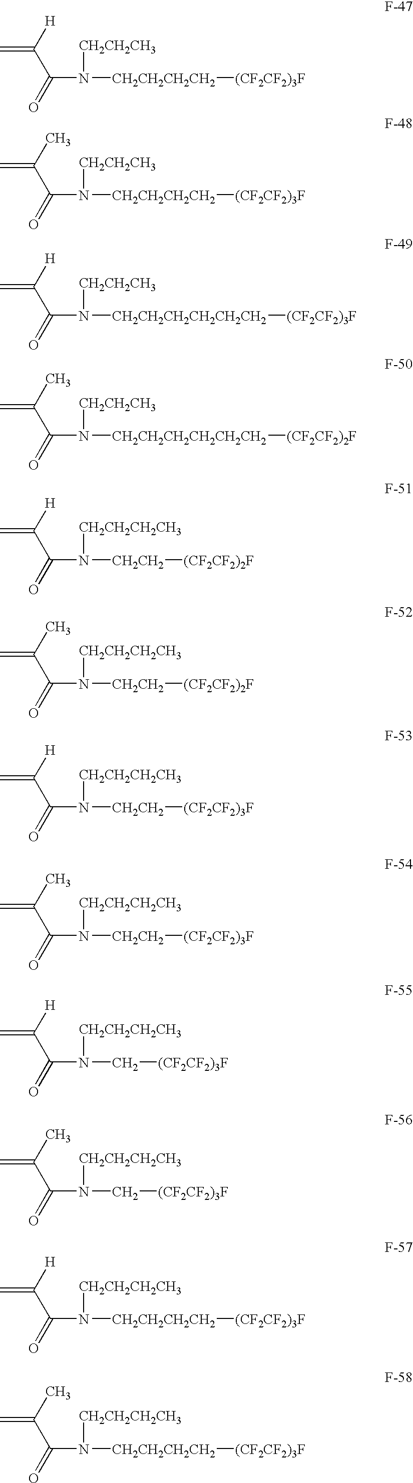

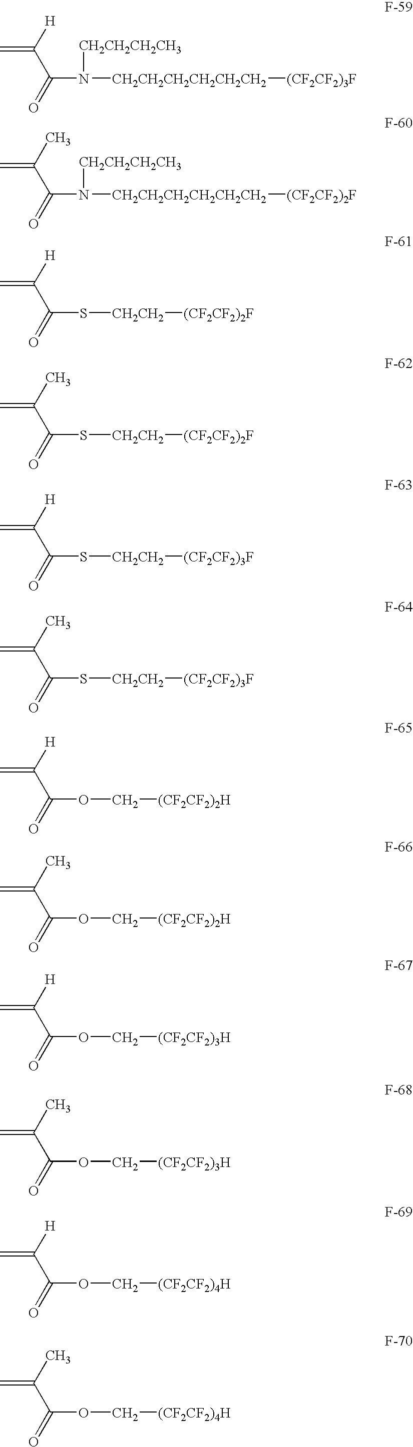

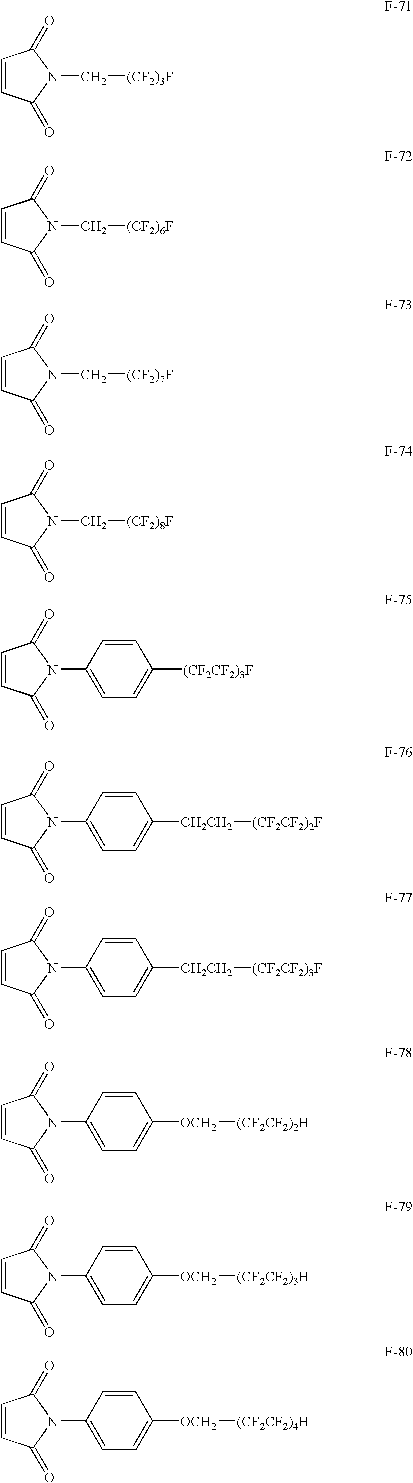

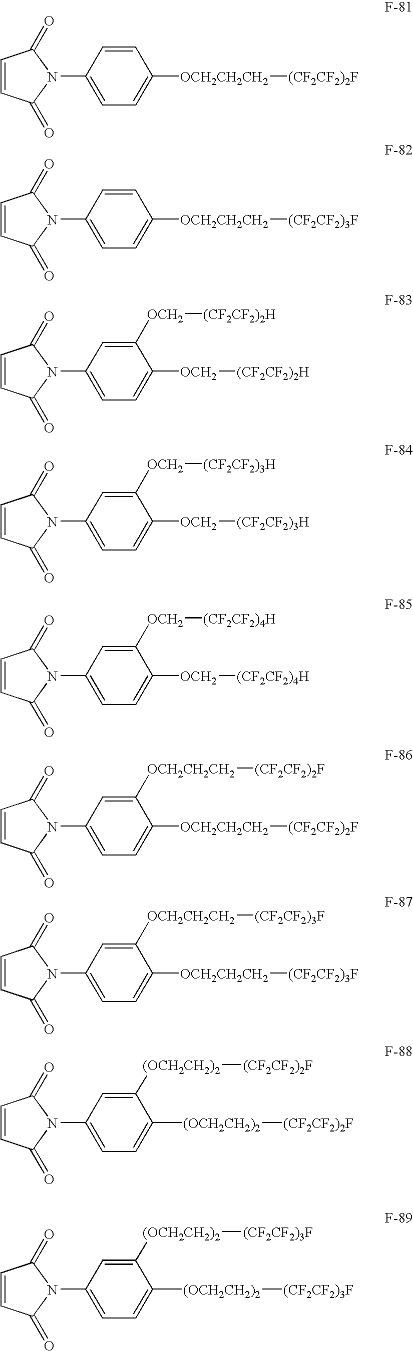

One embodiment of the fluoride-polymer is a copolymer comprising a repeating unit derived from the monomer having fluoro-aliphatic group and a repeating unit derived from a monomer, having a hydrophilic group, represented by a formula [3] shown below.

Formula [3]

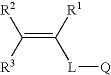

In the formula [3], R¹, R² and R³ respectively represent a hydrogen atom or a substituent group.

In the formula [3], Q represents a carboxyl group (—COOH) or a salt thereof, a sulfo group (—SO₃H) or a salt thereof, a phosphonoxy group {—OP(═O)(OH)₂} or a salt thereof, an alkyl group or a poly(alkylenoxy) group having a terminal hydrogen atom or a terminal alkyl group.

In the formula [3], L represents a divalent linking group selected from the Linking Group shown below or a divalent linking group consisting of two or more selected from the Linking Group shown below;

(Linking Group)

a single bond, —O—, —CO—, —NR⁴— where R⁴ represents a hydrogen atom, an alkyl group, an aryl group or an aralkyl group), —S—, —SO₂—, —P(—O)(OR⁵)— where R⁵ represents an alkyl group, an aryl group or an aralkyl group), an alkylene group and arylene group.

In the formula [3], R¹, R² and R³ respectively represent a hydrogen atom or a substituent group selected from Substituent Group I shown below:

(Substituent Group I)

an alkyl group (desirably C₁₋₂₀, more desirably C₁₋₁₂ and much more desirably C₁₋₈ alkyl group) such as methyl, ethyl, isopropyl, tert-butyl, n-octyl, n-decyl, n-hexadecyl, cyclopropyl, cyclopentyl or cyclohexyl; an alkenyl group (desirably C₂₋₂₀, more desirably C₂₋₁₂ and much more desirably C₂₋₈ alkenyl group) such as vinyl, allyl, 2-butenyl or 3-pentenyl; an alkynyl group (desirably C₂₋₂₀, more desirably C₂₋₁₂ and much more desirably C₂₋₈ alkynyl group) such as propargyl or 3-pentynyl; an aryl group (desirably C₆₋₃₀, more desirably C₆₋₂₀ and much more desirably C₆₋₁₂ aryl group) such as phenyl, p-methylphenyl or naphthyl; an aralkyl group (desirably C₇₋₃₀, more desirably C₇₋₂₀ and much more desirably C₇₋₁₂ aralkyl group) such as benzyl, phenethyl or 3-phenylpropyl; a substituted or unsubstituted amino group (desirably C₀₋₂₀, more desirably C₀₋₁₀ and much more desirably C₀₋₆ amino group) such as unsubstituted amino, methylamino, dimethylamino, diethylamino or anilino; an alkoxy group (desirably C₁₋₂₀, more desirably C₁₋₁₆ and much more desirably C₁₋₁₀ alkoxy group) such as methoxy, ethoxy or butoxy; an alkoxycarbonyl group (desirably C₂₋₂₀, more desirably C₂₋₁₆ and much more desirably C₂₋₁₀ alkoxy carbonyl group) such as methoxycarbonyl or ethoxycarbonyl; an acyloxy group (desirably C₂₋₂₀, more desirably C₂₋₁₆ and much more desirably C₂₋₁₀ acyloxy group) such as acetoxy or benzoyloxy; an acylamino group (desirably C₂₋₂₀, more desirably C₂₋₁₆ and much more desirably C₂₋₁₀ acylamino group) such as acetylamino or benzoylamino; an alkoxycarbonylamino group (desirably C₂₋₂₀, more desirably C₂₋₁₆ and much more desirably C₂₋₁₂ alkoxycarbonylamino group) such as methoxycarbonyl amino; an aryloxycarbonylamino group (desirably C₇₋₂₀, more desirably C₇₋₁₆ and much more desirably C₇₋₁₂ aryloxycarbonylamino group) such as phenyloxycarbonyl amino group; a sulfonylamino group (desirably C₁₋₂₀, more desirably C₁₋₁₆ and much more desirably C₁₋₁₂ sulfonylamino group) such as methylsulfonylamino group or benzenesulfonylamino group; a sulfamoyl group (desirably C₀₋₂₀, more desirably C₀₋₁₆ and much more desirably C₀₋₁₂ sulfamoyl group) such as unsubstituted sulfamoyl, methylsulfamoyl, dimethylsulfamoyl or phenylsulfamoyl, a carbamoyl group (desirably C₁₋₂₀, more desirably C₁₋₁₆ and much more desirably C₁₋₁₂ carbamoyl group) such as unsubstituted carbamoyl, methylcarbamoyl, diethylcarbamoyl or phenylcarbamoyl; an alkythio group (desirably C₁₋₂₀, more desirably C₁₋₁₆ and much more desirably C₁₋₁₂ alkylthio group) such as methylthio or ethylthio; an arylthio group (desirably C₆₋₂₀, more desirably C16 and much more desirably C₆₋₁₂ arylthio group) such as phenylthio; a sulfonyl group (desirably C₁₋₂₀, more desirably C₁₋₁₆ and much more desirably C₁₋₁₂ sulfonyl group) such as mesyl or tosyl; a sulfinyl group (desirably C₁₋₂₀, more desirably C₁₋₁₆ and much more desirably C₁₋₁₂ sulfinyl group) sch as methane sulfinyl or benzenesulfinyl; an ureido group (desirably C₁₋₂₀, more desirably C₁₋₁₆ and much more desirably C₁₋₁₂ ureido group) such as unsubstituted ureido, methylureido or phenylureido; a phosphoric amide (desirably C₁₋₂₀, more desirably C₁₋₁₆ and much more desirably C₁₋₁₂ phosphoric amide) such as diethylphosphoric amide or phenylphosphoric amide; a hydroxy group, a mercapto group, a halogen atom such as fluorine, chlorine, bromine or iodine; a cyano group, a sulfo group, a carboxyl group, a nitoro group, a hydroxamic acid group, a sulfino group, a hydrazino group, an amino group, a hetero cyclic group (desirably C₁₋₃₀ and more desirably C₁₋₁₂ heterocyclic group comprising at least one hetero atom such as nitrogen, oxygen or sulfur) such as imidazolyl, pyridyl, quinolyl, furyl, piperidyl, morpholino, benzoxazolyl, benzimidazolyl or benzthiazolyl; and a silyl group (desirably C₃₋₄₀, more desirably C₃₋₃₀ and much more desirably C₃₋₂₄ silyl group) such as trimethylsilyl or triphenylsilyl. These substituents may be substituted by at least one substituent selected from these. When two substituents are selected, they may be same or different each other. Two or more may, if possible, bond each other to form a ring.

It is preferred that R¹, R² and R³ respectively represent a hydrogen atom, an alkyl group, a halogen atom (such as fluorine, chlorine, bromine or iodine) or a group represented by —L—Q described later; more preferred that R¹, R² and R³ respectively represent a hydrogen atom, a C₁₋₆ alkyl group, chlorine or a group represented by —L—Q described later; much more preferred that R¹, R² and R³ respectively represent a hydrogen atom or a C₁₋₂ alkyl group; and most preferred that R² and R³ are hydrogen and R¹ is hydrogen or methyl. Examples of the alkyl group include methyl, ethyl, n-propyl, n-butyl and sec-butyl. The alkyl group may have any substituent. Examples of the substituent include a halogen atom, an aryl group, a heterocyclic group, an alkoxyl group, an aryloxy group, an alkylthio group, an arylthio group, an acyl group, a hydroxy group, a acyloxy group, an amino group, an alkoxycarbonyl group, an acylamino group, an oxycarbonyl group, a carbomoyl group, a sulfonyl group, a sulfamoyl group, a sulfonamido group, a sulforyl group and a carboxyl group. It is noted that when the alkyl group has any substituent, the carbon atom number of the alkyl group, described above, is the number of the carbon atoms included in the only alkyl group, and the carbon atoms included in the substituent are not counted. Numbers of carbon atoms included in the other groups described later are defined as same as that of the alkyl group.

In the formula [3], L is a divalent linking group selected from the above defined group or any combination of two or more selected from the above identified group. The R⁴ in —NR⁴— described above represents a hydrogen atom, an alkyl group, an aryl group or an aralkyl group, and desirably a hydrogen atom or an alkyl group. And the R⁵ in —PO(OR⁵)— represents an alkyl group, an aryl group or an aralkyl group, and desirably an alkyl group. When R⁴ or R⁵ is an alkyl group, an aryl group or an aralkyl group, the desired carbon numbers of them are same as those described in Substituent Group I. L desirably contains a single bond, —0—, —CO—, —NR⁴—, —S—, —SO₂13 , an alkylene group or arylene group; more desirably contains a single bond, —CO—, —O—, —NR⁴—, an alkylene group or an arylene group; and much more desirably represents a single bond. When L contains an alkylene group, the carbon atom number of the alkylene group is desirably from 1 to 12, more desirably from 1 to 8 and much more desirably from 1 to 6. Preferred examples of the alkylene group include methylene, ethylene, trimethylene, terabutylene and hexamethylene. When L contains an arylene group, the carbon atom number of the arylene group is desirably from 6 to 24, more desirably from 6 to 18 and much more desirably from 6 to 12. Preferred examples of the arylene group include phenylene and naphthalene. When L contains a divalent linking group consisting of a combination of an alkylene group and an arylene group, or in other words an aralkyl group, the carbon atom number in the aralkyl group is desirably from 7 to 36, more desirably from 7 to 26 and much more desirably from 7 to 16. Preferred examples of the aralkyl group include phenylene methylene, phenylene ethylene and methylene phenylene. L may have any substituent. Examples of the substituent are same as those exemplified for the substituent of R¹, R² and R³.

Examples of L include, however not to be limited to, those shown below.

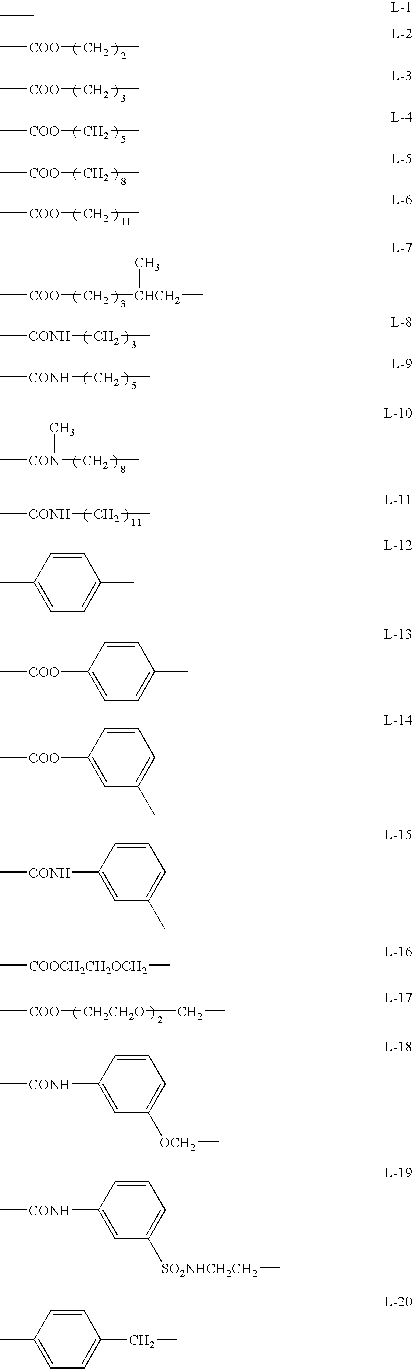

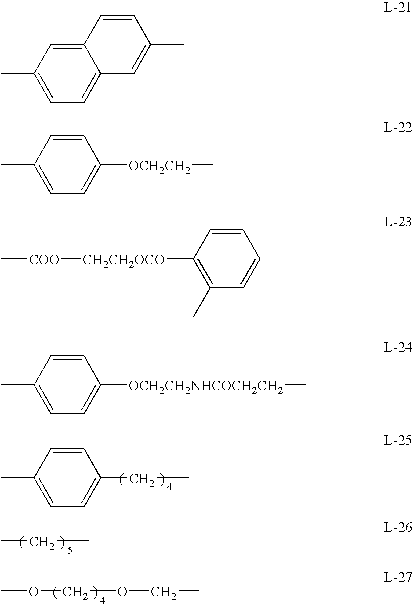

In the formula [3], Q represents a carboxyl group or a carboxylate such as lithium carboxylate, sodium carboxylate, potassium carboxylate, ammonium carboxylate (for example, unsubstituted ammonium carboxylate, tetramethylammonium carboxylate, trimethyl-2-hydroxyethylammmoniun carboxylate, terabutylammonium carboxylate, trimethylbenzylammonium carboxylate or dimethylphanylammmonium carboxylate) or pyridinium carboxylate; a sulfo group or a sulfate (examples of a counter cation are same as those exemplified for the carboxylate above); or a phosphonoxy group or a phosphonoxylate (examples of a counter cation are same as those exemplified for the carboxylate above); an alkyl group (for example, C₁₋₁₈ alkyl group); or a poly(alkyleneoxy) group having a terminal hydrogen atom or a terminal alkyl group. The poly(alkyleneoxy) group is preferably selected from the group represented by (OR)ₓ—G, where R is a C₂₋₄ alkylene group such as —CH₂CH₂—, —CH₂CH₂CH₂—, —CH(CH₃)CH₂— and —CH(CH₃)CH(CH₃—, G is a hydrogen atom or C₁₋₁₂ alkyl group, and is more preferably a hydrogen atom or methyl and x is a natural number. When X is equal to or lager than 2, the poly(oxy alkylene) group may comprise oxyalkylene units of the same species or the different species. Examples of such group include poly(oxypropylene) group. The poly(oxyalkylene) group may also comprise oxyalkylene units of the different two or more species randomly. The poly(oxy alkylene) group may also comprise linear or branched oxypropylene units or oxyethylene units, or linear or branched oxy propylene blocks or oxyethylene blocks.

Examples of the poly(oxyalkylene) group also include the groups formed by combining plural poly(oxyalkylene) chains through one or more linking groups such as —CONH—Ph—NHCO— or —S— where Ph is a phenylene. Combined through the linking group containing a trivalent or higher multivalent atom, branched oxyakylene units are formed.

For employing the copolymer comprising a repeating unit having a poly(oxyalkylene) group in the present invention, the molecular weight of the poly(oxyalkylene) group is preferably from 80 to 3000, and more preferably from 250 to 3000.

Poly (oxyalkylene) acrylate or methacrylate monomers can be prepared by reacting commercially available hydroxy poly(oxyalkylene) materials such as “Pluronic” and “ADEKA POLYETHER” manufactured by ASAHI DENKA CO., LTD., “Carbowax” manufactured by Glico Products “Toriton” manufacture by Rohm and Haas and “P.E.G” , manufactured by DAI-ICHI KOGYO SEIYAKU CO., with acrylic acid, methacrylic acid, acryl chloride, methacryl chloride, acrylic acid anhydride or the like according to any known method. The monomers can be also prepared using poly(oxyalkylene) diacrylate or the like prepared according to any know method.

Examples of the monomer represented by the formula [3], which can be used in producing the fluoride-polymer, include, however not to be limited to, those shown below. The monomer is generally obtained as a mixture of compounds having different polymerization degrees “X” of poly(alkylenoxy) grop, and the examples are shown below as compounds having a polymerization degree of an integer which is nearly equal to the mean polymerization degree.

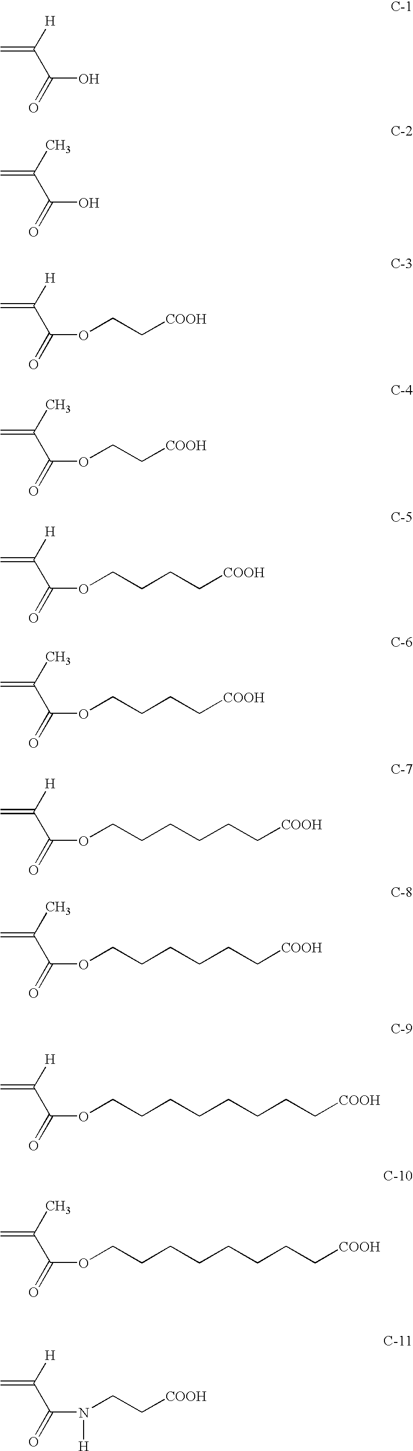

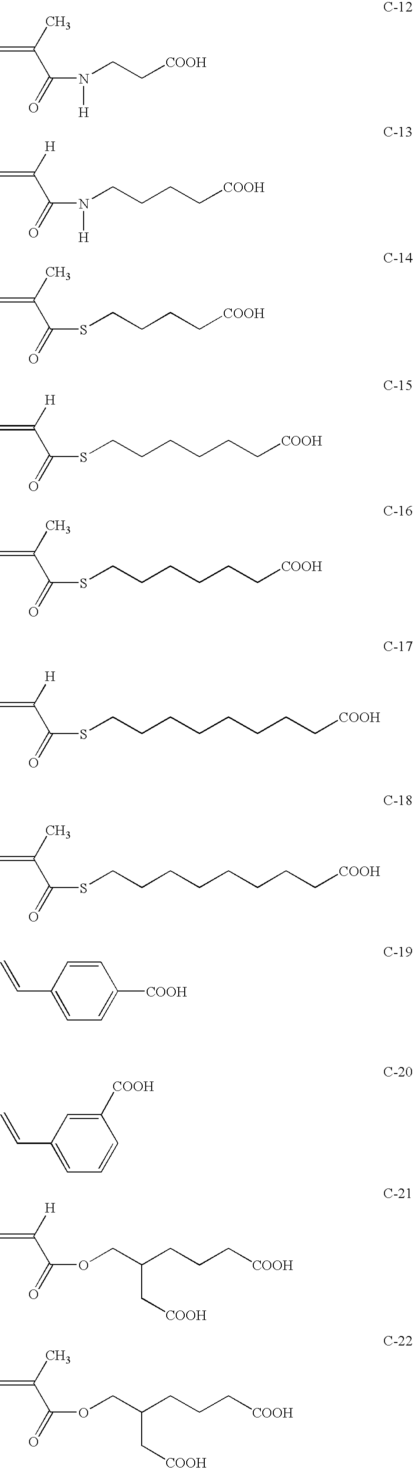

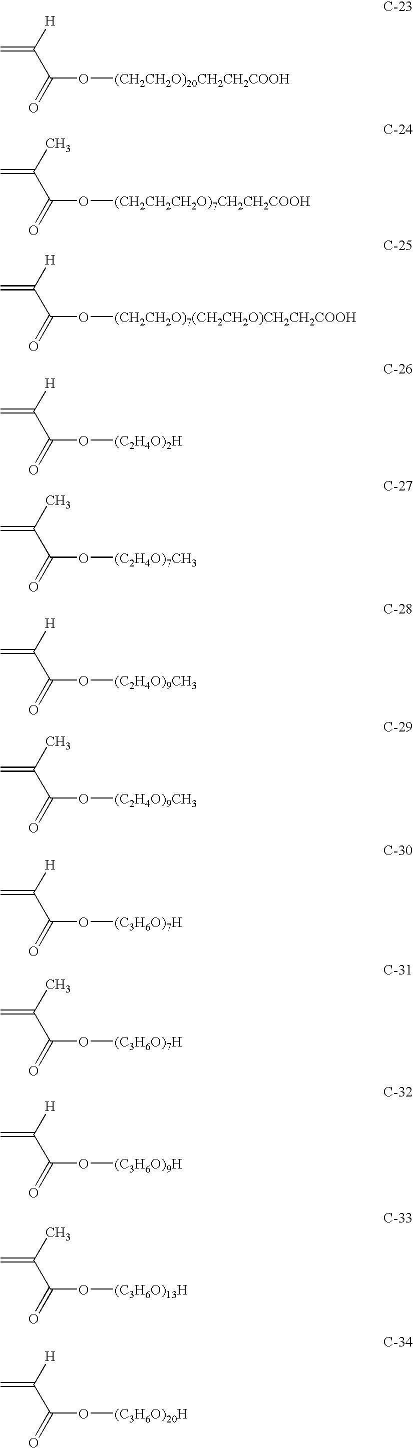

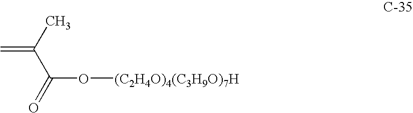

The fluoride-polymer may comprise a single or plural repeating unit derived from the formula [3]. The fluoride-polymer may comprise a single or plural repeating unit other than the repeating units described above. Another repeating unit is not to be limited to a specific type, and any repeating unit derived from common monomers capable of radical-polymerization is preferably used. Examples of the monomer which can give the other repeating unit include, however not to be limited to, those shown below. The fluoride-polymer may comprise one repeating unit or plural repeating units selected from those shown below.

(Monomer Group I)

(1) Alkenes:

ethylene, propylene, 1-buten, isobuten, 1-hexane, 1-dodecene, 1-octadecene, 1-eicocene, hexafluoropropene, vinylidene fluoride, chlorotrifluoroethylene, 3,3,3-trifuluoropropylene, tetrafluoroethylene, vinyl chloride, vinylidene chloride or the like;

(2) Dienes:

1,3-butadiene, isoprene, 1,3-pentadiene, 2-ethyl-1,3-butadiene, 2-n-propyl-1,3-butadiene, 2,3 dimethyl-1,3-butadiene, 2-methyl-1,3-pentadiene, 1-phenyl-1,3-butadiene, 1-α-naphytl-1,3-butadiene, 1-β-naphtyl-1,3-butadiene, 2chloro-1,3-butadiene, 1-bromo-1,3-butadiene, 1-chlorobutadiene, 2-fluoro-1,3-butadiene, 2,3-dichloro-1,3-butadiene, 1,1,2-trichloro-1,3-butadiene, 2-cyano-1,3-butadiene, 1,4-divinyl cyclohexane or the like;

(3) α,β-unsaturated carboxylic acid derivatives:

(3a) Alkyl acrylates:

methyl methacrylate, ethyl acrylate, n-propyl acrylate, isopropyl acrylate, n-butyl acrylate, isobutyl acrylate, sec-butyl acrylate, tert-butyl acrylate, amyl acrylate, n-hexyl acrylate, cyclohexyl acrylate, 2-ethylhexyl acrylate, n-octyl acrylate, tert-octyl acrylate, dodecyl acrylate, phenyl acrylate, benzyl acrylate, 2-chloroethyl acrylate, 2-bromoethyl acrylate, 4-chlorobutyl acrylate, 2-cyanoethyl acrylate, 2-acetoxyethyl acrylate, methoxybenzyl acrylate, 2-chlorocyclohexyl acrylate, furfuryl acrylate, tertrahydrofurfuryl acrylate, 2-methoxyethyl acrylate, ω-methoxy polyethyleneglycol acrylate (having additional molar number, n, of 2 to 100), 3-metoxybutyl acrylate, 2-ethoxyethyl acrylate, 2-butoxyethyl acrylate, 2-(2-butoxyethoxy)ethyl acrylate, 1-bromo-2-methoxyethyl acrylate, 1,1-dichloro-2-ethoxyethyl acrylate, glycidyl acrylate or the like;

(3b) Alkyl methacrylates:

methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, n-hexyl methacrylate, cyclohexyl methacrylate, 2-ethylhexyl methacrylate, n=octyl methacrylate, stearyl methacrylate, benzyl methacrylate, phenyl methacrylate, allyl methacrylate, furfuryl methacrylate, tertrahydrofurfuryl methacrylate, Cheryl methacrylate, naphthyl methacrylate, 2-methoxyethyl methacrylate, 3metoxybutyl methacrylate, ω-methoxy polyethyleneglycol 2-butoxyethyl methacrylate, 2-(2-butoxyethoxy)ethyl methacrylate, glycidyl methacrylate, 3-trimetoxysilylpropyl methacrylate, allyl methacrylate, 2-isosyanate ethyl methacrylate or the like;

(3c) Diesters of unsaturated polycarboxylic acids:

dimethyl maleate, dibutyl maleate, dimethyl itaconate, dibutyl itaconate, dibutyl crotonate, dihexyl crotonate, diethyl fumarate, dimethyl fumarate or the like;

(3d) Amides of α,β-unsaturated carboxylic acids:

N,N-dimethyl acrylamide, N,N-diethyl acrylamide, N-n-propyl acrylamide, N-tert-butyl acrylamide, N-tert-octyl acrylamide, N-cyclohexyl acrylamide, N-phenyl acrylamide, N-(2-acetoacetoxyethyl)acrylamide, N-benzyl acrylamide, N-acryloyl morpholine, diacetone acrylamide, N-methyl maleimide or the like;

(4) Unsaturated nitriles:

acrylonitrile, methacrylonitrile or the like;

(5) Styrene or derivatives thereof:

styrene, vinyltoluene, ethylstyrene, p-tert-butylstyrene, p-vinyl methyl benzoate, α-methyl styrene, p-chloromethyl styrene, vinyl naphthalene, p-methoxy styrene, p-hydroxy methyl styrene, p-acetoxy styrene or the like;

(6) Vinyl esters:

vinyl acetate, vinyl propanate, vinyl butyrate, vinyl isobutyrate, vinyl benzoate, vinyl salicylate, vinyl chloroacetate, vinyl methoxy acetate, vinyl phenyl acetate or the like;

(7) Vinyl ethers:

methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, n-dodecyl vinyl ether, n-eicosyl vinyl ether, 2-ethylhexyl vinyl ether, cyclohexyl vinyl ether, fluorobutyl vinyl ether, fluorobutoxyethyl vinyl ether or the like; and

(8) Other monomers

N-vinyl pyrrolidone, methyl vinyl ketone, phenyl vinyl ketone, methoxy ethyl vinyl ketone, 2-vinyl oxazoline, 2-isopropyl oxazoline or the like.

The monomer which can give other repeating unit not containing fluoro-aliphatic group is desirably selected from the group represented by a formula [4].

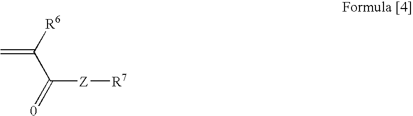

In the formula [4], R⁶ is hydrogen or methyl, z represents a divalent linking group, R⁷ represents an optionally substituted linear, branched or cyclic C₁₌₂₀ alkyl group. The linking group represented by Z is desirably selected from an oxygen atom, a sulfur atom and —N(R⁵)—. R⁵ represents a hydrogen atom, a C₁₋₄ alkyl group such as methyl, ethyl, propyl or butyl. R⁵ is desirably hydrogen or methyl. Z desirably represents an oxygen atom, —NH— or —N(CH₃)—.

Examples of the C₁₋₂₀ alkyl group represented by R⁷ include linear or branched alkyl groups such as methyl, ethyl, propyl, butyl, pentyl, hexyl, heptyl, octyl, nonyl, decyl, undecyl, dodecyl, tridecyl, tetradecyl, pentadecyl, octadecyl or eicosanyl, single cyclic alkyl groups such as cyclohexyl or cycloheptyl and polycyclic alkyl groups such as bicycloheptyl, bicyclodecyl, tricycloundecyl, tetracyclododecyl, adamantyl, norbornyl or tetracyclodecyl. The poly(alkylenoxy) group or the alkyl group represented by R⁷ may have a substituent, and examples of the substituent include, however not to be limited to, a hydroxy group, an alkylcarbonyl group, an arylcarbonyl group, an alkylcarbonyloxy group, a carboxyl group, an alkylether group, an arylether group, a halogen atom such as fluorine, chlorine or bromine, a nitro group, a cyano group and an amino group.

The monomer represented by the formula [4] is desirably selected from alkyl (meth)acrylates or poly(alkyleneoxy)(meth)acrylates.

Examples of the monomer represented by the formula [4] include, however not to be limited to, those shown below.

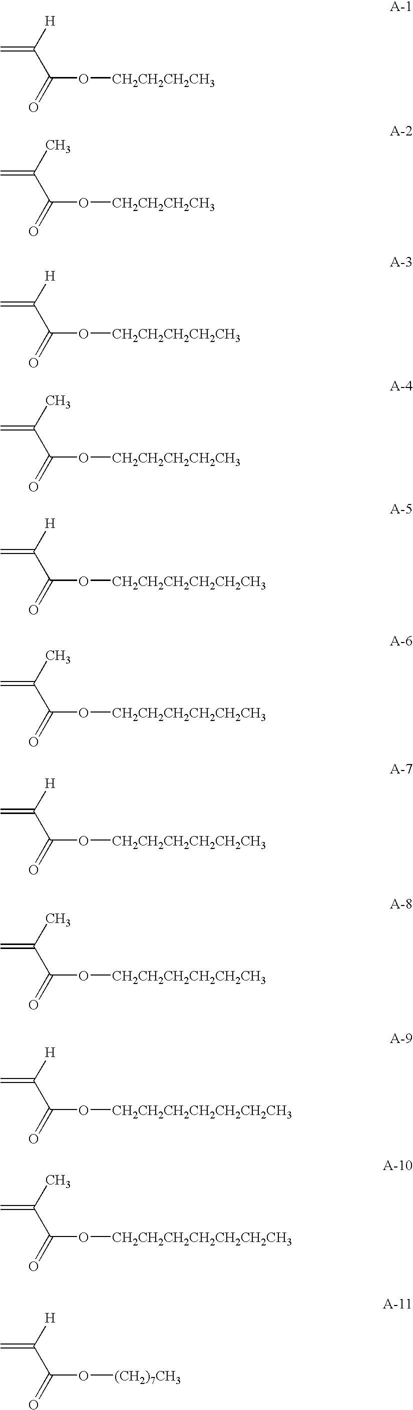

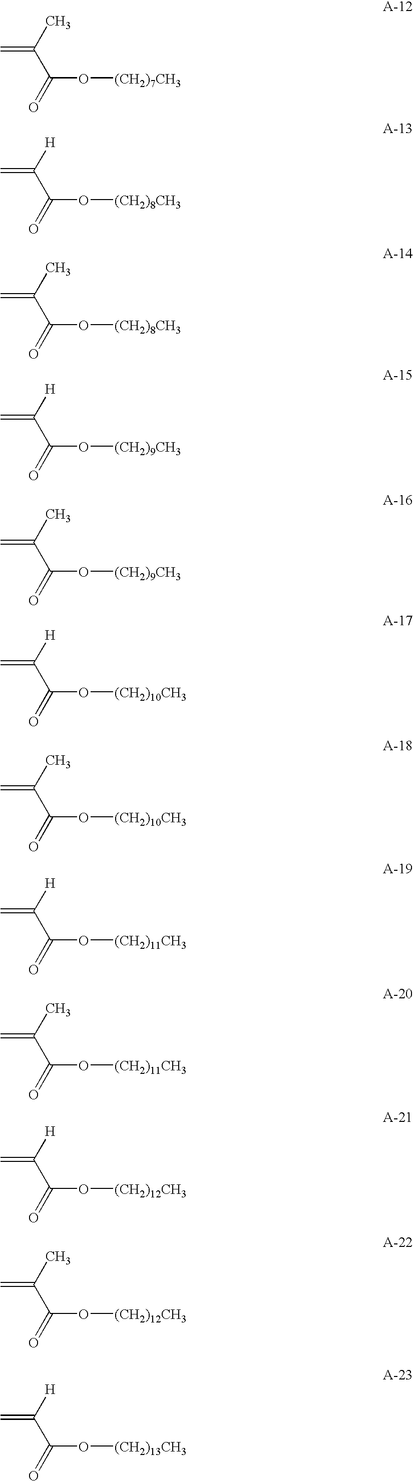

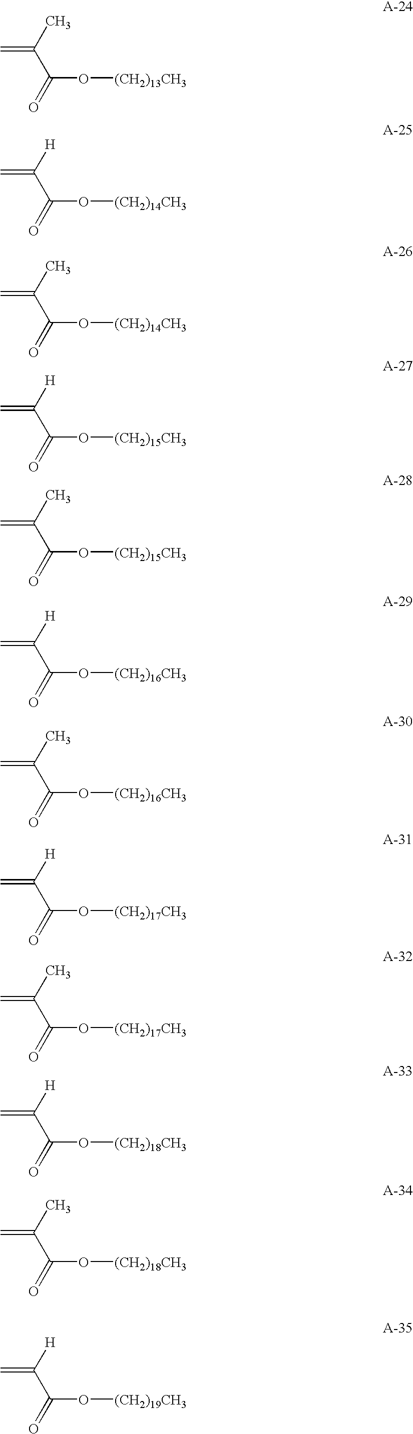

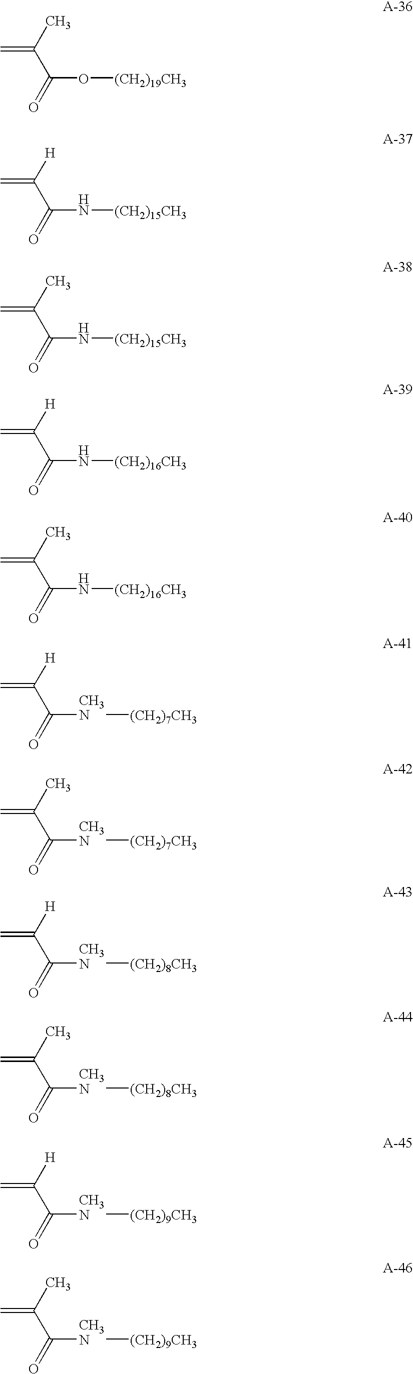

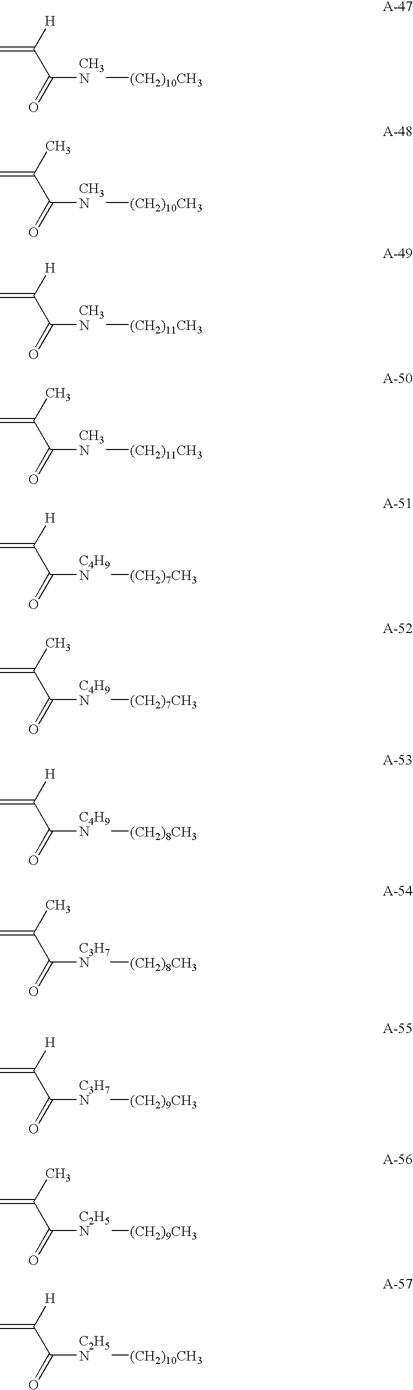

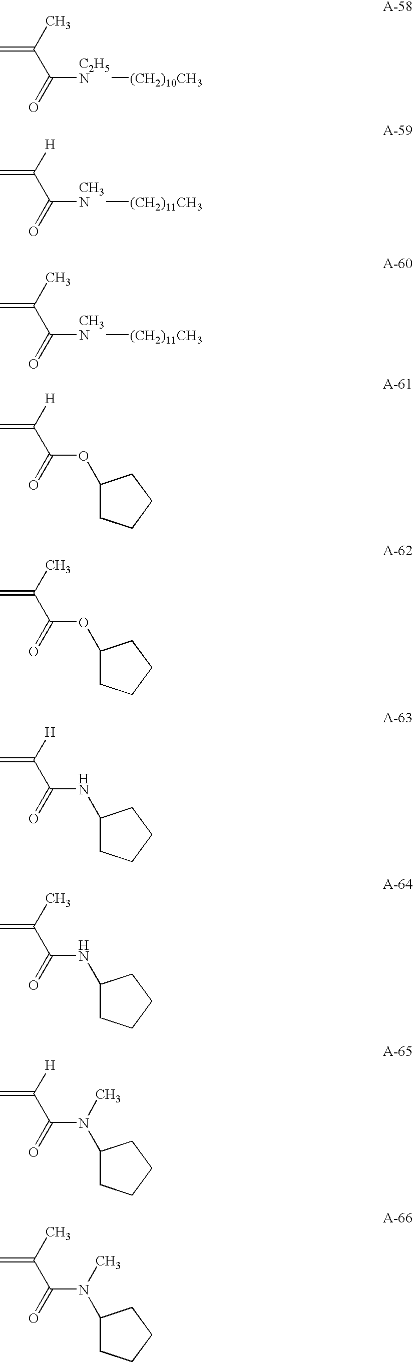

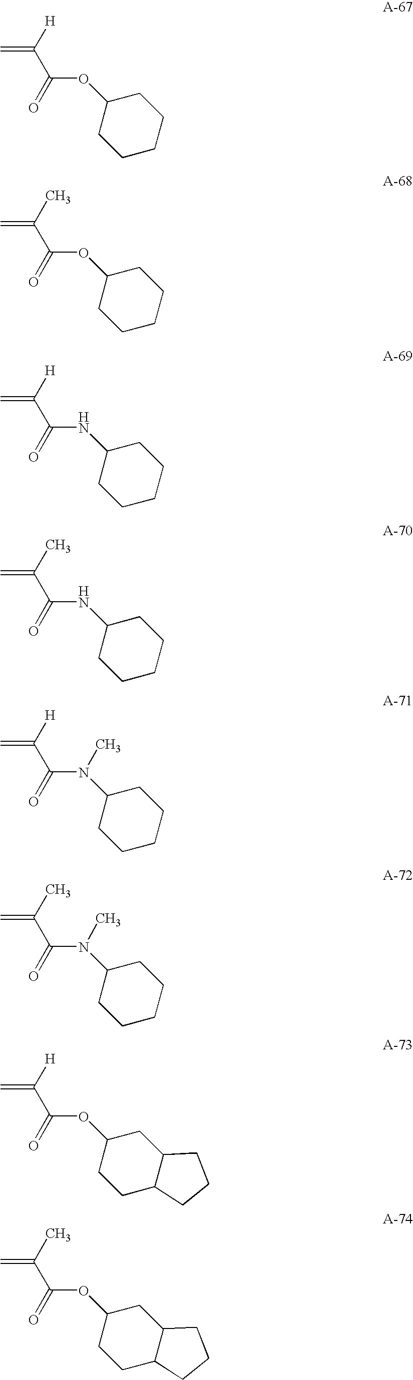

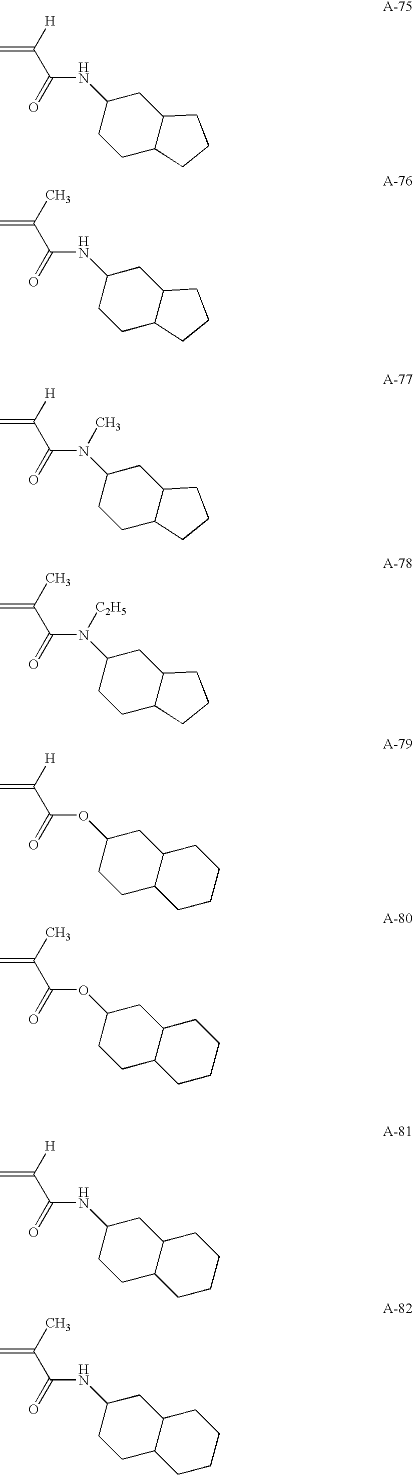

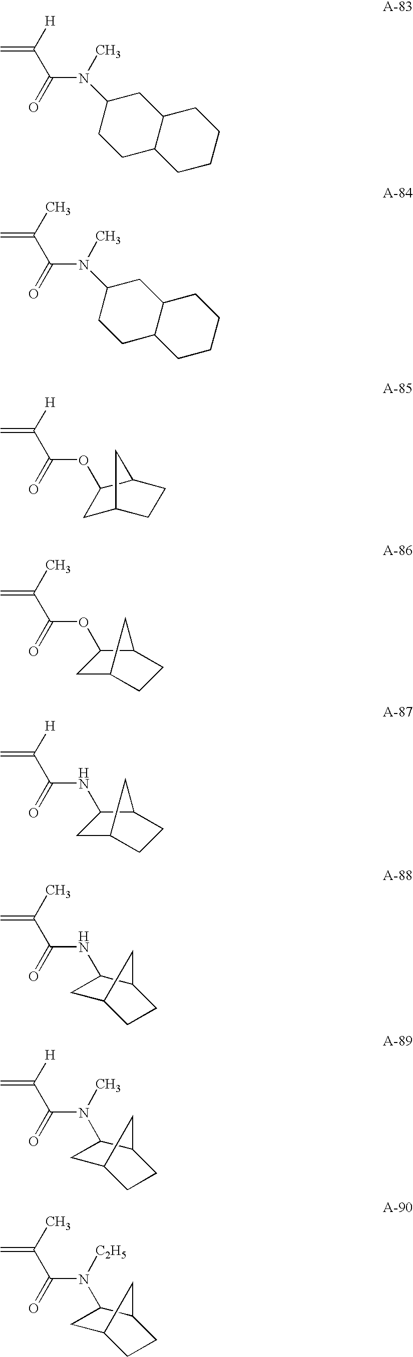

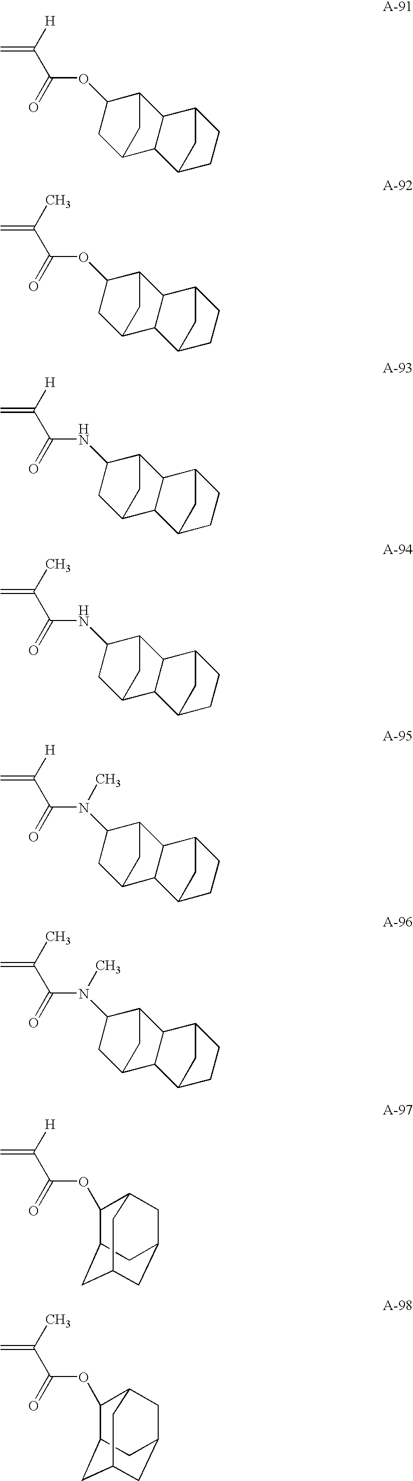

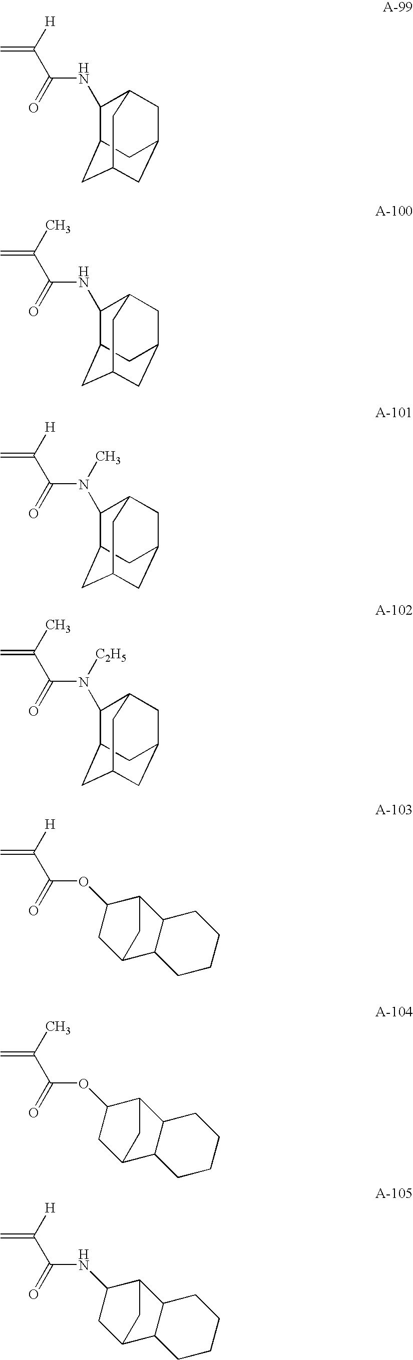

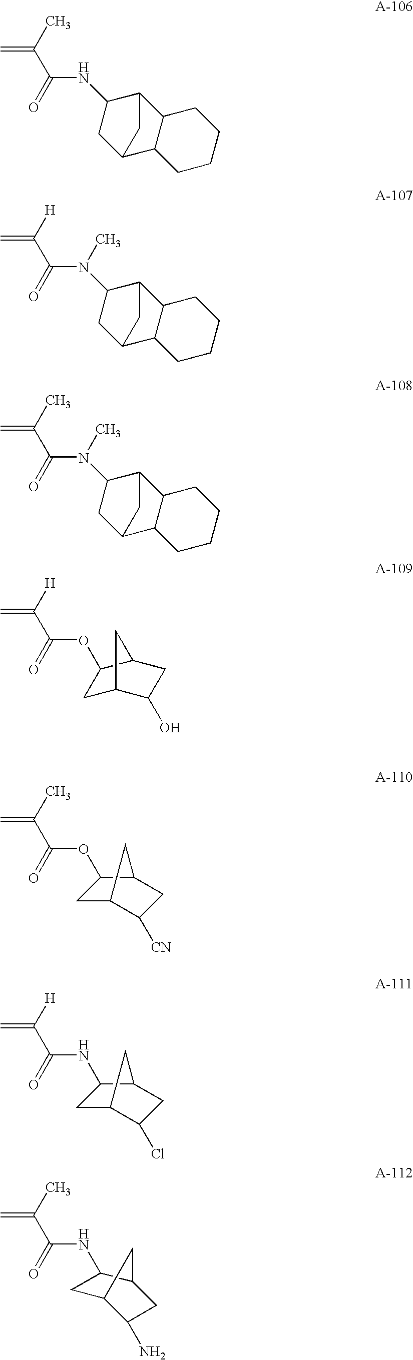

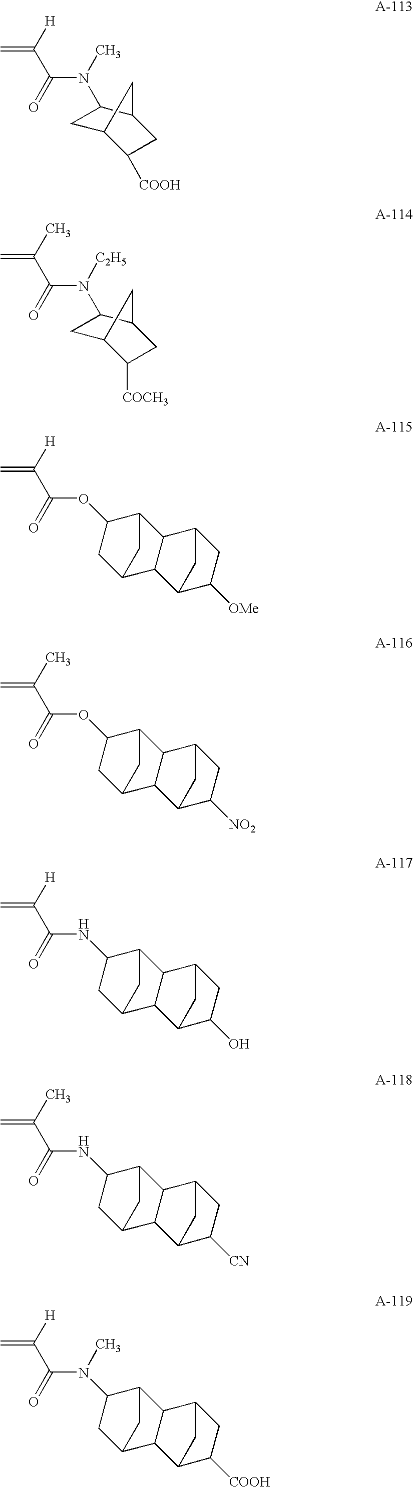

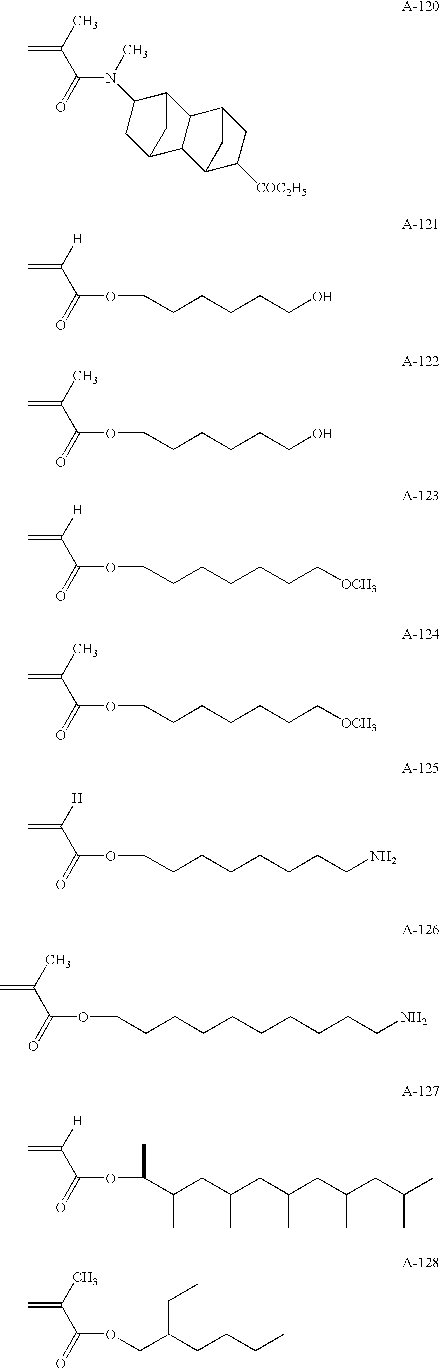

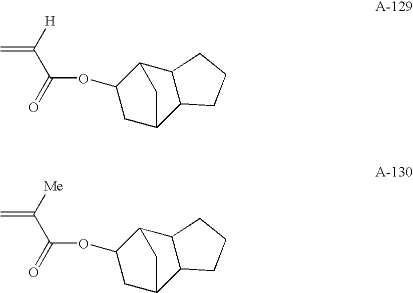

It is preferred that the optically anisotropic layer comprises at least two types of the fluoride-polymers. Employing two or more types of the fluoride-polymers may make it possible to adjust independently a surface smoothness of the layer and an alignment of liquid crystal molecules, and, therefore, make it possible to give a good balance between a surface smoothness and an ability of widening a viewing angle to the layer.

The amount of the monomer containing a fluoro aliphatic group is desirably not less than 5 wt%, more desirably not less than 10 wt%, and much more desirably not less than 30 wt% with respect to the total amount of all monomers constituting the fluoride-polymer.

The weight-average molecular weight (Mw) of the fluoride-polymer to be used in the invention is desirably from 1,000 to 1,000,000, more desirably from 1,000 to 500,000 and much more desirably from 1,000 to 100,000. The Mw can be measured as a polystyrene (PS) equivalent molecular weight with gel permeation chromatography (GPC).

Examples of the method for producing the fluoride-polymer include, however not to be limited to, a radical-polymerization or a cation-polymerization employing a vinyl group and an anion-polymerization, and among them, a radical-polymerization is preferred since it is common. Known radical thermal or radical photo polymerization initiators may be used in the process for producing the fluoride-polymer. Especially, radical thermal polymerization initiators are preferred. It is noted that a radical thermal polymerization is a compound capable of generating radicals when being heated at a decomposition temperature or a higher temperature than it. Examples of the radical thermal polymerization include diacyl peroxides such as acetyl peroxide or benzoyl peroxide; ketone peroxides such as methyl ethyl ketone peroxide or cyclohexanone peroxide, hydro peroxides such as hydrogen peroxide, tert-butylhydro peroxide or cumenehydro peroxide; dialkyl peroxides such as di-tert-butylperoxide, dicumyl peroxide or dilauroyl peroxide; peroxy esters such as tert-butylperoxy acetate or tert-butylperoxy pivalate; azo-based compounds such as azo bis iso-butylonitrile or azo bis iso-valeronitrile and persulfates such as ammonium persulfate, sodium persulfate or potassium persulfate. A single polymerization initiator may be used, or plural types of polymerization initiators may be used in combination.

The radical polymerization may be carried out according to any process such as an emulsion polymerization, dispersion polymerization, a bulk polymerization or a solution polymerization process. One of the typical radical polymerization may be carried out according to a solution polymerization, and is more specifically described below. The details of other polymerization processes are as same as those described below, and for details, it is possible to refer to “Experimental Methods of Polymer Science (Kohbunshi kagaku jkkenn-hoh)” published by TOKYO KAGAKU DOZIN CO., LTD. in 1981 or the like.

For solution polymerization, at least one organic solvent is used. The organic solvent can be selected from any organic solvents which never limit the purpose or the effect of the present invention. Organic solvents are usually understood as an organic compound having a boiling point of 50 to 200° C. at atmosphere pressure, and among them, organic compounds capable of dissolving the components uniformly are preferred. Preferred examples of the organic solvent include alcohols such as isopropanol or butanol; ethers such as dibutyl ether, ethylene glycol dimethyl ether, tetrahydrofuran or dioxane; ketones such as acetone, methyl ethyl ketone, methyl isobutyl ketone or cyclohexanone; esters such as ethyl acetate, butyl acetate, amyl acetate or γ-butyrolactone; aromatic hydrocarbons such as benzene, toluene or xylene. A single organic solvent may be used, or plural types of the organic solvents may be used in combination. Mixed solvents which are prepared by mixing at least one organic solvent and water may also used from the view point of solubility of monomers to be used or polymers to be produced.

The solution polymerization may be carried out, however not to be limited to, at a temperature of 50 to 200° C. for a time of 10 minutes to 30 hours. Inert gas purge is desirably performed before or while carrying out the solution polymerization to avoid deactivation of the generated radicals. Nitrogen gas is usually used as an inert gas.

Radical polymerization with at least one chain transfer agent is useful for producing fluoride-polymers having a proper molecular weight. Examples of the chain transfer agent include mercaptans such as octyl mercaptan decyl mercaptan, dodecyl mercaptan, tert-dodecyl mercaptan, octadecyl mercaptan, thiophenol or p-nonyl thiophenol; polyhalogenated alkyls such as carbon tetrachloride, chloroform 1,1,1-trichloroethane or 1,1,1-tribromo octane; and low-activity monomers such as α-methyl styrene or α-methyl styrene dimer. Among these, C₄₋₁₆ mercaptans are preferred. The amount of the chain transfer agent to be used should be precisely controlled depending on an activity thereof, a type of monomer to be used or polymerization conditions, and is usually, however not to be limited to, 0.01 to 50 mole %, desirably from 0.05 to 30 mole % and much more desirably from 0.08 to 25 mole % with respect to total moles of the monomers to be used. The timing or the method of addition of the chain transfer agent is not to be limited subjected to presence of the chain transfer agent in a polymerization system with at least one monomer to be controlled its polymerization degree during polymerization process. The chain transfer agent may be added by dissolving in the monomer, or in other words in the same time as addition of the monomer, or separately from the addition of the monomer.

Examples of the fluoride-polymer which can be used desirably in the invention include, however not to be limited to, those shown below. Numerical values in formulae shown below mean wt% of each monomer, and Mw in formulae shown below means PS-equivalent weight-average molecular weight measured by GPC. In the formulae, “a”, “b”, “c”, “d” and the like mean weight ratios.

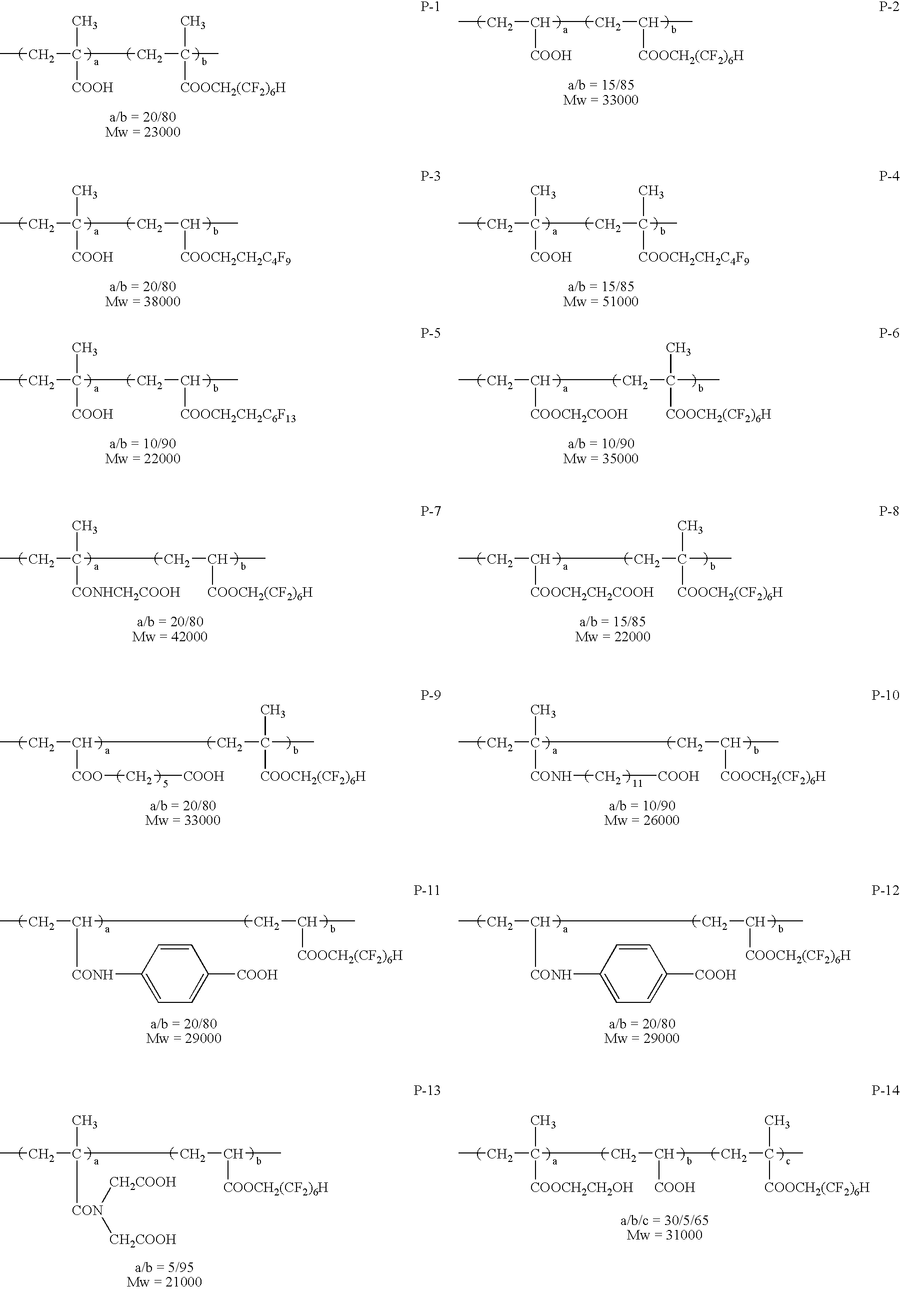

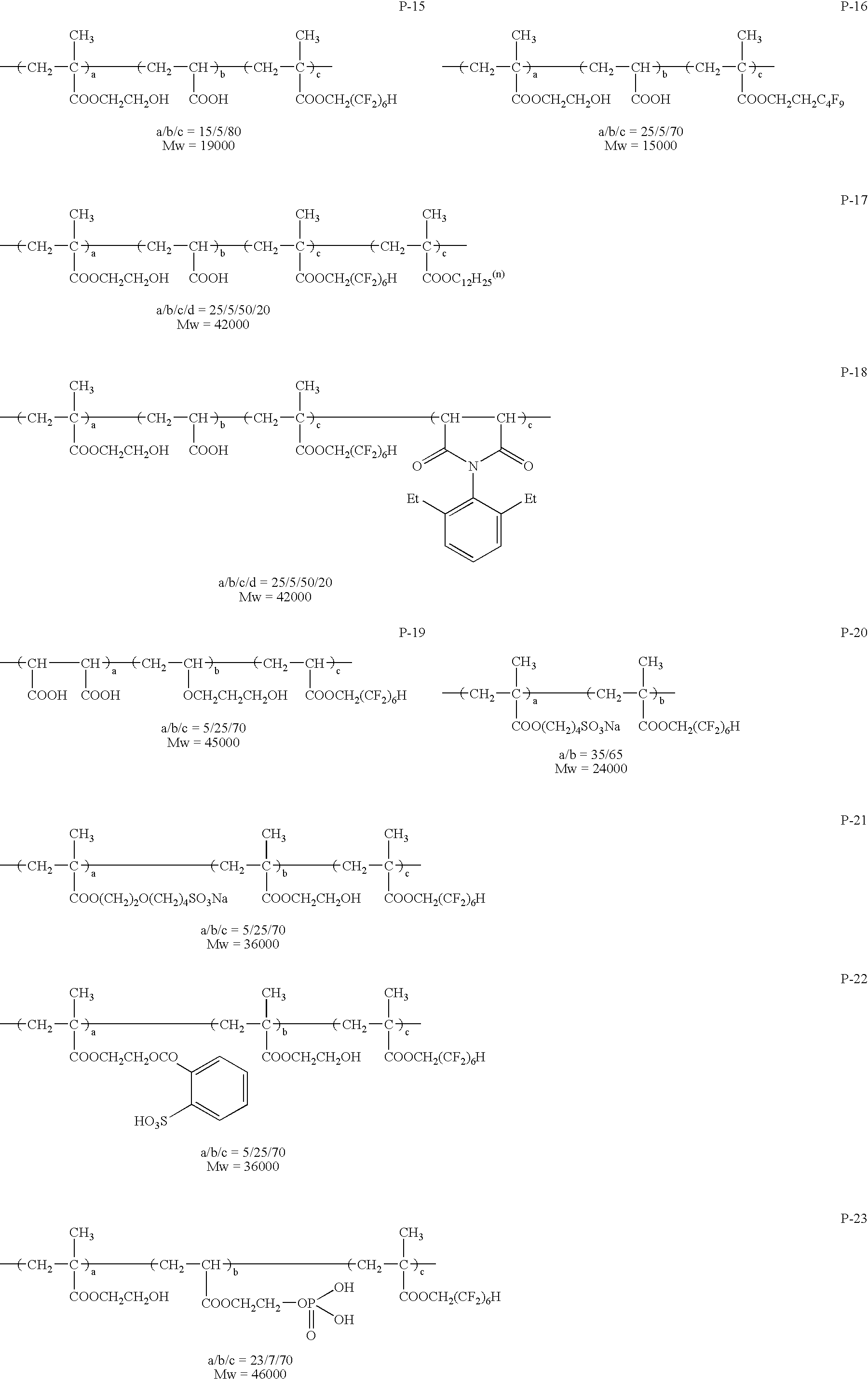

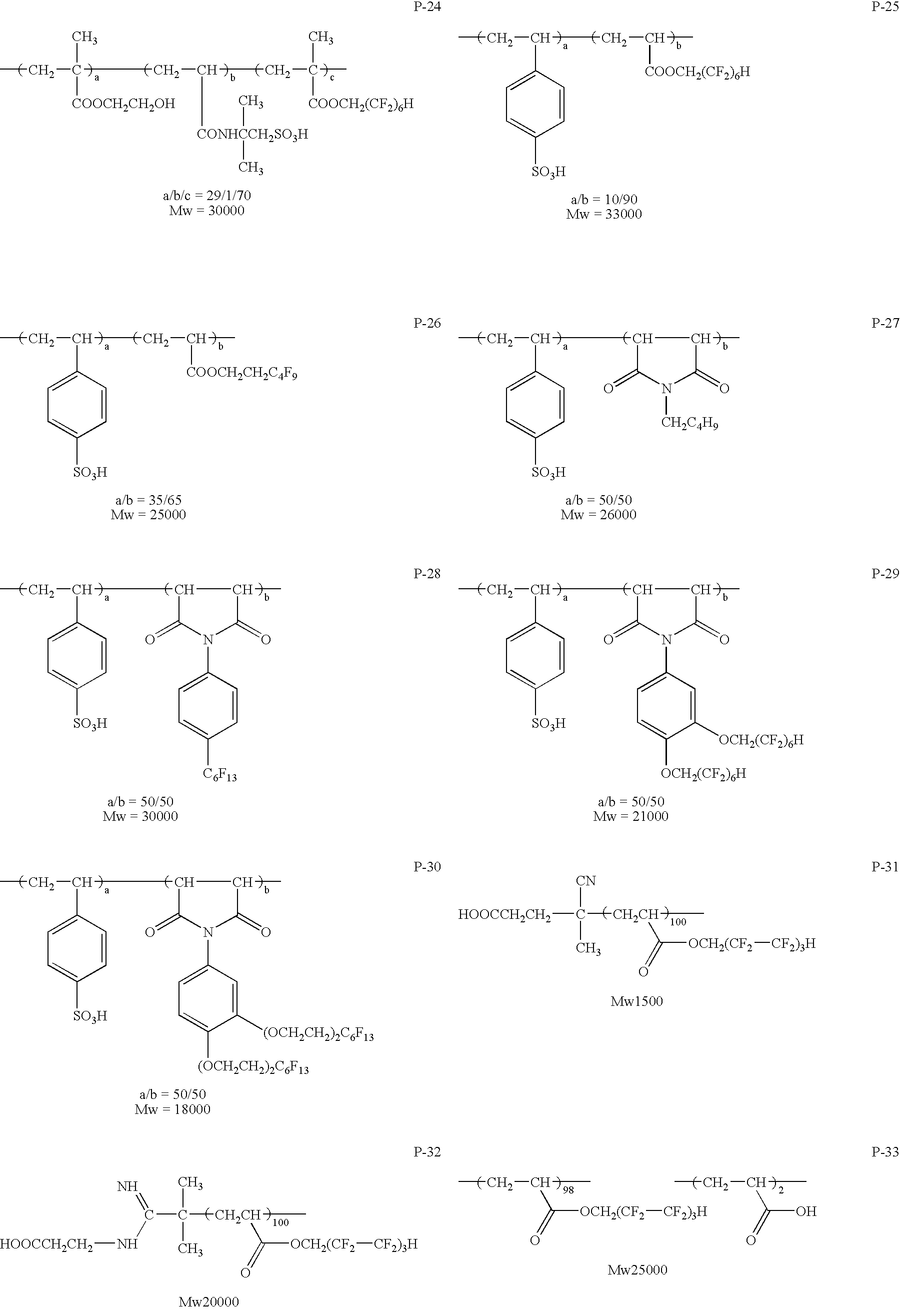

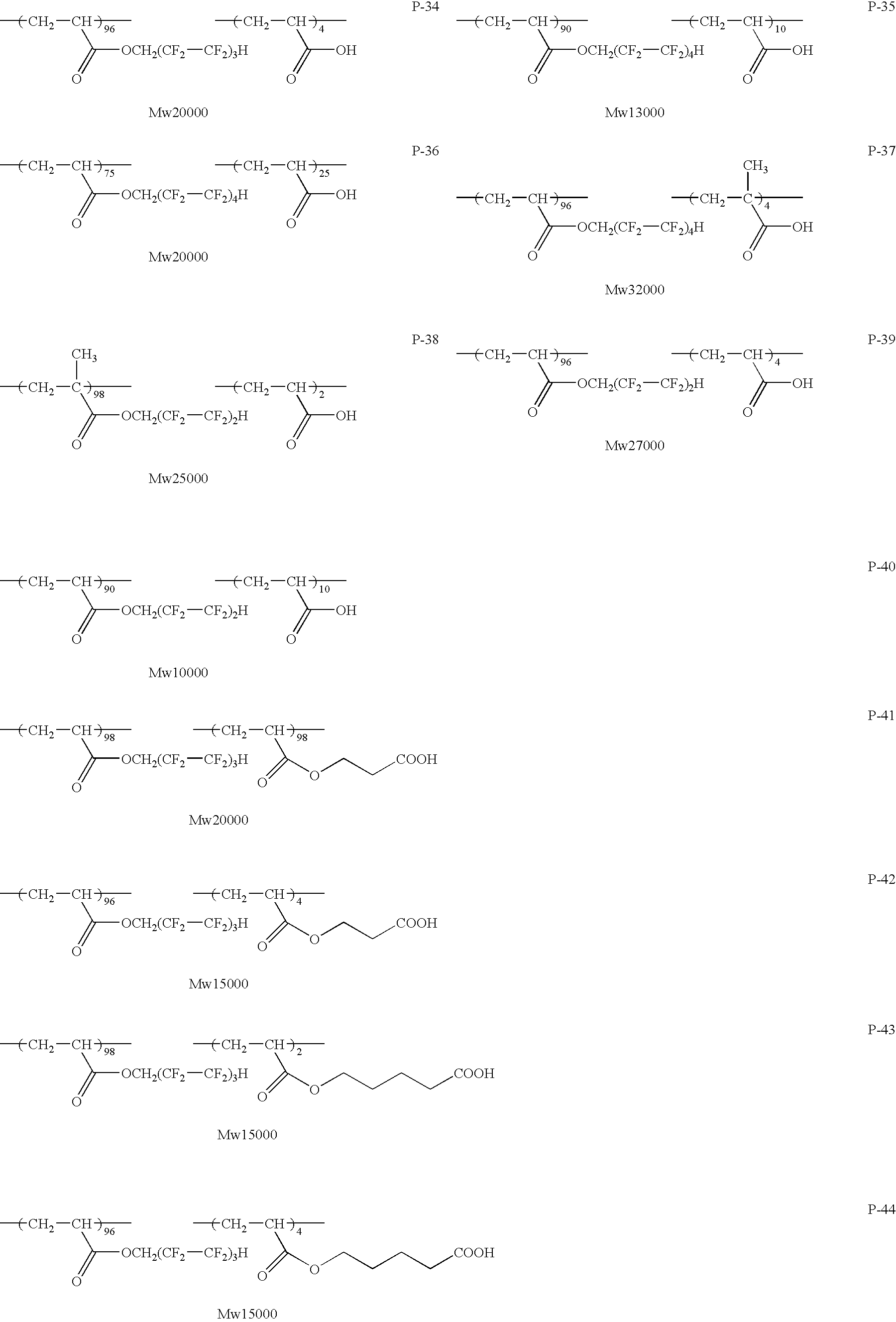

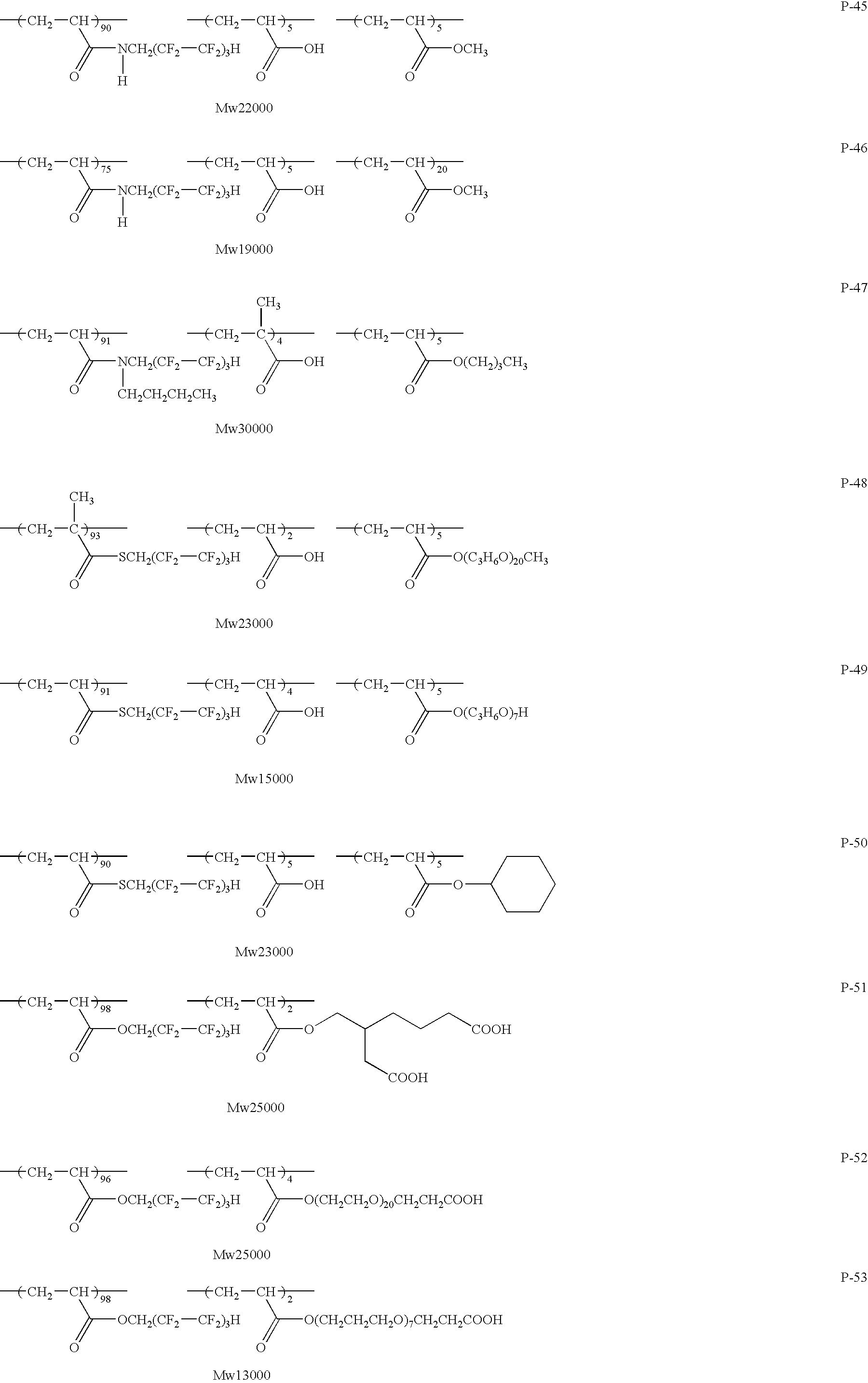

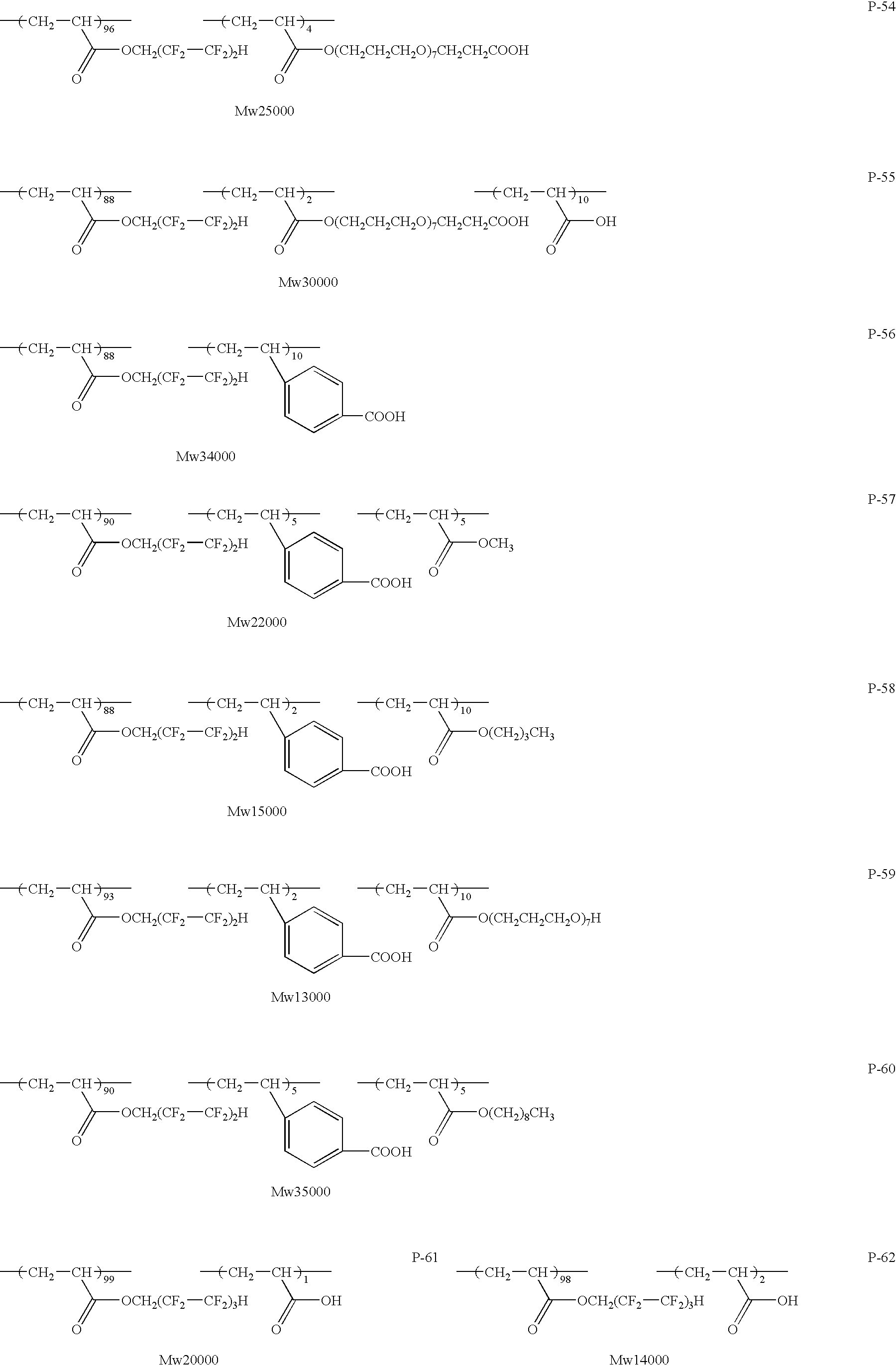

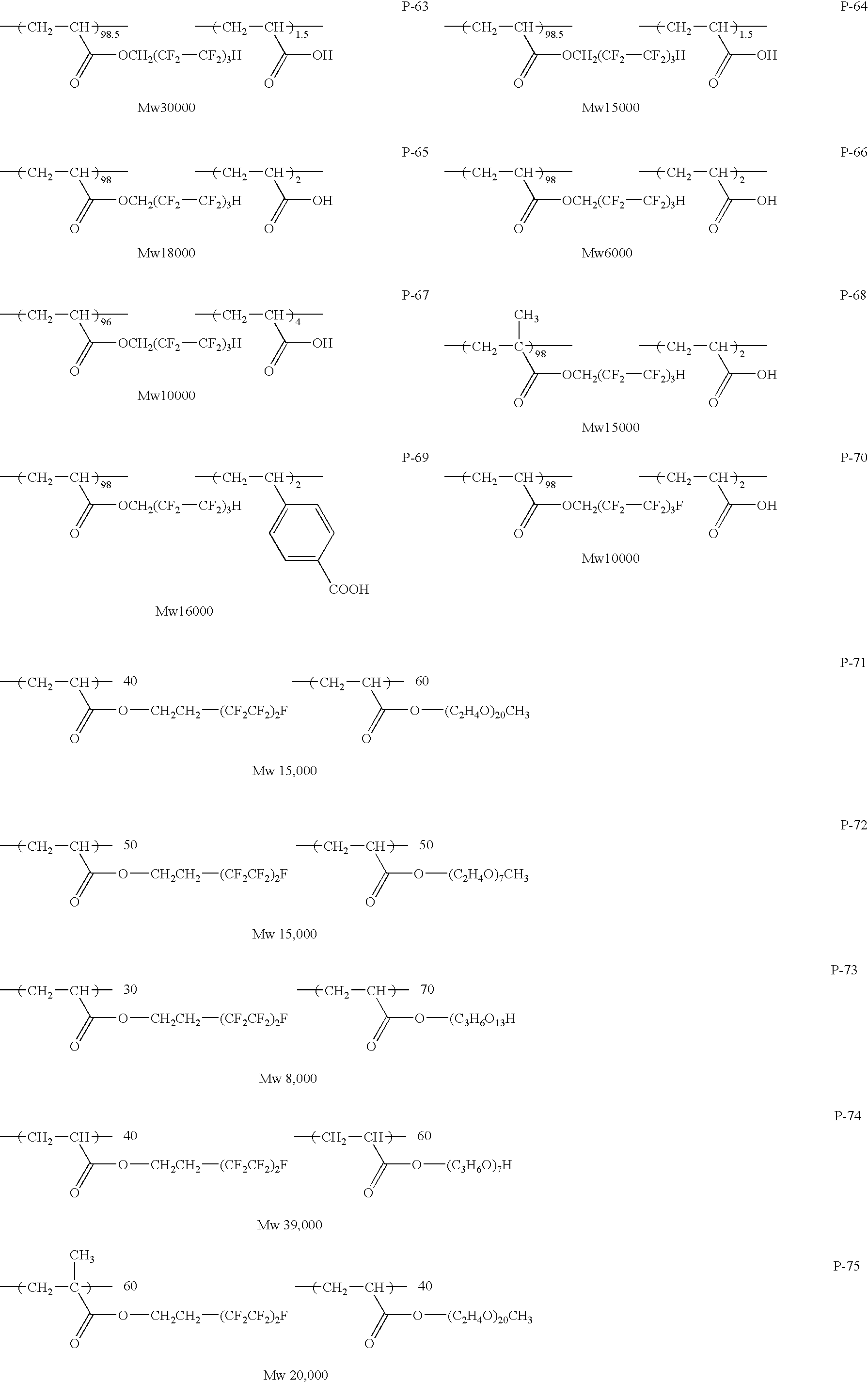

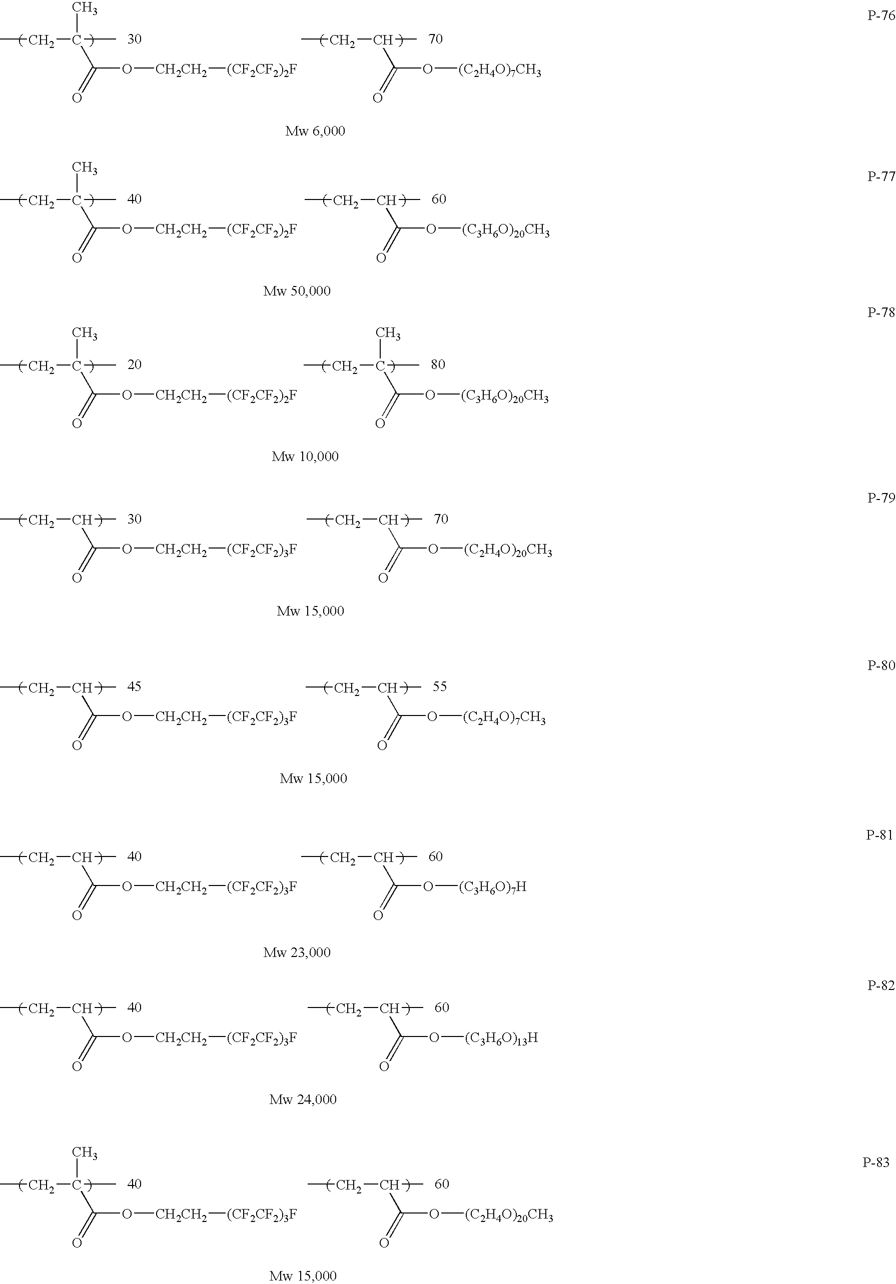

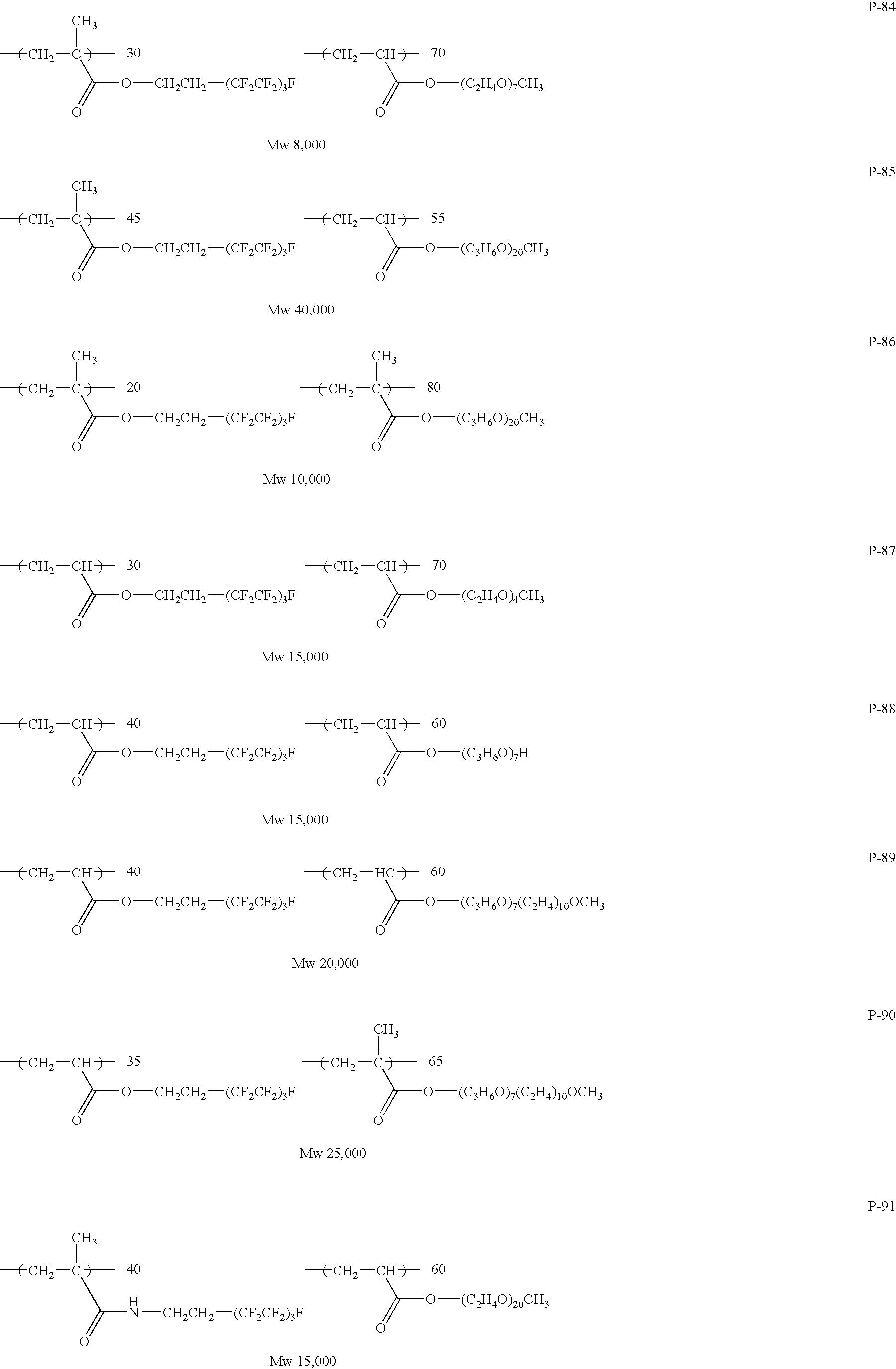

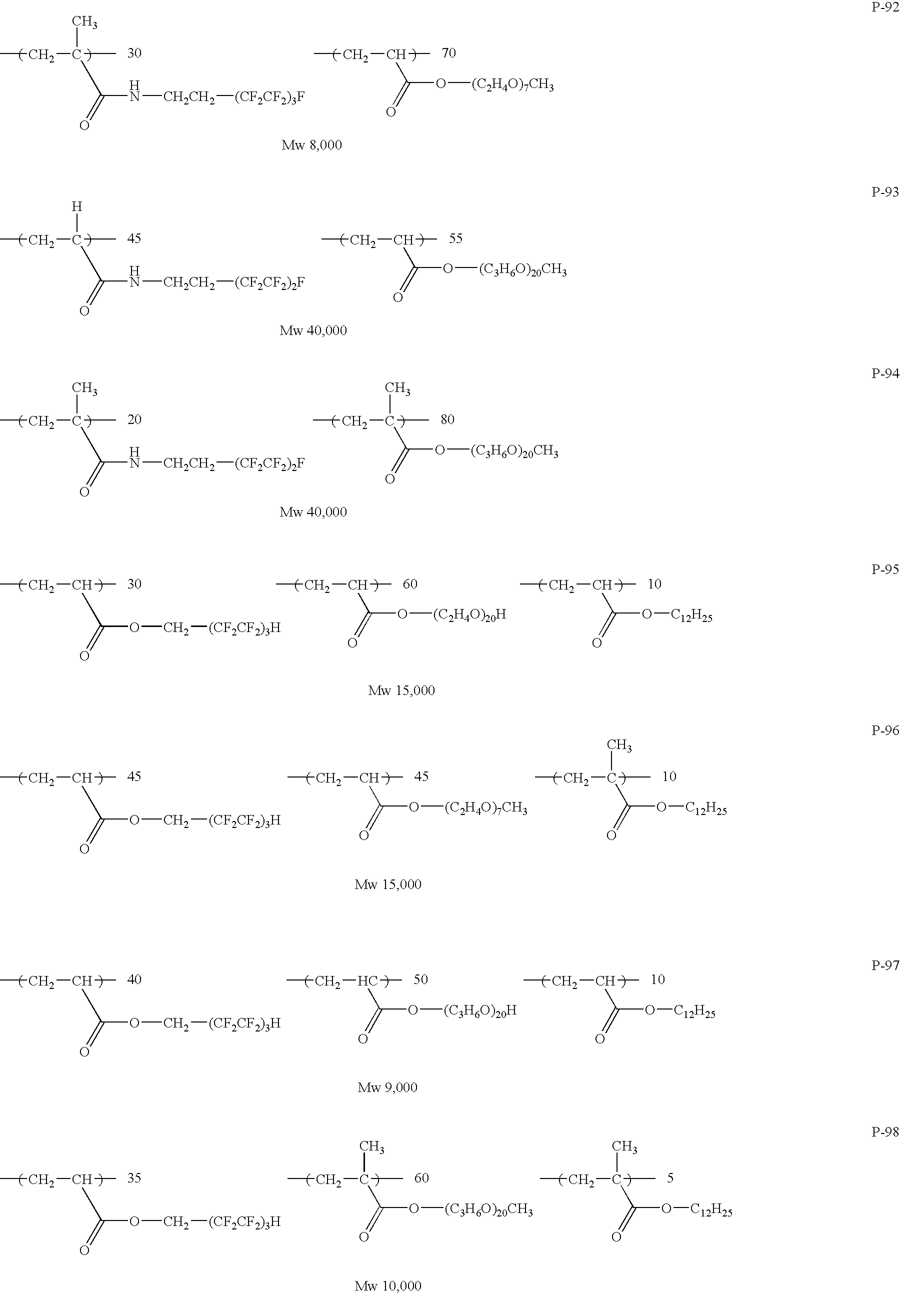

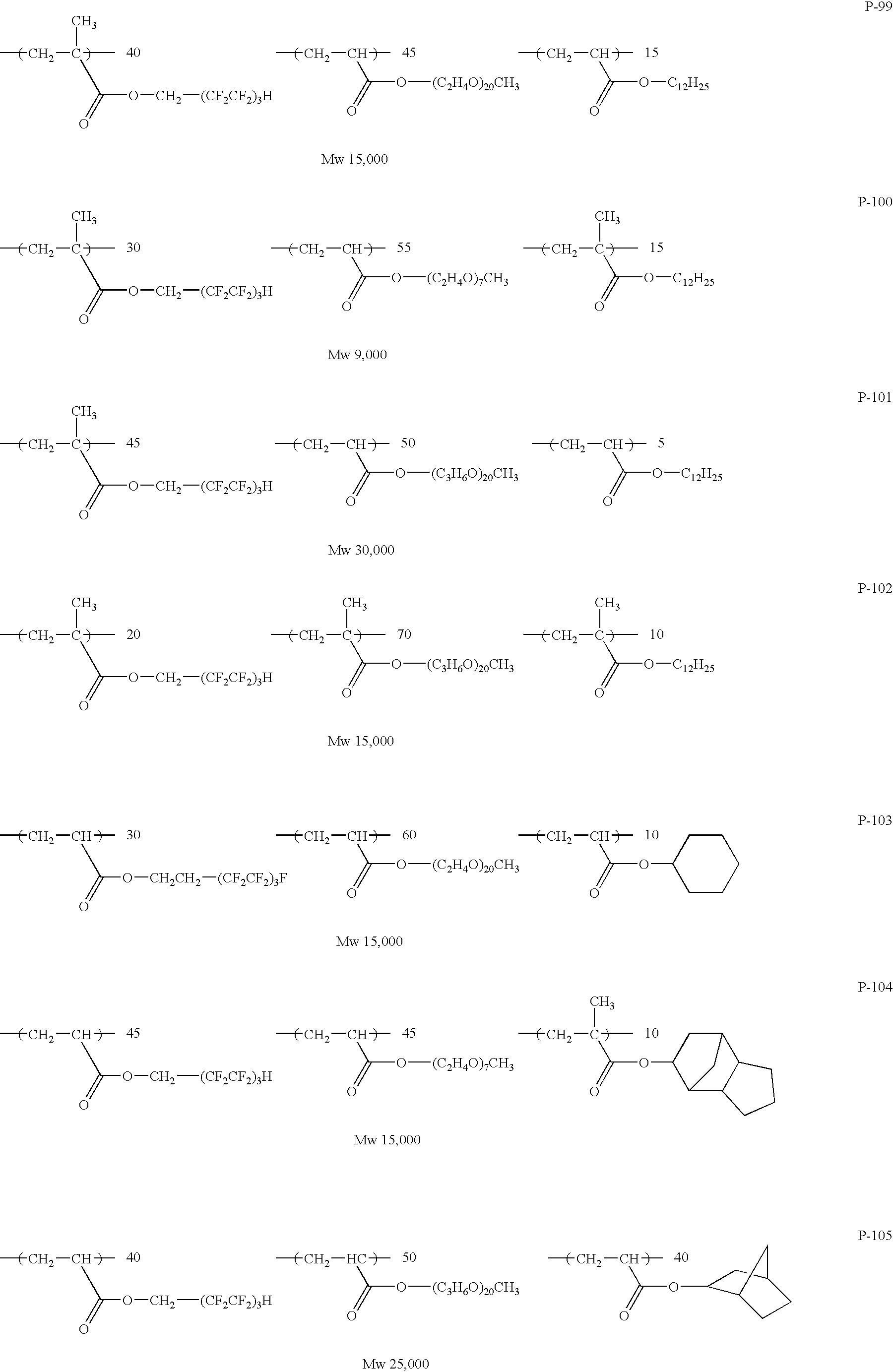

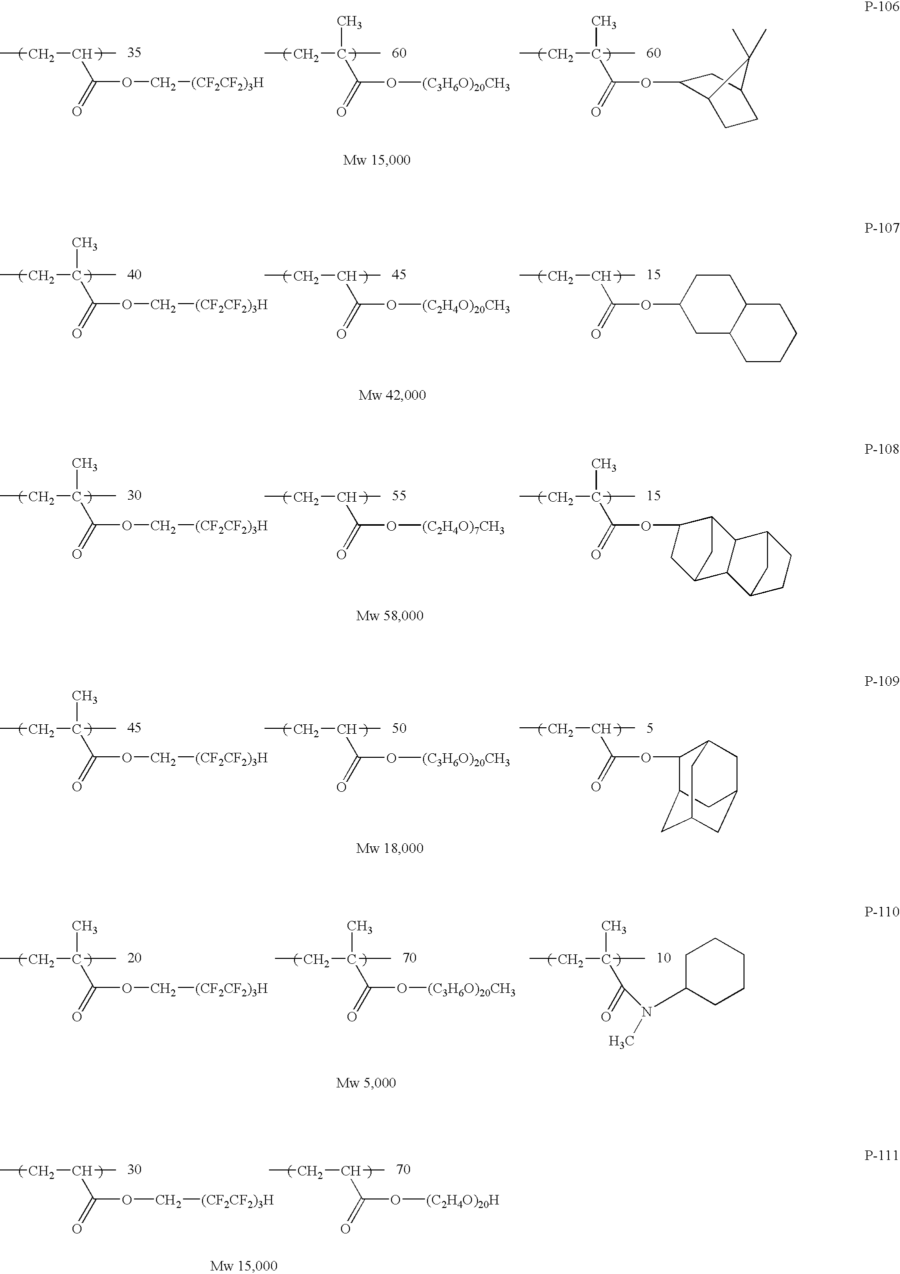

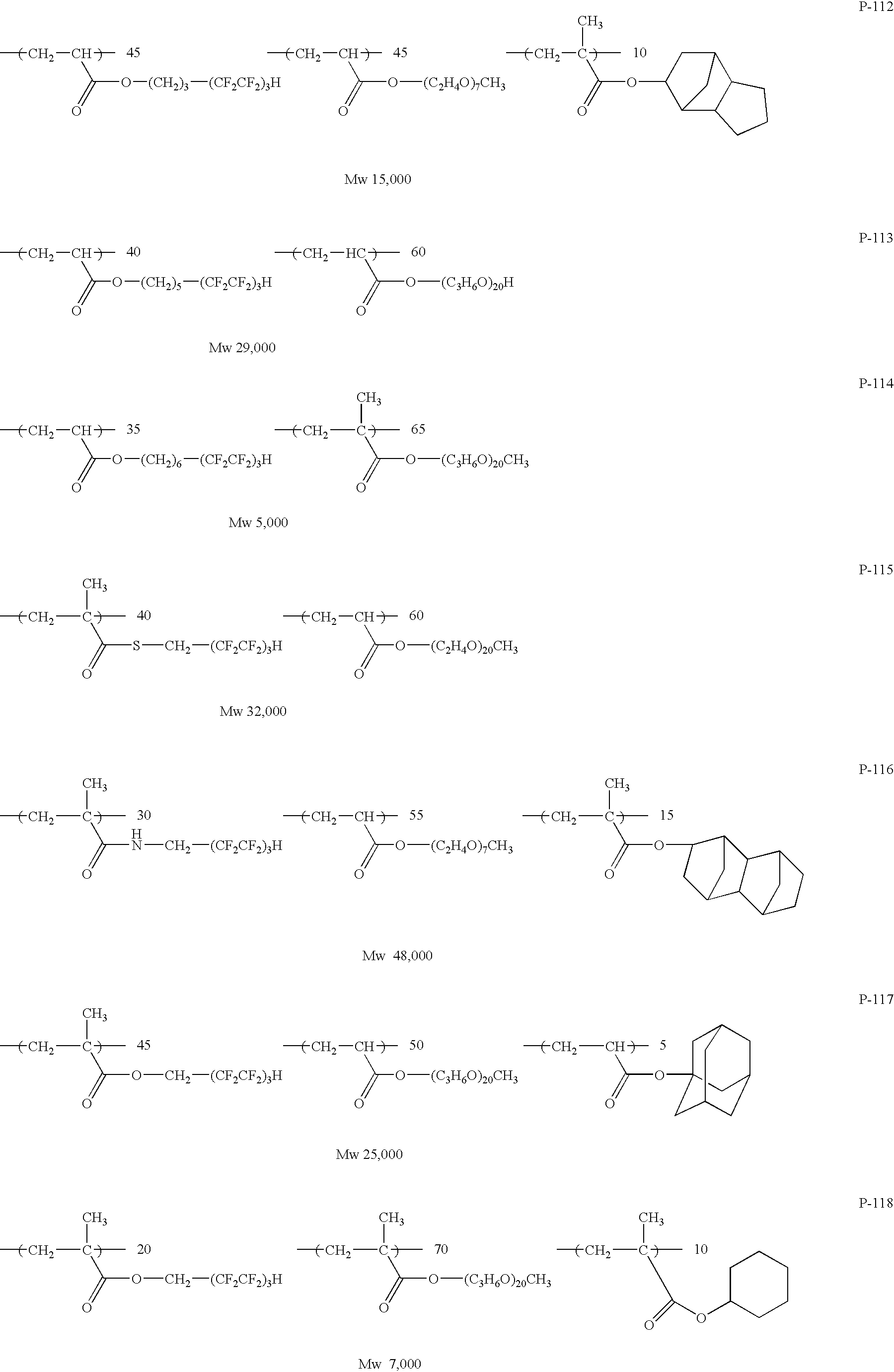

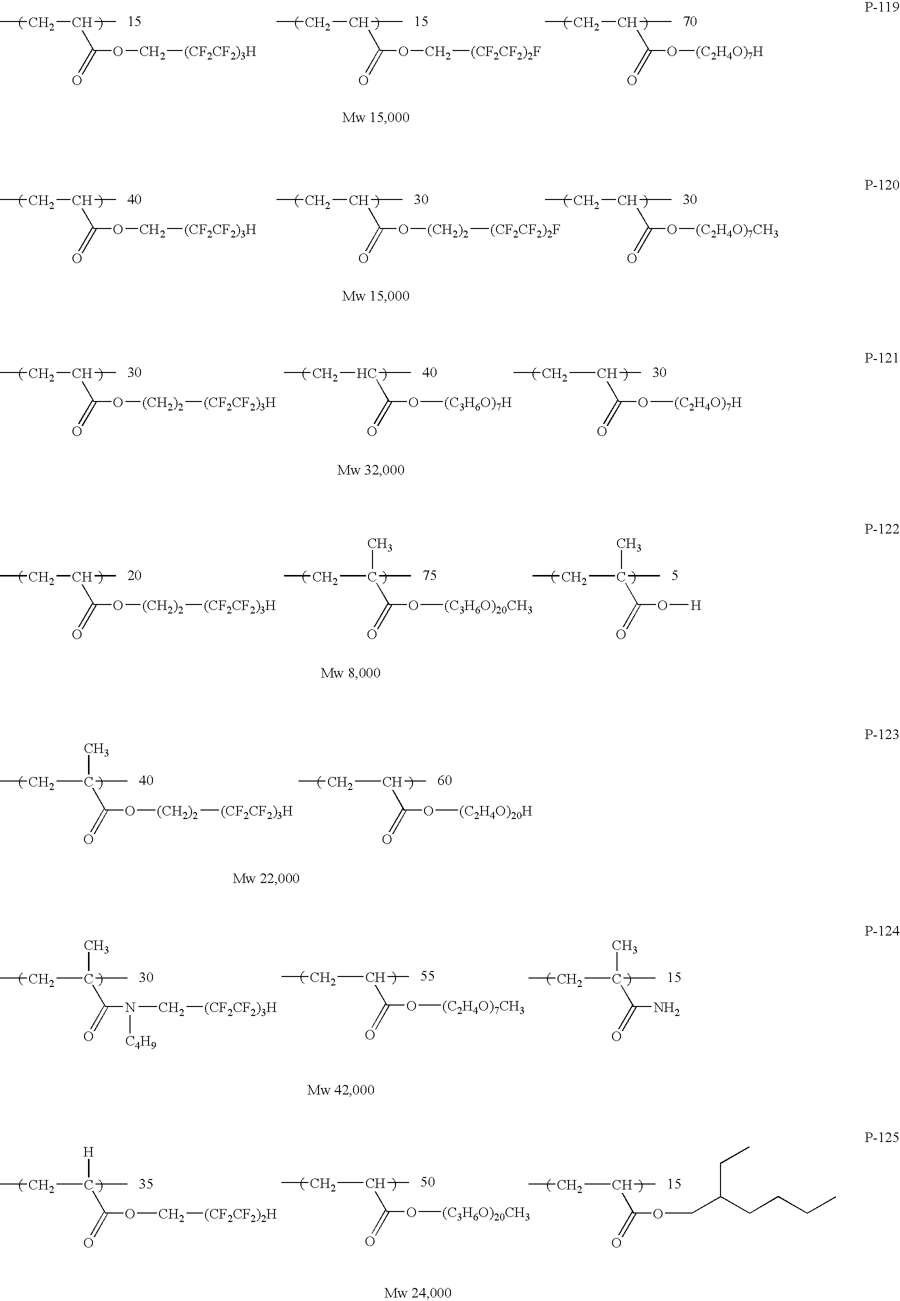

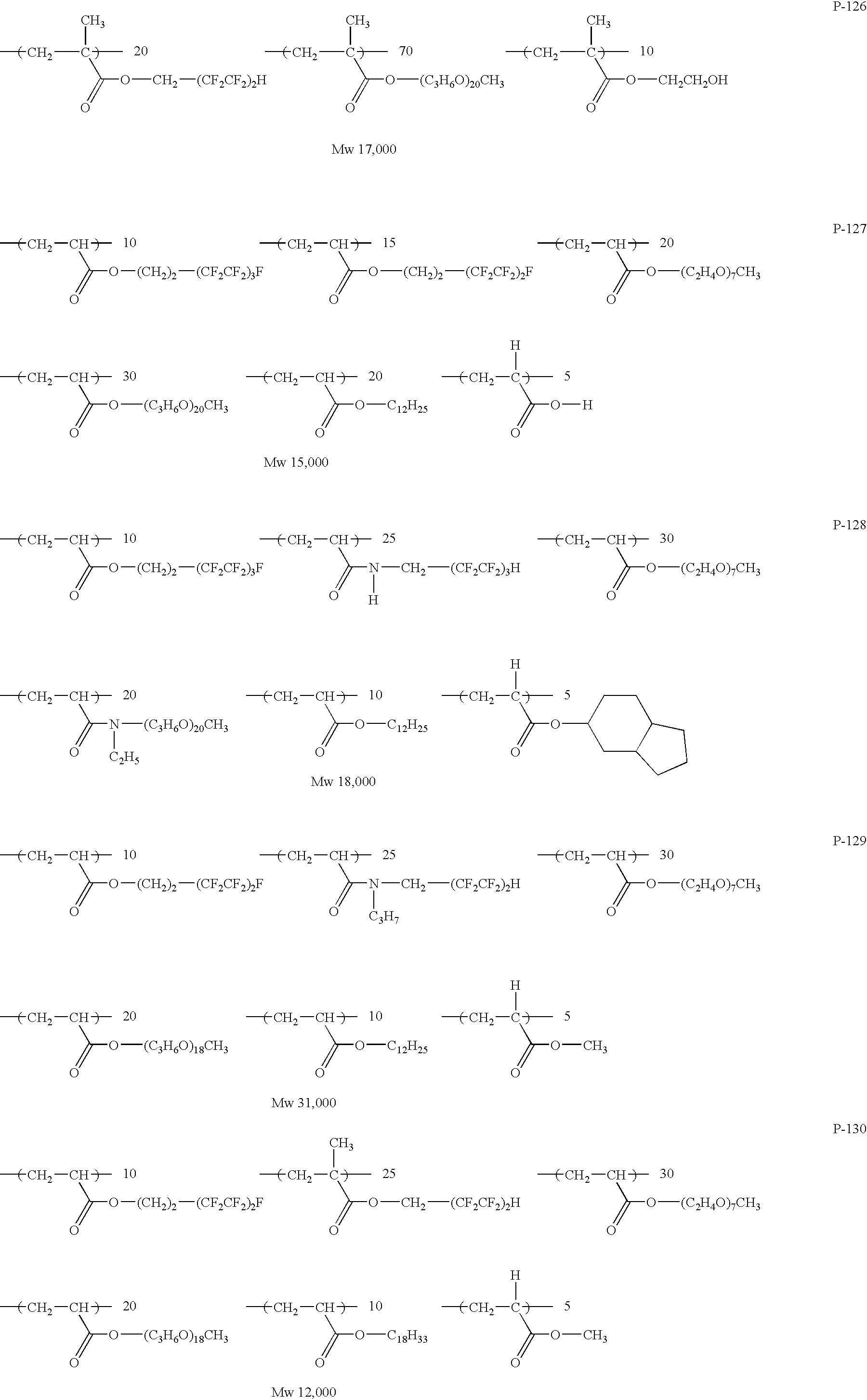

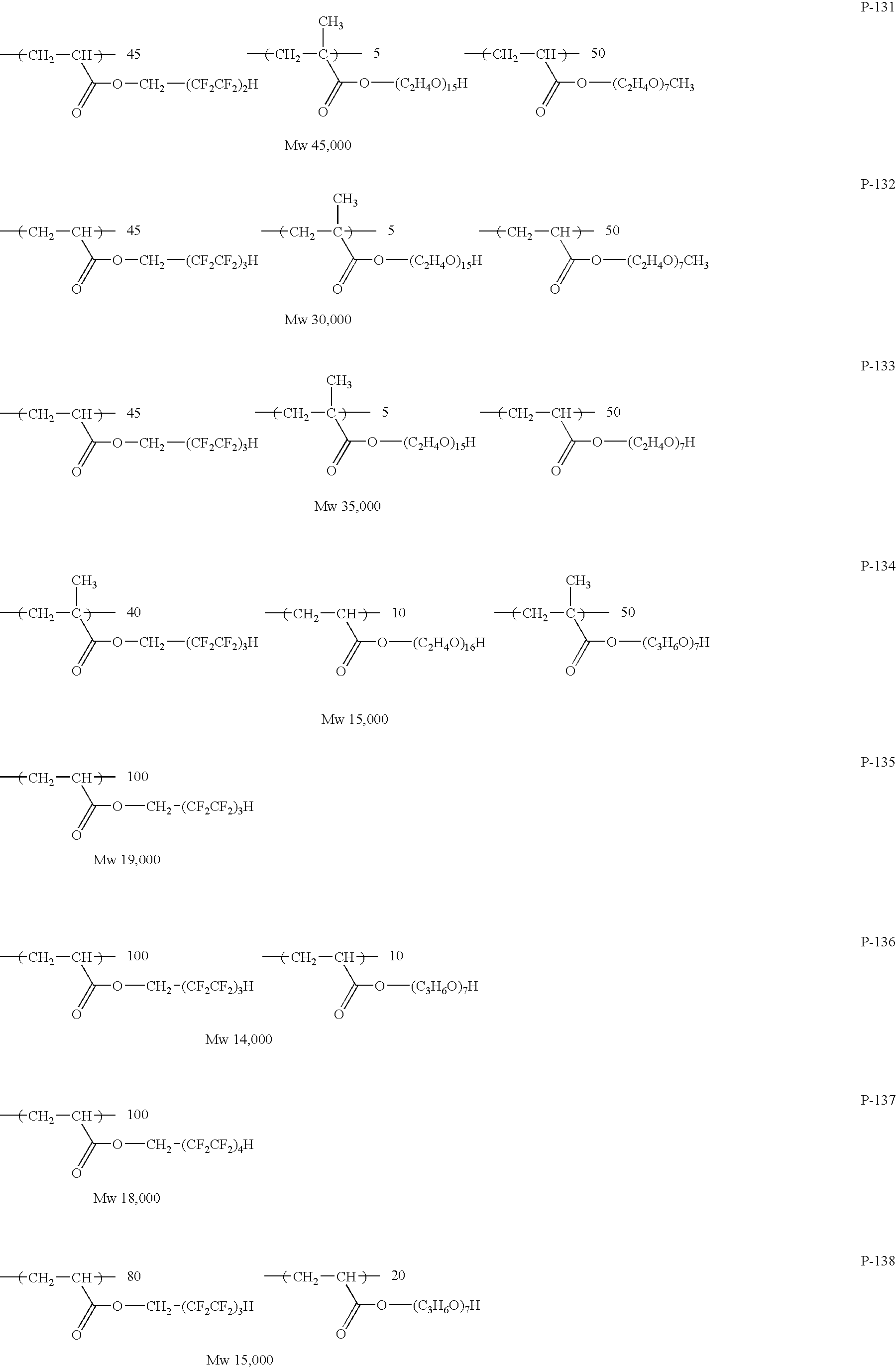

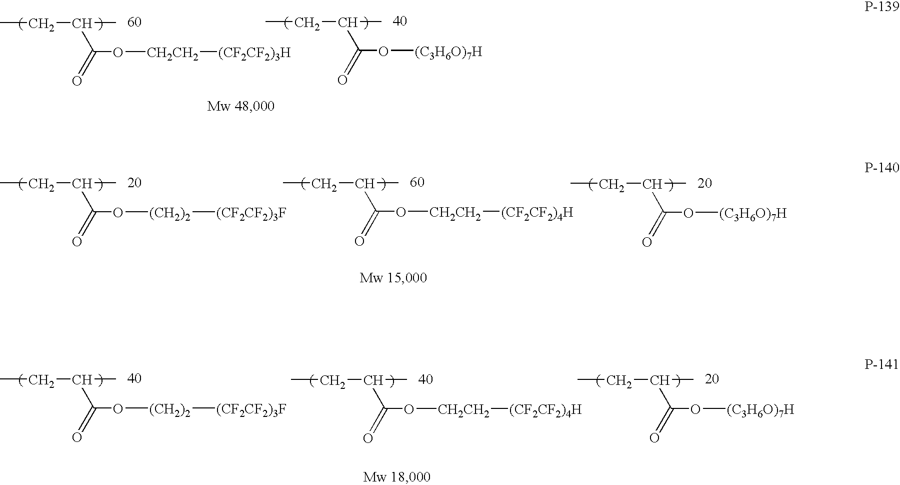

The fluoride-polymer which can be employed in the [symbol] invention may be produced according to any known process as described above. For example, the fluoride-polymer may be produced by carrying out polymerization of a monomer having a fluoro-aliphatic group and a monomer having a hydrophilic group in an organic solvent in the presence of a common radical polymerization initiator. Other addition-polymerizable compounds, if necessary, may be further added, and then, the polymerization may be carried out in the same manner. It is useful for obtaining a polymer having a uniform constitution to carry out polymerization while adding dropwise at least one monomer and at least one polymerization initiator from the view point of polymerization activity of each monomer.

The amount of the fluoride-polymer is desirably from 0.005 to 8 wt%, more desirably from 0.01 to 5 wt% and much more desirably from 0.05 to 2.5 wt% with respect to the total weight of the composition (when the composition is a solution, the solvent is excluded) for producing the optically anisotropic layer. When the amount of the fluoride-polymer falls within the above range, substantial effects may be obtained without lowering a drying property of the coating layer, and, thus, an optical film having uniform optical properties such as retardation.

The optically anisotropic layer can be formed by applying a coating fluid, containing at least one kind of the foregoing liquid crystalline compounds and if desired, additives such as a polymerization initiator and a fluoride-polymer, to a surface of an alignment layer, followed by drying. As a solvent which is used for preparing the coating fluid, an organic solvent is preferably used. Examples of the organic solvent include amides (for example, N,N-dimethylformamide) sulfoxides (for example, dimethyl sulfoxide), heterocyclic compounds (for example, pyridine), hydrocarbons (for example, benzene and hexane), alkyl halides (for example, chloroform, dichloromethane, and tetrachloroethane), esters (for example, methyl acetate and butyl acetate), ketones (for example, acetone and methyl ethyl ketone), and ethers (for example, tetrahydrofuran and 1,2-dimethoxyethane). Of these, alkyl halides and ketones are preferable. The organic solvent may be used in combination of two or more kinds thereof.

In the one case of preparing an optical compensation film with high uniformity, the foregoing coating fluid preferably has a surface tension of not more than 25 mN/m, and more preferably not more than 22 mN/m.

Applying the coating fluid to a surface can be carried out by a known method (for example, an extrusion coating method, a direct gravure coating method, a reverse gravure coating method, and a die coating method).

Next the substrate supporting the optically anisotropic layer has will be described in detail.

(Substrate)

The substrate, which is used for supporting the optically anisotropic layer in the optical compensation film of the invention, is preferably selected from glass plates or transparent polymer films. The substrate preferably has a light transmittance of 80% or more. Furthermore, the substrate preferably has an Rth retardation value, as measured by light having a wavelength of 550 nm, in the range of from 10 to 300 nm, and more preferably from 30 to 200nm. An Re retardation value is preferably from 1 nm to 100 nm, and more preferably from 5 nm to 60 nm.

Examples of the polymer which constitutes the polymer film include cellulose esters (for example, cellulose acetate and cellulose diacetate), norbomene based polymers, and polymethyl methacrylate. Commercially available polymers (in the case of norbomene based polymers, ARTON and ZEONEX (all of which are a trade name)) may also be used.

Above all, cellulose esters are preferable, and lower fatty acid esters of cellulose are more preferable. The term “lower fatty acid” means a fatty acid having not more than 6 carbon atoms. In particular, the carbon atom number is preferably 2 (cellulose acetate), 3 (cellulose propionate) or 4 (cellulose butyrate). Cellulose acetate is especially preferable. Mixed fatty acid esters such as cellulose acetate propionate and cellulose acetate butyrate may also be used.

In order to adjust the retardation of cellulose acetate so as to fall within the foregoing preferred range, a method for giving an external force such as stretching is general. A retardation increasing agent may also be used for the purpose of adjusting the optical anisotropy. The retardation increasing agent is preferably an aromatic compound having at least two aromatic rings. The aromatic compound is preferably used with an amount in the range of from 0.01 to 20 parts by weight based on 100 parts by weight of the polymer. Furthermore, the aromatic compound may be used in combination of two or more kinds thereof. The aromatic ring of the aromatic compound includes an aromatic heterocyclic ring in addition to an aromatic hydrocarbon ring

The retardation increasing agent is described in EP-A-0911656, and in Japanese Laid-Open Patent Publication “Tokkai” Nos. 2000-111914 and 2000-275434.

Incidentally, even conventionally known polymers which are liable to reveal birefringence, such as polycarbonate and polysulfone, can be used in the optical compensation sheet of the invention so far as the revelation of birefringence is controlled by modifying the molecule as described in WO 00/26705.

In the case where the optical compensation film of the invention is used for a polarizing plate protective film or a retardation film, it is preferred to use cellulose acetate having a degree of acetylation of from 55.0 to 62.5 % as the polymer film. The degree of acetylation is more preferably from 57.0 to 62.0%.

The term “degree of acetylation” as referred to herein means an amount of acetic acid as bound per unit weight of cellulose. The degree of acetylation is determined by the measurement and computation of an acetylation degree in ASTM: D817-91 (testing method for cellulose acetate and the like).

A viscosity average degree of polymerization (DP) of cellulose acetate is preferably 250 or more, and more preferably 290 or more. Furthermore, it is preferable that the cellulose acetate has a narrow molecular weight distribution of Mw/Mn (wherein Mw represents a weight average molecular weight, and Mn represents a number average molecular weight) by gel permeation chromatography. Concretely, the Mw/Mn value is preferably from 1.0 to 1.7, more preferably from 1.0 to 1.65, and most preferably from 1.0 to 1.6.

In the cellulose acetate, the hydroxyl groups at the 2-position, the 3-position and the 6-position of cellulose are not equally substituted, but the degree of substitution at the 6-position tends to become small. In the polymer film which is used in the invention, it is preferable that the degree of substitution at the 6-position of cellulose is approximately equal to or larger than that at the 2-position or 3-position.

A proportion of the degree of substitution at the 6-position to the total sum of the degree of substitution at the 2-position, the 3-position and the 6-position is preferably from 30 to 40%, more preferably from 31 to 40%, and most preferably from 32 to 40%. The degree of substitution at the 6-position is preferably 0.88 or more.

The degree of substitution at each of the positions can be measured by NMR.

The cellulose acetate having a high degree of substitution at the 6-position can be synthesized by referring to methods of Synthesis Example 1 as described in paragraphs [0043] to [0044], Synthesis Example 2 as described in paragraphs [0048] to [0049] and Synthesis Example 3 as described paragraphs [0051] to [0052] of Japanese Laid-Open Patent Publication “Tokkai” No. hei 11-5851.

[Polarizing Plate]

Next, a polarizing plate comprising the optical compensation film of the invention as a protective film will be described.

When the optical compensation film of the invention is stuck to a polarizing plate or used as a protective film for protecting a polarizing film of a polarizing plate, it can remarkably exhibit its functions.

(Polarizing Film)

As a polarizing film which can be used for the polarizing plate of the invention, a coating type polarizing film represented by products available from Optiva, Inc. and a polarizing film composed of a binder and iodine or a dichroic dye are preferable.

Iodine or a dichroic dye in a polarizing film is oriented in a binder, whereby an orientation performance is revealed. It is preferable that the iodine or dichroic dye is oriented along the binder molecule or the dichroic dye is oriented in one direction due to self-organization as in liquid crystals.

For example, a general-purpose polarizer can be prepared by immersing a stretched polymer in a solution of iodine or a dichroic dye in a bath tank and penetrating the iodine or dichroic dye into the binder.

In a general-purpose polarizing film, the iodine or dichroic dye is distributed in a depth of approximately 4 μm from the polymer surface (approximately 8 μm in total in the both sides), and in order to obtain sufficient polarization performance, a thickness of at least 10 μm is required. The degree of penetration can be controlled by the concentration of the solution of iodine or a dichroic dye, the temperature of the bath tank containing the same, and the immersion time of the same.

As described previously, a lower limit of the binder thickness is preferably 10 μm. One the other hand, an upper limit of the thickness is not particularly limited. From the viewpoint of a light leakage phenomenon which is caused when the polarizing plate is used in a liquid crystal display device, it is preferable that the thickness is thin as far as possible. The binder thickness is preferably not more than that of a currently general-purpose polarizing plate (about 30 μm), more preferably not more than 25 μm, and further preferably not more than 20 μm. When the binder thickness is not more than 20 μm, the light leakage phenomenon is not observed in a 17-inch liquid crystal display device.

The binder of the polarizing film may be crosslinked. As the crosslinked binder, a polymer which is crosslinkable by itself can be used. The polarizing film can be formed by subjecting a functional group-containing polymer or a binder as obtained by introducing a functional group into a polymer to reaction of the binders with each other by light, heat or a change in the pH.

Furthermore, a crosslinking structure may be introduced into a polymer by a crosslinking agent. The crosslinking structure can be formed by using a crosslinking agent which is a compound having high reaction activity and introducing a binding group derived from the crosslinking agent into the binders to crosslink the binders with each other.

In general, the crosslinking is carried out by coating a coating solution containing a polymer or a mixture of a polymer and a crosslinking agent on a transparent substrate, followed by heating. Since it is only required that the durability is ensured at the stage of a final product, the crosslinking treatment may be carried out at any stage until a final polarizing plate is obtained.

As the binder of the polarizing film, any polymer which is crosslinkable by itself or a polymer which is crosslinked by a crosslinking agent can be used. Examples of the polymer include polymethyl methacrylate, polyacrylic acid, polymethacrylic acid, polystyrene, gelatin, polyvinyl alcohol, modified polyvinyl alcohol, poly(N-methylolacrylamide), polyvinyltoluene, chlorosulfonated polyethylene, nitrocellulose, chlorinated polyolefins (for example, polyvinyl chloride), polyesters, polyimides, polyvinyl acetate, polyethylene, carboxymethyl cellulose, polypropylene, polycarbonate, and copolymers thereof (for example, acrylic acid/methacrylic acid polymers, styrene/maleinimide polymers, styrene/vinyltoluene polymers, vinyl acetate/vinyl chloride polymers, and ethylene/vinyl acetate polymers). Above all, water-soluble polymers (for example, poly(N-methylolacrylamide), carboxymethyl cellulose, gelatin, polyvinyl alcohol, and modified polyvinyl alcohol) are preferable; gelatin, polyvinyl alcohol, and modified polyvinyl alcohol are more preferable; and polyvinyl alcohol and modified polyvinyl alcohol are the most preferable.

The polyvinyl alcohol and the modified polyvinyl alcohol preferably have a degree of hydrolysis of from 70 to 100%, more preferably from 80 to 100%, and most preferably from 95 to 100%. The polyvinyl alcohol preferably has a degree of polymerization of from 100 to 5,000.

the modified polyvinyl alcohol is obtained by introducing a modified group into polyvinyl alcohol by co-polymerization modification, chain transfer modification or block polymerization modification. According to the co-polymerization modification, —COONa, —Si(OH)₃, N(CH₃)₃—Cl, C₉H₁₉COO—, —SO₃Na, and —C₁₂H₂₅ can be introduced as the modified group. According to the chain transfer modification, —COONa, —SH, and —SC₁₂h₂₅ can be introduced as the modified group. The modified polyvinyl alcohol preferably has a degree of polymerization of from 100 to 3,000. The modified polyvinyl alcohol is described in Japanese Laid-Open Patent Publication “Tokkai” Nos. hei 8-338913, hei 9-152509 and hei 9-316127.

Unmodified polyvinyl alcohol and alkylthio-modified polyvinyl alcohol each having a degree of hydrolysis of from 85 to 95% are especially preferable.

The polyvinyl alcohol or modified polyvinyl alcohol may be used in combination of two or more kinds thereof.

By adding a large amount of the crosslinking agent to the binder, resistance to most heat of the polarizing film can be improved. However, when the crosslinking agent is added in an amount of 50% by weight or more to the binder, the orientation properties of the iodine or dichroic dye are lowered. The amount of addition of the crosslinking agent is preferably from 0.1 to 20% by weight, and more preferably from 0.5 to 15% by weight based on the binder.

The binder contains the unreacted crosslinking agent to some extent even after completion of the crosslinking reaction. However, the amount of the residual crosslinking agent is preferably not more than 1.0% by weight, and more preferably not more than 0.5% by weight in the binder. When the crosslinking agent is contained in an amount of exceeding 10% by weight in the binder layer, there is some possibility that a problem is caused in the durability. That is, in the case where a polarizing film in which the amount of the residual crosslinking agent is high is incorporated into a liquid crystal display device and then used for a long period of time or allowed to stand under high-temperature and high-humidity atmospheres for a long period of time, a lowering in the degree of polarization may possibly be caused.

The crosslinking agent is described in U.S. Reissue Pat. No. 23,297. Boron compounds (for example, boric acid and borax) can also be used as the crosslinking agent.

Examples of the dichroic dye which can be used include azo based dyes, stilbene based dyes, pyrazolone based dyes, triphenylmethane based dyes, quinoline based dyes, oxazine based dyes, thiazine based dyes, and anthraquinone based dyes. It is preferable that the dichroic dye is water-soluble. It is preferable that the dichroic dye contains a hydrophilic substituent (for example, sulfo, amino, and hydroxl).

Examples of the dichroic dye include: C.I. Direct Yellow 12, C.I. Direct Orange 39, C.I. Direct Orange 72, C.I. Direct Red 39, C.I. Direct Red 79, C.I. Direct Red 81, C.I. Direct Red 83, C.I. Direct Red 89, C.I. Direct Violet 48, C.I. Direct Blue 67, C.I. Direct Blue 90, C.I. Direct Green 59, and C.I. Acid Red 37. The dichroic dye is described in Japanese Laid-Open Patent Publication “Tokkai” Nos. hei 1-161202, hei 1-172906hei 1-172907, hei 1-183602, hei 1-248105, hei 1-265205, and hei 7-261024. The dichroic dye is used in a free acid state or as an alkali metal salt, an ammonium salt or an amide salt. By blending two or more kinds of dichroic dyes, it is possible to produce a; polarizing film having various hues. A polarizing film using a compound (dye) which exhibits black when the polarizing axes are made orthogonal to each other, or a polarizing film or a polarizing plate in which various dichroic molecules are blended so as to exhibit black is preferable because of excellent single panel transmittance and degree of polarization.

In order to enhance the contrast ratio of the liquid crystal display device, it is preferable that the transmittance of the polarizing plate is high; and it is also preferable that the degree of polarization is high. The transmittance of the polarizing plate is preferably in the range of from 30 to 50%, more preferably in the range of from 35 to 50%, and most preferably in the range of from 40 to 50% (a maximum value of the single panel transmittance of the polarizing plate is 50%) in light having a wavelength of 550 nm. The degree of polarization is preferably in the range of from 90 to 100%, more preferably in the range of from 95 to 100%, and most preferably in the range of from 99 to 100% in light having a wavelength of 550 nm.

It is possible to dispose the polarizing film and the optically anisotropic layer, or the polarizing film and the alignment layer via an adhesive. As the adhesive, polyvinyl alcohol based resins (inclusive of polyvinyl alcohol modified with an acetoacetyl group, a sulfonic acid group, a carboxyl group, or an oxyalkylene group) or boron compound aqueous solutions can be used. Of these, polyvinyl alcohol based resins are preferable. The thickness of the adhesive layer after drying is preferably in the range of from 0.01 to 10 μm, and especially preferably in the range of from 0.05 to 5 μm.

(Production of Polarizing Plate)

From the viewpoint of yield, it is preferred that the polarizing film is dyed by iodine or a dichroic dye after stretching a binder while inclining at an angle of from 10 to 80 degrees against the longitudinal direction (MD direction) of the polarizing film (stretching method) or rubbing it (rubbing method). It is preferred to achieve stretching such that an angle of inclination is coincident with an angle formed by a transmission axis of two polarizing plates stuck on the both sides of a liquid crystal cell which constitutes LCD and the machine or transverse direction of the liquid crystal cell.

The inclination angle is usually 45 degrees. However, recently, in transmission type, reflection type and semi-transmission type LCDs, there have been developed devices in which the inclination angle is not always 45 degrees. Thus, it is preferable that the stretching direction can be arbitrarily adjusted in conformity with the design of LCD.

In the case of a stretching method, the stretch ratio is preferably 2.5 to 30.0 times, and more preferably from 3.0 to 10.0 times. The stretching can be carried out by dry stretching in air. Also, the stretching may be carried out by wet stretching in an immersed state in water. In the case of dry stretching, the stretch ratio is preferably from 2.5 to 5.0 times, whereas in the case of wet stretching, the stretch ratio is preferably 3.0 to 10.0 times. The stretching process may be carried out by dividing stretching inclusive of oblique stretching several times. By dividing the stretching several times, more uniform stretching can be carried out even in stretching in a high stretch ratio. Prior to the oblique stretching, stretching in the transverse or machine direction may be carried out to slight extent (a degree such that shrinkage in the width direction can be prevented).

The stretching can be carried out by performing tenter stretching in biaxial stretching in a process different from each other right and left. This biaxial stretching is the same as a stretching method which is usually employed in the film formation. According to the biaxial stretching, stretching is carried out at a rate different from each other right and left. Thus, it is required that the thickness of the binder film prior to stretching differs from each other right and left. According to cast film formation, by providing a die with a taper, it is possible to give a difference right and left to a flow rate of the binder solution.

In this way, a binder film as obliquely stretched at an angle of from 10 to 80 degrees against the MD direction of the polarizing film is produced.

In the rubbing method, a rubbing treatment method which is widely employed as the liquid crystal orientation treatment process of LCD can be applied. That is, the orientation is obtained by rubbing the surface of a film using paper, gauze, felt, rubber or nylon or polyester fibers in a fixed direction. In general the rubbing is carried out by rubbing the surface of a film approximately several times using a cloth in which fibers having uniform length and thickness are uniformly flocked. It is preferred to perform rubbing using a rubbing roll having a roundness, a cylindricity and a deflection (eccentricity) of not more than 30 μm, respectively. A lap angle of the film against the rubbing roll is preferably from 0.1 to 90 degrees. However, a stable rubbing treatment can be obtained by winding at 360 degrees or more as described in Japanese Laid-Open Patent Publication “Tokkai” No. hei 8-160430.

In the case of rubbing a longitudinal film, it is preferred to deliver the film at a rate of from 1 to 100 m/min in a fixed tension state by a delivery device. It is preferable that the rubbing roll is aligned rotatably in the horizontal direction against the advancing direction of the film for the purpose of setting up an arbitrary rubbing angle. It is preferred to select an appropriate rubbing angle within the range of from 0 to 60 degrees. In the case of using the film in a liquid crystal display device, the rubbing angle is preferably from 40 to 50 degrees, and especially preferably 45 degrees.

It is preferable that a polymer film is disposed on the surface in the side opposite to the optically anisotropic layer of the polarizing film (alignment of optically anisotropic layer/polarizing film/polymer film).

In the specification, Re(λ) and Rth(λ) respectively mean an in-plane retardation and a retardation in a thickness-direction at wavelength λ. The Re(λ) is measured by using KOBRA-21ADH (manufactured by Oji Scientific Instruments) for an incoming light of a wavelength λ nm in a direction normal to a film-surface. The Rth(λ) is calculated by using KOBRA-21ADH based on three retardation values; first one of which is the Re(λ) obtained above, second one of which is a retardation which is measured for an incoming light of a wavelength λ mm in a direction rotated by +40° with respect to the normal direction of the film around an in-plane slow axis, which is decided by KOBRA21ADH, as an a tilt axis (rotation axis), and third one of which is a retardation which is measured for an incoming light of a wavelength λ nm in a direction rotated by −40° with respect to the normal direction of the film around an in-plane slow axis as an a inclining axis (a rotation axis); a hypothetical mean refractive index and an entered thickness value of the film. The wavelength λ generally falls within the range from 450 to 750 nm. According to the present invention, the wavelength λ is 589 nm. The mean refractive indexes of various materials are described in published documents such as “POLYMER HANDBOOK” (JOHN WILEY & SONS, INC) and catalogs. If the values are unknown, the values may be measured with an abbe refractometer or the like. The mean refractive indexes of major optical films are exemplified below:

cellulose acylate (1.48), cyclo-olefin polymer (1.52), polycarbonate (1.59), polymethyl methacrylate (1.49), polystyrene (1.59).

When the hypothetical mean refractive index and a thickness value are put into KOBRA21ADH, nx, ny and nz are calculated. And Nz, which is equal to (nx-nz)(nx-ny), is calculated based on the calculated nx, ny and nz.

Incidentally, polymer films having a positive value of Rth and exhibiting negative birefringence properties are preferably used as a substrate in the present invention.

[Liquid Crystal Display Device]

The optical compensation film and the polarizing plate according to the invention can be used in liquid crystal display devices employing various modes. Preferred embodiments of the optical anisotropic layer in each of the liquid crystal modes will be hereunder described.

(Liquid Crystal Display Device Employing a TN Mode)

A liquid crystal cell employing a TN mode has been most frequently utilized as a color TFT liquid crystal display device and is described in a number of documents.

In a liquid crystal cell employing a TN mode, in a black state, rod-like liquid crystalline molecules are oriented perpendicularly in the central portion of the thickness direction and are oriented horizontally in the portion near to the substrate.

The retardation generated by the orientation of rod-like liquid crystalline molecules in the central portion can be compensated by the retardation generated by the homeotropic alignment, in which discotic molecules are aligned with being their disk faces parallel to a layer plane, or the retardation of a (transparent) substrate; whereas the retardation generated by the orientation of rod-like liquid crystalline molecules in the portion near to the substrate can be compensated by the retardation generated by the hybrid alignment, in which discotic liquid crystalline molecules are aligned with a tilt angle changing along with a thickness direction of the cell.

The retardation generated by the orientation of rod-like liquid crystalline molecules in the central portion can also be compensated by the retardation generated by the homogeneous alignment, in which rod-like crystalline molecules are aligned with being their long axes parallel to the layer plane, or the retardation of a (transparent) substrate, whereas the retardation generated by the orientation of rod-like liquid crystalline molecules in the portion near to the substrate can also be compensated by the retardation generated by the hybrid alignment, in which discotic liquid crystalline molecules are aligned with a tilt angle changing along with a thickness direction of the cell.

In the homeotropic alignment, liquid crystalline molecules may be aligned with an angle, formed between a mean direction of the long axes of the molecules and the layer plane, from 85 to 95 degrees.

In the homogeneous alignment, liquid crystalline molecules may be aligned with an angle, formed between a mean direction of the long axes of the molecules and the layer plane, of 15 degrees or more, and preferably from 15 degrees to 85 degrees.

The retardation of the (transparent) substrate, the optically anisotropic layer in which discotic liquid crystalline molecules are fixed in a homeotropic alignment state, the optically anisotropic layer in which rod-like liquid crystalline molecules are fixed in a homogenous alignment state, or the optically anisotropic layer in which discotic liquid crystalline molecules are fixed in a homeotropic alignment state and rod-like liquid crystalline molecules are fixed in a homogenous alignment state, preferably exhibits the Rth retardation value from 40 nm to 200 nm and the Re retardation value from 0 to 70 nm.

The layer in which discotic liquid crystalline molecules are fixed in a homeotropic alignment state, or, in other words, fixed in horizontally aligned state, and the layer in which rod-like liquid crystalline molecules are fixed in a homogenous alignment state, or, in other words, fixed in horizontally aligned state, are described in Japanese Laid-Open Patent Publication ¢Tokkai” Nos. hei 12-304931 and hei 12-304932. The layer in which discotic liquid crystalline molecules are fixed in a hybrid alignment state is described in Japanese Laid-Open Patent Publication “Tokkai” No. hei 8-50206.

(Liquid Crystal Display Device Employing an OCB Mode)

A liquid crystal cell employing an OCB mode is a bend-orientation mode liquid crystal cell in which rod-like liquid crystalline molecules are oriented substantially in the opposite direction to each other (symmetrically) in an upper portion and a lower portion. A liquid crystal display device employing a bend-orientation mode liquid crystal cell is disclosed in U.S. Pat. Nos. 4,583,825 and 5,410,422. Since the rod-like liquid crystalline molecules are symmetrically oriented in an upper portion and a lower portion, a bend-orientation mode liquid crystal cell has a self-optically compensatory function. For that reason, this liquid crystal mode is called OCB (optically compensatory bend) liquid crystal mode.

Likewise in the liquid crystal cell employing a TN mode, in the liquid crystal cell employing an OCB mode, in a black state, rod-like liquid crystalline molecules are oriented perpendicularly in the central portion of the thickness direction and are oriented horizontally in the portion near to the substrate.

In a black state, since the orientation of the liquid crystal in an OCB mode cell is the same as that of the liquid crystal in a TN mode, its preferred embodiment is also the same as in that of the liquid crystal of a TN mode. However, in an OCB mode, the central portion in which liquid crystalline molecules are oriented perpendicularly is larger than that in a TN mode, and, therefore, the retardation of the optically anisotropic layer in which discotic liquid crystalline molecules are homeotropically oriented or the retardation of the optically anisotropic layer in which rod-like liquid crystalline molecules are homogeneously oriented, may be adjusted so as to fall within a preferred range for an OCB-mode liquid crystal call. Concretely, the optically anisotropic layer in which discotic liquid crystalline molecules are homeotropically oriented or the optically anisotropic layer in which rod-like liquid crystalline molecules are homogeneously oriented, exhibits the Rth retardation value from 150 nm to 500 nm and the Re retardation value from 20 to 79 nm.

(Liquid Crystal Display Device Employing a VA Mode)

In a liquid crystal cell of a VA mode, rod-like liquid crystalline molecules are substantially vertically oriented when being applied with no voltage.

In addition to )1) a liquid crystal cell of a VA mode in a narrow sense in which rod-like liquid crystalline molecules are substantially vertically oriented when being applied with no voltage and substantially horizontally oriented when being applied with a voltage (as described in Japanese Laid-Open Patent Publication “Tokkai” No. hei 2-176625), the liquid crystal cell of a VA mode includes (2) a liquid crystal cell with multi domains (MVA mode) showing a widened viewing angle property (as described in SID 97, Digest of Tech Papers (preprints), 28 (1997), page 845), (3) a liquid crystal cell employing an n-ASM mode in which rod-like liquid crystalline molecules are substantially vertically oriented when being applied with no voltage and are oriented in a twisted multi domain manner when being applied with a voltage (as described in Preprint of Japan Liquid Crystal Forum, pp. 58-59 (1998)), and (4) a liquid crystal cell of an SURVAIVAL mode (as announced in LCD international 98).

According to a VA mode, since almost all of rod-like liquid crystalline molecules in the cell are aligned perpendicularly in a black state, it is preferable that the retardation generated by the orientation of liquid crystalline molecules in a black state are compensated by the retardation of an optically anisotropic layer in which rod-like liquid crystalline molecules are homogeneously oriented; and, additionally, that the viewing-angle depending property of a polarizing plate is compensated with an optically anisotropic layer in which rod-like liquid crystalline molecules are homogeneously oriented with an angle, formed between the mean orientation direction of the long axes of rod-like liquid crystalline molecules and the transmission axis direction of the polarizing plate, of less than 5 degrees.

The (transparent) substrate, the optically anisotropic layer in which discotic liquid crystalline molecules are homeotropically oriented, or the optically anisotropic layer in which rod-like liquid crystal molecules are homogeneously oriented, preferably exhibits the Rth retardation value from 150 nm to 500 nm and the Re retardation value from 20 to 70 nm.

(Other Liquid Crystal Display Devices)

For a liquid display device employing an ECB mode and a liquid crystal display device employing an STN mode, it is also possible to achieve optical compensation according to the same strategy as that described previously.

### EXAMPLES

### Example 1

(Preparation of Polymer Substrate)

the following composition was charged in a mixing tank and stirred while heating at 30° C., thereby dissolving the respective components. There was thus prepared a cellulose acetate solution.

| Composition of cellulose acetate solution | Internal | External |
|---|---|---|
| (parts by weight) | layer | layer |
| Cellulose acetate having a degree of acetylation | 100 | 100 |
| of 60.9%: | | |
| Triphenyl phosphate (plasticizer): | 7.8 | 7.8 |
| Biphenyl diphenyl phosphate (plasticizer): | 3.9 | 3.9 |
| Methylene chloride (first solvent): | 293 | 314 |
| Methanol (second solvent): | 71 | 76 |
| 1-Butanol (third solvent): | 15 | 1.6 |
| Silica fine particle (AEROSIL R972, manufactured by | 0 | 0.8 |
| Nippon Aerosil Co., Ltd): | | |
| Retardation increasing agent as described below: | 1.7 | 0 |

Retardation increasing agent

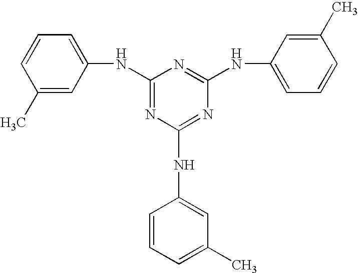

The resulting dope for internal layer and dope for external layer were cast on a drum as cooled at 0° C. using a three-layer co-casting die. A film having an amount of the residual solvent of 70% by weight was stripped off from the drum and dried at 80° C. while fixing the both ends thereof by a pin tenter and delivering in a drawing ratio in the delivery direction of 110%. When the amount of the residual solvent reached 10%, the film was dried at 110° C. Thereafter, the resulting film was dried at a temperature of 140° C. for 30 minutes to produce a cellulose acetate film having an amount of the residual solvent of 0.3% by weight (external layer: 3μm, internal layer: 74 μm, external layer: 3 μm). With respect to the prepared cellulose acetate film, optical characteristics were measured.

The resulting cellulose acetate film had a width of 1,340 mm and a thickness of 80 μm. A retardation value (Re) in light having a wavelength of 500 nm was measured according to the foregoing method. As a result, it was found to be 6 nm. Also, a retardation value (Rth) in light having a wavelength of 500 nm was measured. As a result, it was found to be 90 nm.

Furthermore, a haze of the prepared cellulose acetate film was measured. As a result, it was found to be 0.3%.

The prepared cellulose acetate film was immersed in a 2.0 N potassium hydroxide solution (at 25° C.) for 2 minutes, neutralized with sulfuric acid and washed with pure water, followed by drying. Surface energy of this film was determined by a contact angle method. As a result, it was found to be 63 mN/m.

<Preparation of Alignment Layer for Optically Anisotropic Layer>

A coating solution having the following composition was applied in an amount of 28 mL/m² to a surface of this cellulose acetate film using a #16 wire bar coater. The coated cellulose acetate film was dried by warm air at 60° C. for 60 seconds and further by warm air at 90° C. for 150 seconds, to form an alignment layer. The surface of the alignment layer was subjected to rubbing treatment in a direction parallel to the flow-casting direction of the cellulose acetate film.

(Composition of coating solution for alignment
layer)

| | | |
|---|---|---|
| Modified polyvinyl alcohol as described below: | 20 | parts by weight |
| Water: | 360 | parts by weight |
| Methanol: | 120 | parts by weight |
| Glutaldehyde (crosslinking agent): | 1.0 | part by weight |

Modified polyvinyl alcohol

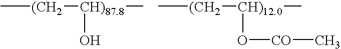

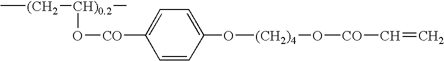

<Preparation of Optically Anisotropic Layer>

A coating solution having the following composition was continuously applied to a surface of the alignment layer formed on the foregoing rolled film as delivered at 30 m/min with a #3.2 wire bar rotating at 1,171 rpm in the same delivery direction as that of the film. The solvent was dried in a process for continuously raising the temperature from room temperature to 100° C., and thereafter, the coated film, or, in other words, the discotic liquid crystal layer, was heated in a drying zone at 135° C. for about 90 seconds with airflow in the manner that the velocity of airflow blowing in a direction parallel to the delivery direction of the film at a surface of the layer is 1.5 m/sec, thereby orienting the discotic liquid crystal molecules. Next, the resulting film was delivered into a drying zone at 80° C. and irradiated with ultraviolet light having an illuminance of 600 mW for 4 seconds by an ultraviolet light irradiation unit (ultraviolet lamp; output: 160 W/cm, light emitting length: 1.6 m) in a state that the surface temperature of the film was about 100° C., thereby carrying out a crosslinking reaction and fixing the discotic liquid crystal molecules in the orientation state. Thereafter, the film was cooled to room temperature and cylindrically rolled up, thereby forming it in a rolled state.

(Composition of Coating Solution for Optically Anisotropic Layer)

The following composition was dissolved in 107 parts by weight of methyl ethyl ketone to prepare a coating solution.

| | | |
|---|---|---|
| Discotic liquid crystalline compound (1) as | 41.01 | parts by weight |
| described blow: | | |
| Ethylene oxide-modified trimethylolpropane | 4.06 | parts by weight |
| triacrylate (V#360, manufactured by Osaka | | |
| Organic Chemical Industry Ltd.): | | |
| Cellulose acetate butyrate (CAB551-0.2, | 0.27 | parts by weight |
| manufactured by Eastman Chemical Company): | | |
| Cellulose acetate butyrate (CAB531-1, | 0.09 | parts by weight |
| manufactured by Eastman Chemical Company): | | |
| Fluoro aliphatic group-containing polymer 1 | 0.03 | parts by weight |
| as described below: | | |
| Fluoro aliphatic group-containing polymer 2 | 0.23 | parts by weight |
| as described below: | | |
| Photopolymerization initiator (IRGACURE 907, | 1.35 | parts by weight |
| manufactured by Ciba-Geigy AG): | | |
| Sensitizer (KAYACURE DETX, manufactured by | 0.45 | parts by weight |
| Nippon Kayaku Co., Ltd: | | |

Discotic liquid cystalline compound (1)

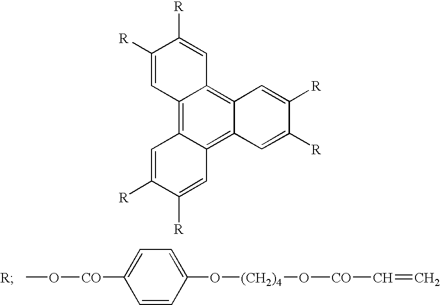

Fluoro aliphatic group-containing polymer 1 (a/b = 90/10 wt %)

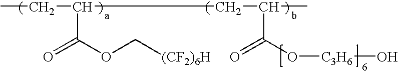

Fluoro aliphatic group-containing polymer 2 (a/b = 98/2 wt %)

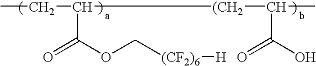

The polarizing plate was subjected to cross-Nicol configuration, and the resulting optical compensation sheet was observed with respect to the presence of unevenness. As a result, even by being viewed in the normal direction and in the oblique direction rotated by 60 degrees from the normal direction, unevenness was not detected. A haze of the resulting optical compensation sheet was measured. The results are shown in Table 1.

(Preparation of Polarizing Plate)

A polyvinyl alcohol (PVA) film having a thickness of 80 μm was dyed by immersing in an iodine aqueous solution having an iodine concentration of 0.05% by weight at 30° C. for 60 seconds. Subsequently, the dyed film was longitudinally stretched 5 times the original length during immersion in a boric acid aqueous solution having a boric acid concentration of 4% by weight for 60 seconds and then dried at 50° C. for 4 minutes to obtain a polarizing film having a thickness of 20 μm.

The optical compensation sheet was immersed in 1.5 moles/L of a sodium hydroxide aqueous solution at 55° C., and the sodium hydroxide was then thoroughly washed away with water. Thereafter, the optical compensation sheet was immersed in 0.005 moles/L of a dilute sulfuric acid aqueous solution at 35° C. for one minute and then immersed in water, thereby thoroughly washing away the dilute sulfuric acid aqueous solution. Finally, the sample was thoroughly dried at 120° C.

The foregoing optical compensation sheet which had been subjected to a saponification treatment was combined with a commercially available cellulose acylate film which had been subjected to a saponification treatment in the same manner and stuck so as to interpose the foregoing polarizing film therebetween using a polyvinyl alcohol based adhesive, thereby obtaining a polarizing plate. Here, FUJITAC TF80UL (manufactured by Fuji Photo Film Co., Ltd.) was used as the commercially available cellulose acylate film. At that time, since the polarizing film and the protective films on both sides of the polarizing film are prepared in a rolled state, the longitudinal directions of the respective rolled films are disposed parallel to each other and continuously stuck. Accordingly, the longitudinal direction of the optical compensation sheet roll (casting direction of the cellulose acylate film) and the absorption axis of the polarizer were parallel to each other.

(Evaluation in TN Liquid Crystal Cell)

One pair of polarizing plates as provided in a liquid crystal display device employing a TN mode liquid crystal cell (SYNCMASTER 172X, manufactured by Samsung) were striped off. Instead, the above prepared polarizing plate was stuck to each of the observer side and the backlight side via an adhesive such that the optical compensation sheet was positioned in the liquid crystal cell side. The transmission axis of the polarizing plate in the observer side and the transmission axis of the polarizing plate in the backlight side were disposed so as to take an O mode.

With respect to the thus prepared liquid crystal display device, transmittances in a black state (L0) and white state (L7) were measured using an analyzer (EZ-Contrast 160D, manufactured by ELDIM), from which was then determined a contrast ratio (white transmittance/black transmittance). The results of the measurement of contrast and the relation with measured values of haze are shown in Table 1.

(Unevenness Evaluation on Liquid Crystal Display Device Panel)

The entire surface of the display panel of the prepared liquid crystal display device was adjusted so as to have an intermediate tone and evaluated with respect to the presence of unevenness. As a result, unevenness was not detected with the panel.

### Example 2

An optical compensation sheet was prepared in the same manner as in Example 1, except that the amount of addition of the cellulose acetate butyrate (CAB551-0.2, manufactured by Eastman Chemical Company) in the coating solution for forming an optically anisotropic layer was changed to 0.10 parts by weight and that the cellulose acetate butyrate (CAB531-1), manufactured by Eastman Chemical Company) was not added.

### Example 3

An optical compensation sheet was prepared in the same manner as in Example 1, except that both the cellulose acetate butyrate (CAB551-0.2, manufactured by Eastman Chemical Company) and the cellulose acetate butyrate (CAB531-1, manufactured by Eastman Chemical Company) were not added in the coating solution for forming an optically anisotropic layer.

### Example 4

An optical compensation sheet was prepared in the same manner as in Example 1, except that the wire bar to be used in coating the coating solution for forming an optically anisotropic layer was changed to a #2.2 wire bar coater. The thickness of the prepared optically anisotropic layer was 0.7 times the thickness of the optically anisotropic layer as prepared in Example 1.

### Comparative Example 1

An optical compensation sheet was prepared in the same manner as in Example 1, except that the amount of addition of the cellulose acetate butyrate (CAB551-02, manufactured by Eastman Chemical Company) in the coating solution for forming an optically anisotropic layer was changed to 0.91 parts by weight and that the amount of addition of the cellulose acetate butyrate (CAB531-1, manufactured by Eastman Chemical Company) was changed to 0.23 parts by weight.

TABLE 1

| | | Haze of optical | Rate of increase of | |
|---|---|---|---|---|
| Optical | Haze of substrate | compensation sheet | haze | |
| compensation sheet | (H₁) | (H₂) | (H₂ − H₁) | Contrast ratio |
| Example 1 | 0.3 | 0.38 | 0.08 | 740 |
| Example 2 | 0.3 | 0.34 | 0.04 | 750 |
| Example 3 | 0.3 | 0.31 | 0.01 | 760 |
| Example 4 | 0.3 | 0.34 | 0.04 | 750 |
| Comparative | 0.3 | 1.0 | 0.7 | 680 |
| Example 1 | | | | |

As is clear from the results as shown in the Table 1, the optical compensation sheets of Examples 1 to 4 of the invention are small with respect to the rate of increase of haze before and after the formation of an optically anisotropic layer. As a result, as compared with the case of using the optical compensation sheet of Comparative Example 1 in which the rate of increase of haze is large, the optical compensation sheets of Examples 1 to 4 of the invention can improve the contrast ratio of a liquid crystal display device.

### Example 5

Optical compensation sheets and optical compensation sheet-provided polarizing plates were prepared in the same manner as in Example 1, except that the amount of addition of the retardation increasing agent as used in Example 1 was changed to prepare cellulose acetate films having an Rth retardation value of 76 nm, 85 nm, 100 nm and 110 mn, respectively. Even by changing the Rth retardation value of the polymer substrate to 76 nm, 85 nm, 100 nm and 110 nm, respectively, the unevenness-free surface properties were confirmed. With respect to these polarizing plates, a difference in haze before and after the formation of an optically anisotropic layer was determined in the same manner as described above. Also, a contrast ratio was confirmed by applying in the same liquid crystal display device as that described previously. In all of the optical compensation sheets, a change in the haze before and after the formation of an optically anisotropic layer was approximately from 0.05 to 0.10%, and the contrast ratio was high as seen in the foregoing Examples 1 to 4.

### Example 6

Optical compensation sheets and optical compensation sheet-provided polarizing plates were prepared in the same manner as in Example 1, except that a polymer substrate having an Rth retardation value of 90 nm was prepared by using the following retardation increasing agent in place of the retardation increasing agent as used in Example 1 and changing the addition amount of the internal layer to 1.2 parts by weight. The unevenness-free surface properties were confirmed. In all of the optical compensation sheets, a change in the haze before and after the formation of an optically anisotropic layer was approximately from 0.05 to 0.10%, and the contrast ratio was high as seen in the foregoing Examples 1 to 4.

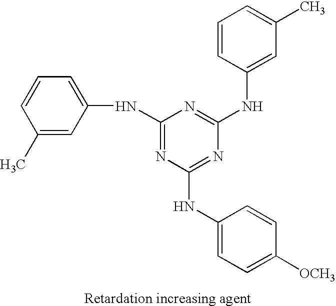

### Example 7

Optical compensation sheets and optical compensation sheet-provided polarizing plates were prepared in the same manner as in Example 1, except that the amount of addition of the retardation increasing agent as used in Example 6 was changed to prepare cellulose acetate films having an Rth retardation value of 76 nm, 85 nm, 100 nm and 110 nm, respectively. Even by changing the Rth retardation value of the polymer substrate to 76 nm, 85 nm, 100 nm and 110 nm, respectively, the unevenness-free surface properties were confirmed. In all of the optical compensation sheets, a change in the haze before and after the formation of an optically anisotropic layer was approximately from 0.05 to 0.10%, and the contrast ratio was high as seen in the foregoing Examples 1 to 4.

### Example 8

(Preparation of Cellulose Acetate Solution)

The following composition was charged in a mixing tank and stirred while heating, thereby dissolving the respective components. There was thus prepared a cellulose acetate solution.

Composition of cellulose acetate solution

| | | |
|---|---|---|
| Cellulose acetate having a | 100 | parts by weight |
| degree of acetylation of 60.9%: | | |
| Triphenyl phosphate: | 7.8 | parts by weight |
| Biphenyl diphenyl phosphate: | 3.9 | parts by weight |
| Methylene chloride: | 300 | parts by weight |
| Methanol: | 45 | parts by weight |

In another mixing tank 4 parts by weight of cellulose acetate (linter) having a degree of acetylation of 60.9%, 25 parts by weight of the following retardation increasing agent, 0.5 parts by weight of a silica fine particle (average particle size: 20 nm), 80 parts by weight of methylene chloride, and 20 parts by weight of methanol and stirred while heating to prepare a retardation increasing agent solution. 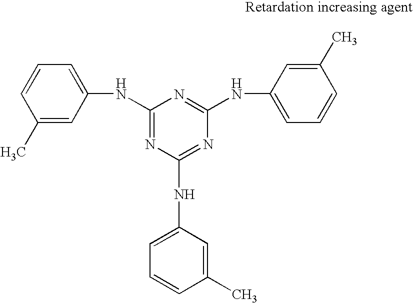
(Preparation of Cellulose Acetate Film)

18.5 parts by weight of the retardation increasing agent solution was mixed in 470 parts by weight of the cellulose acetate solution and thoroughly stirred to prepare a dope. A mass ratio of the retardation increasing agent to the cellulose acetate was 3.5%. After stripping off the film having an amount of the residual solvent of35% by weight from a band, the film was laterally stretched in a stretch ratio of 38% using a tenter. The clip was removed, and the film was dried at 130° C. for 45 seconds. The thus produced cellulose acetate film had an amount of the residual solvent of 0.2% by weight and a thickness of 88 μm.

(Measurement of Optical Characteristics)

With respect to the prepared cellulose acetate film, a retardation value Re (550) was measured by light having a wavelength of 550 nm using an ellipsometer M-150 (manufactured by JASCO Corporation). As a result, it was found to be 45 nm. When the cellulose acetate film was tilted at ±40° while using the in-plane slow axis as a tilting axis, retardation values Re (40°) and Re (−40°) were measured. Rth (550) as computed by the ellipsometer from the measured results was 150 nm.

On the prepared cellulose acetate film, an optically anisotropic layer was formed in the same manner as in Example 1, thereby preparing an optical compensation sheet. A change in the haze was 0.08%, and a haze of the optical compensation sheet was 0.3%. Also, the contrast ratio was high as seen in the foregoing Examples 1 to 4.

### INDUSTRIAL APPLICABILITY

According to the invention, it is possible to provide an optical compensation film and a polarizing plate capable of contributing to a reduction of light leakage in a black state and an improvement of a contrast ratio, when being applied to a liquid crystal display device. Also, according to the invention, it is possible to provide a liquid crystal display device in which not only the like leakage in a black state is reduced, but also a contrast ratio is improved.

1. An optical compensation film comprising:
a substrate, and, on the substrate, at least one optically anisotropic layer formed of a composition comprising a liquid crystalline compound,
wherein a difference (H₂−H₁) between a haze (H₂) of the whole of the optical compensation film and a haze (H₁) of the substrate alone is not more than 0.2%.

2. The optical compensation film of claim 1, wherein the optically anisotropic layer is a layer formed by applying the composition to a surface.

3. The optical compensation film of claim 1, wherein the liquid crystalline compound is a discotic liquid crystalline compound.

4. The optical compensation film of claim 1, wherein the haze (H₂) of the whole is not more than 0.5%.

5. The optical compensation film of claim 1, wherein the composition comprises cellulose acetate butyrate in an amount falling within 0.1 to 2.0% with respect to a total weight of the composition.

6. The optical compensation film of claim 1, wherein the optically anisotropic layer has a thickness of from 0.1 to 2.0 μm.

7. The optical compensation film of claim 1, wherein the substrate is a cellulose acylate film.

8. A polarizing plate comprising at least a polarizing film and a transparent protective film provided on one surface of the polarizing film, wherein the transparent protective film is an optical compensation film as set forth in claim 1.

9. A liquid crystal display device comprising an optical compensation film as set forth in claim 1.

10. A liquid crystal display device comprising a polarizing plate as set forth in claim 8.
